(19) United States
(12) Patent Application Publication
(10) Pub. No.: US 2026/0336087 A1
(43) Pub. Date: Oct. 29, 2026

(54) POWER TOOL SYSTEM AND POWER TOOL

(71) Applicant: Nanjing Chervon Industry Co., Ltd., Nanjing (CN)

(72) Inventors: Dezhong Yang, Nanjing (CN); Zhen Xu, Nanjing (CN); Wei Lu, Nanjing (CN); Guang Li, Nanjing (CN); Shuang Li, Nanjing (CN); Yongkang Wu, Nanjing (CN); Cheng Cheng, Nanjing (CN); Lei Wang, Nanjing (CN); Zheng Geng, Nanjing (CN); Yanqing Xu, Nanjing (CN); Shoubin Wang, Nanjing (CN)

(21) Appl. No.: 19/701,942

(22) Filed: Jun. 9, 2026

Related U.S. Application Data
(63) Continuation of application No. PCT/CN2024/139871, filed on Dec. 17, 2024.

(30) Foreign Application Priority Data
Jan. 5, 2024 (CN) 202410020344.2
Mar. 25, 2024 (CN) 202410340869.4
Dec. 10, 2024 (CN) 202411816380.6
Dec. 10, 2024 (CN) 202423055369.0

(51) Int. Cl. B25F 5/00; G01L 3/10

(52) U.S. Cl. CPC B25F 5/001; G01L 3/108

(57) ABSTRACT

A power tool system includes: a power tool; a battery pack coupled to the power tool to supply electric power to the power tool, where at least one of the power tool and the battery pack is provided with a force-bearing component; and at least one miniature force sensor mounted in the power tool or the battery pack, where the miniature force sensor detects at least one of a deformation parameter of a preset part of the force-bearing component or a value of a force applied to the preset part of the force-bearing component, and the operating current of the miniature force sensor is less than or equal to 10 mA.

### RELATED APPLICATION INFORMATION

This application is a continuation of International Application Number PCT/CN 2024/139871, filed on Dec. 17, 2024, through which this application also claims the benefit under 35 U.S.C. § 119(a) of Chinese Patent Application No. 202410020344.2, filed on Jan. 5, 2024, Chinese Patent Application No. 202410340869.4, filed on Mar. 25, 2024, Chinese Patent Application No. 202423055369.0, filed on Dec. 10, 2024, and Chinese Patent Application No. 202411816380.6, filed on Dec. 10, 2024, which applications are incorporated herein by reference in their entireties.

### TECHNICAL FIELD

The present application relates to the field of power tools, for example, a power tool system and a power tool.

### BACKGROUND

In the related art, power tools, battery packs, and charging devices have increasingly higher requirements for product safety and control accuracy. Therefore, a growing number of various electronic control components are used, resulting in higher power consumption and greater space occupation.

This part provides background information related to the present application, and the background information is not necessarily the existing art.

### SUMMARY

A power tool system includes: a power tool; a battery pack coupled to the power tool to supply electric power to the power tool, where at least one of the power tool and the battery pack is provided with a force-bearing component; and at least one miniature force sensor mounted in the power tool or the battery pack, where the miniature force sensor detects at least one of a deformation parameter of a preset part of the force-bearing component or a value of a force applied to the preset part of the force-bearing component, and the operating current of the miniature force sensor is less than or equal to 10 mA.

In some examples, the power tool includes a power tool driven by a motor, an outdoor traveling device, or an electrical device not driven by a motor.

In some examples, the power tool includes a housing provided with an accommodation space, the battery pack includes a battery pack housing provided with an accommodation space, and the miniature force sensor is mounted on an inner side of the housing of the power tool or on an inner side of the battery pack housing.

In some examples, the force-bearing component is formed on or connected to the housing or the force-bearing component is formed on or connected to the battery pack housing, the force-bearing component includes a force-bearing surface, and the miniature force sensor is disposed on the back or side of the force-bearing surface or on the outer periphery of the force-bearing surface.

In some examples, the power tool includes a controller disposed inside the housing, the controller is connected to the miniature force sensor, and the controller determines a detection value from the miniature force sensor and sends a corresponding signal according to the detection value to control a working state of the power tool.

In some examples, the power tool further includes a motor disposed inside the housing, the motor rotatably drives an output portion coupled to the motor, the miniature force sensor detects at least one of a deformation parameter of a preset part of the output portion or a value of a force applied to the preset part of the output portion, and the controller is configured to determine a detection value from the miniature force sensor and control an operation state of the motor according to the detection value.

In some examples, the controller determines the actual output torque of the power tool according to at least one of a deformation parameter or a force value detected by the miniature force sensor and determines the operation state of the motor according to a comparison result between the actual output torque and the preset torque.

In some examples, the output portion includes an output mechanism including an output shaft for connecting a working attachment and driving the working attachment to rotate.

In some examples, the output portion includes: an output mechanism including an output shaft for connecting a working attachment and driving the working attachment to rotate; and a transmission mechanism disposed between the motor and the output mechanism and used for transmitting power between the motor and the output mechanism.

In some examples, the power tool further includes: a motor disposed inside the housing and configured to drive an output shaft to rotate; and an actuator sleeve that is operably rotatable about the output shaft to allow a user to set a torque threshold, where when the actuator sleeve rotates, the actuator sleeve undergoes axial displacement parallel to an extension direction of the output shaft. The miniature force sensor is configured to detect at least one of a deformation parameter of a preset part of the actuator sleeve or a value of an applied force when the actuator sleeve rotates, where the force receiving surface of the miniature force sensor intersects with the output shaft.

In some examples, the controller is configured to acquire at least one of a deformation parameter or a force value detected by the miniature force sensor and determine the torque threshold according to the acquired data, where the controller controls an operation state of the motor according to the torque threshold.

In some examples, the battery pack has a total capacity greater than or equal to 1.5 Ah and less than or equal to 5 Ah.

In some examples, the miniature force sensor has a dimension less than or equal to 3 mm.

In some examples, the miniature force sensor has a measurement frequency greater than or equal to 500 Hz.

In some examples, the miniature force sensor includes a substrate portion, where the substrate portion includes a silicon-based circuit board.

In some examples, the battery pack further includes a human-machine interaction device, the human-machine interaction device includes a force-bearing surface and a miniature force sensor, and the miniature force sensor is disposed inside the housing.

In some examples, the battery pack further includes: a cell module disposed inside the battery pack housing and including at least one cell unit; and a terminal assembly electrically connected to the cell module to supply power to the power tool.

In some examples, the force-bearing surface is a region defined by the battery pack housing, or the force-bearing surface is a touchscreen or touchpad disposed on the battery pack housing.

In some examples, the battery pack further includes a controller disposed inside the battery pack housing, the controller is connected to the miniature force sensor, and the controller determines a detection value from the miniature force sensor and sends a corresponding signal according to the detection value to control a working state of the battery pack.

In some examples, the battery pack has a total capacity greater than or equal to 1.5 Ah.

In some examples, the battery pack is detachably connected to the power tool.

In some examples, the power tool includes a power supply connecting portion provided with an accommodation portion, and the battery pack is non-detachably disposed in the accommodation portion.

In some examples, when the difference between the force value and the reference value is greater than or equal to the first threshold, the controller determines that the force-bearing surface is subjected to an external force from the user and implements the relevant function.

In some examples, the reference value is relative to a baseline.

In some examples, the controller is further configured to update the baseline at a predetermined frequency.

In some examples, the controller updates the baseline by comparing the force value with an automatic calibration threshold.

In some examples, a buffer is disposed between the force-bearing surface and the miniature force sensor, and the buffer includes rubber or silicone.

In some examples, a circuit board is disposed between the buffer and the miniature force sensor, and the miniature force sensor is bonded to the circuit board.

A power tool includes: a housing; a motor configured to rotatably drive an output portion coupled to the motor; a controller disposed inside the housing; a force-bearing component for receiving an external force or a force generated by the movement of the motor; and at least one miniature force sensor configured to detect at least one of a deformation parameter of a preset part of the force-bearing component or a value of a force applied to a preset part of the output portion. The controller sends a corresponding signal based on a detection value from the miniature force sensor to control a working state of the power tool. The miniature force sensor has a dimension less than or equal to 3 mm.

In some examples, the force-bearing component is formed on or connected to the housing.

In some examples, the force-bearing component includes a force-bearing surface for receiving an external force and undergoing different deformations when the external force changes.

In some examples, the miniature force sensor is disposed on the inner side of the housing. In some examples, the miniature force sensor is disposed on the back or side of the force-bearing surface or on the outer periphery of the force-bearing surface.

In some examples, the force-bearing component includes a moving portion driven by a motor to move or a support portion supporting the moving portion.

In some examples, the moving portion is formed on or connected to the output portion; the miniature force sensor is connected to the moving portion or the support portion; and the moving portion includes at least one of an output shaft for outputting torque, a gear transmission structure, or a cylinder.

In some examples, the support portion is directly or indirectly connected to the moving portion, and the support portion is configured to, when the moving portion is driven by the motor to move, undergo deformation or displacement in response to the movement.

A charging combination system includes: a battery pack coupled to a power tool to supply electric power to the power tool; a charging device coupled to the battery pack or the power tool and used for charging the battery pack, where the charging device is provided with a force-bearing component; and at least one miniature force sensor mounted in the charging device, where the miniature force sensor detects at least one of a deformation parameter of a preset part of the force-bearing component or a value of a force applied to the preset part of the force-bearing component, and the operating current of the miniature force sensor is less than or equal to 10 mA.

In some examples, the power tool includes a power tool driven by a motor, an outdoor traveling device, or an electrical device not driven by a motor.

In some examples, the charging device includes a charger housing provided with an accommodation space; and the miniature force sensor is mounted on the inner side of the charger housing.

In some examples, the force-bearing component is formed on or connected to the charger housing, the force-bearing component includes a force-bearing surface, and the miniature force sensor is connected to the back or side of the force-bearing surface or disposed on the outer periphery of the force-bearing surface.

In some examples, the force-bearing surface is used for receiving an external force and undergoing deformation or displacement in response to the movement when the external force changes.

A battery pack includes: a battery pack housing coupled to a power tool; a cell module disposed inside the housing and including at least one cell unit; and a terminal assembly electrically connected to the cell module to supply power to the power tool. The battery pack further includes a human-machine interaction device, the human-machine interaction device includes a force-receiving surface and a miniature force sensor, and the miniature force sensor is disposed inside the housing.

In some examples, when the difference between the force value and the reference value is greater than or equal to the first threshold, the controller determines that the force-bearing surface is subjected to an external force from the user and implements the relevant function.

In some examples, the relevant function includes starting or stopping the discharge of the battery pack.

In some examples, the human-machine interaction device further includes a display portion for being operated or providing feedback information, and the relevant function includes lighting up the display portion.

In some examples, the battery pack has a waterproof rating of at least IPX6.

An electrical device includes: a housing; a battery pack interface disposed on the housing and used for connecting a battery pack so that the battery pack is charged or the battery pack supplies power to the electrical device, and the battery pack is used for supplying power to a power tool; and a control panel disposed on the housing, where the control panel is operated to control the electrical device. The control panel includes a flat force-bearing surface and at least three miniature force sensors disposed inside the housing.

In some examples, the control panel includes a touchscreen or a touchpad.

In some examples, the force-bearing surface is made of at least one of glass, plastic, and organic glass.

In some examples, the force-bearing surface is configured to be a rectangle, and the miniature force sensors are disposed at the corners of the rectangle.

In some examples, the number of miniature force sensors is greater than or equal to four, with at least one miniature force sensor disposed at each corner of the force-bearing surface.

In some examples, the diagonal dimension of the control panel is greater than or equal to 2.4 inches and less than or equal to 13 inches.

In some examples, the control panel has a waterproof rating of at least IPX6.

In some examples, the control panel includes a circuit board bonded to the force-bearing surface, and the miniature force sensor is integrated into the circuit board.

In some examples, the electrical device includes a power tool, and the power tool includes a power tool driven by a motor, an outdoor traveling device, or an electrical device not driven by a motor.

In some examples, the electrical device includes a charging device, the charging device includes the power input portion for connecting an external power supply, the charging device further includes an output portion, and the output portion is coupled to the battery pack or the power tool, thereby charging the battery pack.

A power tool includes: a motor configured to rotatably drive an output portion coupled to the motor; a speed regulation mechanism for acquiring a user input; and a controller communicatively connected to the speed regulation mechanism and determining the target rotational speed of the motor according to the output of the speed regulation mechanism. The speed regulation mechanism includes a miniature force sensor.

In some examples, the speed regulation mechanism includes an elongated force-bearing surface, and the miniature force sensor is disposed on the back side of the force-bearing surface.

In some examples, the power tool further includes a housing, and the force-bearing surface is a region defined by the housing.

In some examples, two miniature force sensors are disposed on two sides of the midpoint of the elongated strip, respectively.

In some examples, the controller determines the target rotational speed of the motor according to the ratio of the outputs of the two miniature force sensors.

In some examples, the controller linearly adjusts the actual rotational speed of the motor according to the ratio of the outputs of the two miniature force sensors.

In some examples, the controller starts or stops the motor according to the output of one of the miniature force sensors.

In some examples, the miniature force sensor has a measurement minimum value less than or equal to 10 g.

A power tool includes: a working portion electrically driven to implement sound and/or light functions; an adjustment mechanism for acquiring a user input; and a controller communicatively connected to the adjustment mechanism and determining a target working state of the working portion according to the output of the adjustment mechanism. The adjustment mechanism includes a miniature force sensor.

In some examples, the adjustment mechanism includes a force-bearing surface, and the miniature force sensor is disposed on the back side of the force-bearing surface.

In some examples, the power tool further includes a housing, and the force-bearing surface is a region defined by the housing.

In some examples, the working state includes enabling sound or light emission of the working portion, turning off the working portion, and changing the output form of the sound/light state.

In some examples, the power tool includes a motor configured to rotatably drive an output portion coupled to the motor.

A power tool includes: a housing; a motor disposed inside the housing and configured to rotatably drive an output portion coupled to the motor; a controller disposed inside the housing and controlling the rotation of the motor; and at least one miniature force sensor configured to detect at least one of a deformation parameter of a preset part of the output portion or a value of a force applied to the preset part of the output portion. The controller is connected to the miniature force sensor and is configured to acquire a detection value from the miniature force sensor and control an operation state of the motor according to the detection value.

In some examples, the controller determines the actual output torque of the power tool according to the detection value from the miniature force sensor and determines the operation state of the motor according to a comparison result between the actual output torque and the preset torque.

In some examples, the detection value includes at least one of the deformation parameter of the preset part of the output portion, the force value, the rate of change of deformation, or the rate of change of the force value.

In some examples, the transmission mechanism includes a target part for receiving the load torque on the output shaft and performing at least one of causing deformation at a preset position or applying pressure to the preset position.

In some examples, the transmission mechanism includes a planet gear assembly, the planet gear assembly includes an inner ring gear, the inner ring gear abuts against the target part, and the inner ring gear applies torque to the target part.

In some examples, the miniature force sensor detects at least one of the deformation parameter of the preset part or the force value, the controller determines the torque applied by the inner ring gear to the target part, and when the controller determines that the torque applied by the inner ring gear to the target part is greater than a preset torque threshold, the controller controls the motor to operate in a preset manner.

In some examples, the miniature force sensor acquires the deformation parameter of the output shaft to determine the output torque of the output shaft. When the controller determines that the output torque of the output shaft is greater than the preset torque, the controller controls the motor to shut down or decelerate.

In some examples, the preset torque is set by a torque setting portion, the torque setting portion includes a torque cup, the torque cup includes a sensor and an actuator sleeve, the actuator sleeve is operably rotatable about the output shaft for user setting, the sensor sends a corresponding signal to the controller according to the rotation of the actuator sleeve, and the controller determines the preset torque according to the signal from the sensor.

A power tool includes: a housing; a motor disposed inside the housing and configured to drive an output shaft to rotate; a controller disposed inside the housing and controlling the rotation of the motor; an actuator sleeve operably rotatable about the output shaft to allow a user to set a torque threshold, where when the actuator sleeve rotates, the actuator sleeve undergoes axial displacement parallel to an extension direction of the output shaft; a miniature force sensor configured to detect at least one of a deformation parameter of a preset part of the actuator sleeve or a value of an applied force when the actuator sleeve rotates, where a force receiving surface of the miniature force sensor intersects with the output shaft; and a controller connected to the miniature force sensor, where the controller is configured to acquire a detection value from the miniature force sensor and determine the torque threshold according to the acquired detection value, where the controller controls an operation state of the motor according to the torque threshold.

In some examples, when the controller determines that the output torque of the output shaft is greater than the torque threshold, the controller controls the motor to shut down or decelerate.

In some examples, the miniature force sensor is disposed on the back or side of the preset part or on the outer periphery of the preset part.

In some examples, the power tool includes a torque setting portion, and the torque setting portion includes an actuator sleeve and a miniature force sensor; and the power tool further includes an elastic member for applying a corresponding force to the miniature force sensor when the actuator sleeve rotates and undergoes axial displacement parallel to the extension direction of the output shaft.

In some examples, the preset torque is set by the torque setting portion, the torque setting portion includes a human-machine interaction assembly for receiving an operation instruction from the user and sending the operation instruction signal to the controller, and the controller determines the preset torque.

In some examples, the preset torque is set by the torque setting portion, the torque setting portion includes a communication portion and an external device, the communication portion is used for receiving an operation signal from the external device, and the controller determines the preset torque according to the operation signal from the external device.

In some examples, when the difference between the force value and the reference value is greater than or equal to the first threshold, the controller determines that the force-bearing surface is subjected to an external force from the user and implements the relevant function.

In some examples, the reference value is relative to a baseline.

In some examples, the controller is further configured to update the baseline at a predetermined frequency.

In some examples, the controller updates the baseline by comparing the force value with an automatic calibration threshold.

In some examples, a buffer is disposed between the force-bearing surface and the miniature force sensor, and the buffer includes rubber or silicone.

In some examples, a circuit board is disposed between a buffer and a miniature force sensor, and the miniature force sensor is integrated into the circuit board. A handheld power tool includes: a housing; a grip formed on or connected to the housing; a motor disposed inside the housing and configured to rotatably drive an output portion coupled to the motor; a controller disposed inside the housing and controlling the operation of the motor; at least one miniature force sensor for detecting at least one of a deformation parameter of a preset part of the grip or a value of a force applied to the preset part of the grip; and a controller connected to the miniature force sensor and configured to determine a detection value from the miniature force sensor and control an operation state of the motor according to the detection value, where the detection value includes at least one of the deformation parameter of the preset part of the grip, the force value, the rate of change of deformation, or the rate of change of the force value.

In some examples, the grip includes a force-bearing surface for receiving an external force and undergoing different deformations when the external force changes, and the miniature force sensor is disposed inside the grip.

In some examples, the grip includes a first grip and a second grip, and at least one of the first grip and the second grip is provided with the miniature force sensor.

In some examples, the handheld power tool includes a handheld cutting tool. In some examples, the controller is configured to, when the detection value from the miniature force sensor exceeds a threshold, determine that the handheld cutting tool experiences kickback and limit the operation of the motor. The detection value includes at least one of the deformation parameter of the preset part of the grip, the force value, the rate of change of deformation, or the rate of change of the force value.

In some examples, the handheld power tool includes a handheld rotary output tool. In some examples, the controller is configured to, when the detection value from the miniature force sensor exceeds a threshold, determine that the gripping force of the user is not enough to control the handheld rotary output tool and limit the operation of the motor. The detection value includes at least one of the deformation parameter of the preset part of the grip, the force value, the rate of change of deformation, or the rate of change of the force value.

In some examples, the miniature force sensor is disposed inside the housing.

A power tool includes: a motor configured to rotatably drive an output portion coupled to the motor; a trigger for acquiring a user input instruction; at least one miniature force sensor disposed near the trigger and configured to detect at least one of a deformation parameter of a preset part or a value of an applied force when the trigger is activated and undergoes a stroke; and a controller connected to the miniature force sensor and configured to acquire at least one of a deformation parameter of the miniature force sensor or a value of an applied force and determine a target parameter of the motor according to detection data from the miniature force sensor.

In some examples, the trigger includes: a contact portion that is in contact with the user's finger; a linkage portion for deforming a preset part or applying a force to a preset part; and a controller connected to a miniature force sensor and configured to acquire at least one of the deformation parameter or the value of the applied force detected by the miniature force sensor and determine the direction of rotation and the target parameter of the motor according to the deformation parameter or the force value detected by the miniature force sensor.

A power tool includes: a housing; a motor disposed inside the housing and configured to rotatably drive an output portion coupled to the motor; and a controller disposed inside the housing and controlling the rotation of the motor. The output portion includes an attachment for machining a workpiece. At least one miniature force sensor is configured to detect at least one of a deformation parameter of at least one preset part of the attachment or the workpiece or a value of an applied force. The controller is connected to the at least one miniature force sensor and is configured to determine the state of the attachment or the workpiece according to at least one of the deformation parameter or the force value detected by the miniature force sensor.

In some examples, a state indication portion is further included and used for issuing an identifiable state prompt according to the state of the attachment or the workpiece.

In some examples, the controller is configured to determine the state of the attachment or the workpiece according to at least one of the deformation parameter or the force value detected by the miniature force sensor and control the operation of the motor according to the state of the attachment or the workpiece.

In some examples, when determining that the attachment and the workpiece are in a preset relationship according to at least one of the deformation parameter or the force value detected by the miniature force sensor, the controller controls the motor to operate in a preset state.

In some examples, the power tool includes a table cutting tool. The table cutting tool includes: a worktable for supporting a workpiece; an attachment including a saw blade for cutting the workpiece; at least one miniature force sensor disposed on the worktable; and a controller. When determining that the saw blade is disengaged or basically disengaged from the workpiece according to at least one of a deformation parameter or a force value detected by the miniature force sensor, the controller controls the motor to shut down.

In some examples, the power tool includes a cutting tool. The cutting tool includes: an attachment including a saw blade for cutting a workpiece; a receiving portion for accommodating and clamping the attachment; a state indication portion; at least one miniature force sensor disposed inside the receiving portion and configured to detect at least one of a deformation parameter of a contact portion between the attachment and the receiving portion or a value of an applied force; and a controller configured to determine the positional relationship between the saw blade and the receiving portion according to at least one of a deformation parameter or a force value detected by the miniature force sensor, where the controller controls the state indication portion to issue an identifiable state prompt.

In some examples, the power tool includes a cutting tool. The cutting tool includes: an attachment including a saw blade for cutting a workpiece; a receiving portion for accommodating and clamping the attachment; at least one miniature force sensor disposed inside the receiving portion and configured to detect at least one of a deformation parameter of a contact portion between the attachment and the receiving portion or a value of an applied force; and a controller configured to determine a working state of the saw blade according to at least one of a deformation parameter or a force value detected by the miniature force sensor, where the controller sends a corresponding control signal according to the working state of the saw blade.

In some examples, when determining that the saw blade is disengaged from the workpiece or is in contact with a non-workpiece according to at least one of the deformation parameter or the force value detected by the miniature force sensor, the controller limits the output of the motor.

An illumination device includes: an illumination mechanism including a lamp head for emitting light, where the lamp head includes a lamp head housing and a lamp board, and the lamp board is accommodated in the lamp head housing; an adjustment mechanism for acquiring a user input; a controller connected to the adjustment mechanism; and at least one miniature force sensor configured to detect at least one of a deformation parameter of at least one preset part of the adjustment mechanism or a value of an applied force. The controller is connected to the at least one miniature force sensor and configured to determine a target working state of the illumination mechanism according to at least one of a deformation parameter or a force value detected by the miniature force sensor.

In some examples, the working state includes turning on the illumination mechanism, turning off the illumination mechanism, and changing the output form of the light from the illumination mechanism.

An outdoor traveling device includes: a vehicle frame; a traveling assembly connected to the vehicle frame and supporting the vehicle frame, where the traveling assembly includes at least drive wheels and drive motors for driving the drive wheels to rotate; an operation device operated by a user to control at least the steering of the outdoor traveling device; a controller drivingly connected to the drive motors and controlling at least the drive motors; and at least one miniature force sensor disposed inside the operation device, where the miniature force sensor detects at least one of a deformation parameter of a preset part of the operation device or a value of a force applied to the preset part of the operation device. The controller is connected to the miniature force sensor, the controller receives a detection value signal from the miniature force sensor, the controller determines the operation intention of the user for the operation device based on the detection value from the miniature force sensor, and the controller outputs control signals to the drive motors to control output states or the controller generates an alarm signal and provides the alarm to the user.

In some examples, the power supply is configured to supply power to at least the drive motors.

In some examples, the operation intention includes the following: increasing, maintaining, or decreasing the traveling speed, changing the traveling direction, stopping, or setting device parameters changing in a non-traveling state.

In some examples, the detection value includes at least one of the deformation parameter of the preset part of the operation device, the force value, the rate of change of deformation, or the rate of change of the force value.

In some examples, the preset part is disposed on the housing of the operation device, and the housing of the operation device defines a force-bearing surface.

In some examples, the operation device includes a steering wheel, the steering wheel includes a left portion, the housing of the left portion of the steering wheel defines a force-bearing surface for receiving an external force and undergoing different deformations when the external force changes, and the miniature force sensor is disposed in the left portion of the steering wheel.

In some examples, the operation device includes a steering wheel, the steering wheel includes a right portion, the housing of the right portion of the steering wheel defines a force-bearing surface for receiving an external force and undergoing different deformations when the external force changes, and the miniature force sensor is disposed in the right portion of the steering wheel.

In some examples, the operation device includes a first operating lever and a second operating lever, the first operating lever and the second operating lever are operably connected to a first drive wheel and a second drive wheel, respectively, to control the speeds and directions of the first drive wheel and the second drive wheel, respectively, at least one of the first operating lever and the second operating lever includes a force-bearing surface for receiving an external force and undergoing different deformations when the external force changes, and the miniature force sensor is disposed on the back or side of the force-bearing surface or on the outer periphery of the force-bearing surface.

In some examples, the first operating lever and the second operating lever each include a gripping portion for supporting at least the palm, and the housing of the gripping portion defines a force-bearing surface.

In some examples, the miniature force sensor has a dimension less than or equal to 3 mm.

In some examples, the miniature force sensor has an operating current less than or equal to 10 mA.

In some examples, the miniature force sensor is a microelectromechanical (MEMS) force sensor.

An outdoor traveling device includes: a vehicle frame; a traveling assembly connected to the vehicle frame and supporting the vehicle frame, where the traveling assembly includes at least drive wheels and drive motors for driving the drive wheels to rotate; an operation device operated by a user to control at least the steering of the outdoor traveling device; a controller drivingly connected to the drive motors and controlling at least the drive motors; and at least one miniature force sensor disposed inside the operation device, where the miniature force sensor detects at least one of a deformation parameter of a preset part of the operation device or a value of a force applied to the preset part of the operation device. The controller is connected to the miniature force sensor, the controller receives a detection value signal from the miniature force sensor, and the controller determines the operation intention of the user for the operation device based on the detection value from the miniature force sensor.

In some examples, the power supply is configured to supply power to at least the drive motors.

An outdoor traveling device includes: a vehicle frame; a traveling assembly connected to the vehicle frame and supporting the vehicle frame, where the traveling assembly includes at least traveling wheels and a drive motor for driving the traveling wheels to rotate; a power supply device configured to supply power to at least the drive motor; a support mechanism connected to the vehicle frame and supporting a user at least during the traveling process of the outdoor traveling device; a controller for controlling at least the drive motor; and at least one miniature force sensor for detecting at least one of a deformation parameter of a preset part of at least one of the traveling assembly, the support mechanism, and the vehicle frame or a value of a force applied to the preset part of at least one of the traveling assembly, the support mechanism, and the vehicle frame. The controller is connected to the miniature force sensor and configured to receive a detection value from the miniature force sensor and trigger a corresponding control signal of the controller based on the detection value from the miniature force sensor.

In some examples, the support mechanism includes a seat; and based on the detection value from the miniature force sensor, the controller determines the user presence condition and triggers a control signal corresponding to the user presence condition.

In some examples, based on the detection value from the miniature force sensor, the controller determines the weight of the user supported by the support mechanism or the position of the user relative to the support mechanism.

In some examples, the miniature force sensor is disposed inside the seat, and the preset part includes the surface of the seat.

In some examples, the seat is connected to a seat mounting portion of the vehicle frame, and the miniature force sensor is disposed inside the vehicle frame, and the preset part includes the seat mounting portion.

In some examples, the vehicle frame includes connecting plates, the traveling wheels are connected to the connecting plates, and the miniature force sensors are disposed on the connecting plates. Based on the detection values from the miniature force sensors, the controller determines the attitude information of the outdoor traveling device and triggers a control signal corresponding to the attitude information.

In some examples, the traveling assembly includes at least four traveling wheels, and the vehicle frame includes four axles corresponding to the traveling wheels. Based on the detection values from the miniature force sensors, the pressure differences among the axles are determined, and the controller determines the attitude information of the outdoor traveling device based on the pressure differences.

In some examples, the attitude information includes the tilt angle in the horizontal direction and the change in the tilt angle in the horizontal direction.

In some examples, the controller controls the output states of the drive motors based on the attitude information. In some examples, the controller generates an alarm signal based on the attitude information and provides the alarm to the user.

### BRIEF DESCRIPTION OF THE DRAWINGS

FIG. 1 is an example view of a power tool system and a miniature force sensor in the present application.

FIG. 2 is a structural view of a power tool (a polisher) in the present application.

FIG. 3 is a structural view of a power tool using a built-in battery in the present application.

FIG. 4 is a structural view of a power tool (an outdoor traveling device) in the present application.

FIG. 5 is a structural view of a battery pack in the present application.

FIG. 6 is a structural view of a cell module of a battery pack in the present application.

FIG. 7 is an example view of a charging combination system and a miniature force sensor.

FIG. 8 is a structural view of a charger in the present application.

FIG. 9 is a structural view of a miniature force sensor.

FIG. 10 is a structural view illustrating that a miniature force sensor is mounted inside a battery pack housing in the present application.

FIG. 11 is a structural view illustrating that a miniature force sensor is mounted in a touchscreen in the present application.

FIG. 12 is a structural view of a control panel in the present application.

FIG. 13 is an exploded view of a control panel in the present application.

FIG. 14 is a schematic view of three miniature force sensors disposed in a control panel in the present application.

FIG. 15 is a schematic view of four miniature force sensors disposed in a control panel in the present application.

FIG. 16 is a schematic view of a speed regulation mechanism and miniature force sensors in the present application.

FIG. 17 is a schematic view of an adjustment mechanism of an illumination device in the present application.

FIG. 18 is a structural view of a handheld power tool (an electric circular saw) in the present application.

FIG. 19 is a structural view of a handheld power tool (an electric circular saw) in the present application from another perspective.

FIG. 20 is an electrical block diagram of a handheld power tool in the present application.

FIG. 21 is a flowchart of a control method for a handheld power tool in the present application.

FIG. 22 is a structural view of a handheld power tool (an electric drill) in the present application.

FIG. 23 is a sectional view of a handheld power tool (an electric drill) in the present application.

FIG. 24 is a sectional view of a handheld power tool (an electric drill) in the present application.

FIG. 25 is a sectional view of a handheld power tool (an electric drill) in the present application from another perspective.

FIG. 26 is a structural view illustrating that a miniature force sensor is mounted in a power tool in the present application.

FIG. 27 is an electrical block diagram of a handheld power tool in the present application.

FIG. 28 is a flowchart of a control method for a handheld power tool in the present application.

FIG. 29A is a structural view of a trigger of a power tool in the present application.

FIG. 29B is a structural view of another trigger of a power tool in the present application.

FIG. 29C is a structural view of another trigger of a power tool in the present application.

FIG. 30 is a structural view of a power tool (a table cut-off saw) in the present application.

FIG. 31A is a structural view of a power tool (a table cut-off saw) in the present application.

FIG. 31B is another structural view of a power tool (a table cut-off saw) in the present application.

FIG. 31C is another structural view of a power tool (a table cut-off saw) in the present application.

FIG. 32 is a flowchart of a control method for a power tool in the present application.

FIG. 33 is an electrical block diagram of a power tool in the present application.

FIG. 34 is a structural view of a power tool (a jigsaw) in the present application.

FIG. 35 is a partial sectional view of FIG. 34.

FIG. 36 is a partial sectional view of a power tool (a reciprocating saw) in the present application.

FIG. 37 is a structural view of a power tool (a fastener driver) in the present application.

FIG. 38 is a structural view of a power tool (an outdoor traveling device) in the present application, mainly illustrating a traveling assembly and a control circuit board.

FIG. 39 is a structural view of a power tool (another outdoor traveling device) in the present application.

FIG. 40 is a structural view of a steering wheel in FIG. 39.

FIG. 41 is a structural view of a first operating lever and a second operating lever in FIG. 4.

FIG. 42 is a structural view of a power tool (an outdoor traveling device) in the present application, mainly illustrating a vehicle frame structure.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate member and the two members or assemblies are connected by the at least one intermediate member. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with a quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, a lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned units.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

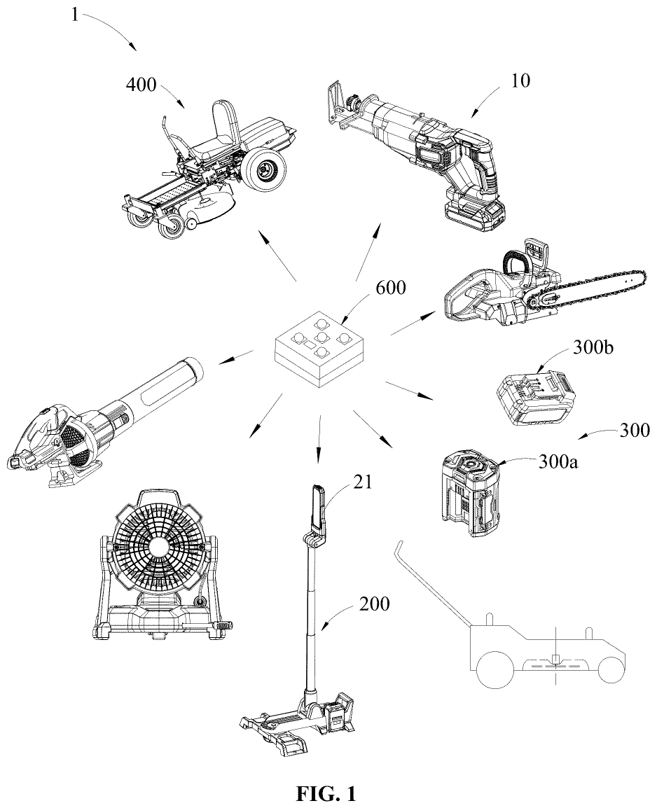

To clearly illustrate the technical solutions of the present application, an upper side, a lower side, a front side, and a rear side shown in FIG. 1 are further defined.

FIGS. 1 to 6 show a power tool system 1 in an example of the present application. The power tool system 1 includes a power tool 10. In this example, the power tool 10 is a polisher 100a. In some examples, the power tool 10 may be another handheld power tool, for example, a screwdriver, a wrench, an electric hammer, a nail gun, a sander, a reciprocating saw, or a jigsaw. In some examples, the power tool 10 may be a table tool, for example, a table saw, a metal cutter, an electric router, or a miter saw. In some examples, the power tool 10 is a handheld garden tool, for example, a hedge trimmer or a blower. In some examples, the power tool 10 is a push garden tool, for example, a mower, a snow thrower, or a cleaning machine. In some examples, the power tool 10 is a fan or the like.

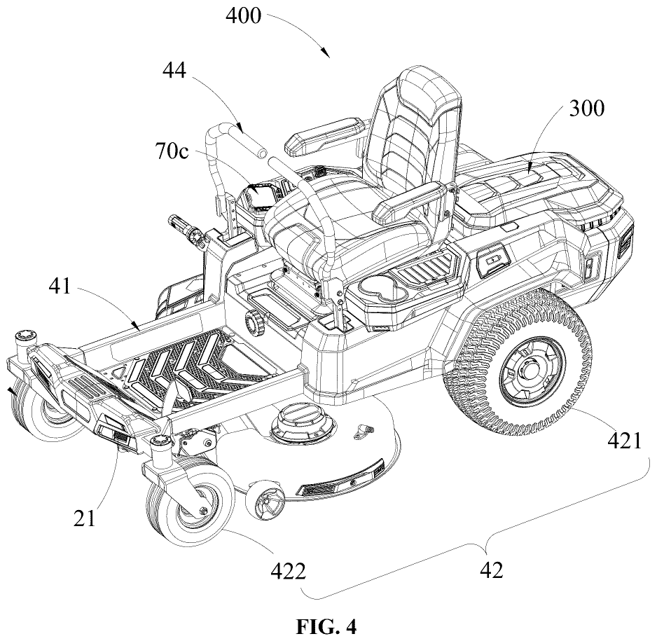

In some examples, as shown in FIG. 4, the power tool 10 is an outdoor traveling device 400, and the outdoor traveling device 400 includes a vehicle frame 41 and a traveling assembly 42. The vehicle frame 41 is the body structure of the outdoor traveling device 400. The traveling assembly 42 supports the vehicle frame 41 and includes wheels 422 and wheels 421. The traveling assembly 42 includes a drive motor. For example, the outdoor traveling device 400 includes a riding mower, and the riding mower can travel outdoors and mow grass. It is to be understood that the outdoor traveling device 400 may be another vehicle that only travels outdoors such as a utility vehicle (UTV) and may also be a dune buggy, a farmer's vehicle, a golf cart, or an all-terrain vehicle (ATV). The outdoor traveling device 400 may also be a vehicle that can implement another function in addition to the traveling function, like the riding mower shown in this example, such as a snow thrower that can not only travel outdoors but also implement the snow removal function. The outdoor traveling device 400 may be an agricultural machinery vehicle, for example, a harvester or a pesticide spraying vehicle. Of course, it is to be understood that the outdoor traveling device 400 may be a cleaning machine.

In some examples, the power tool 10 further includes electrical devices 200 that are not driven by the motor, for example, a work light, a photoelectric detection device, a radio, and a speaker. In the electrical device 200 that is not driven by the motor, the motor is generally not provided, and a working portion 21 is driven by directly using electrical energy. It is to be understood that the working portion 21 may be, for example, a light-emitting element or a sound-emitting element.

As shown in FIGS. 1, 5, and 6, the power tool system 1 further includes a power supply 300 for supplying electrical energy to the power tool 10. In this example, the power tool 10 is powered using a direct current (DC) power supply. For example, the DC power supply is a battery pack. Corresponding components in the power tool 10 are powered by the battery pack in conjunction with a corresponding power supply circuit. For the power tool 10 with a motor, the power supply 300 supplies power to at least the motor. It is to be understood by those skilled in the art that the power supply 300 is not limited to the battery pack, and the corresponding components in the machine may be powered by mains electricity or an alternating current (AC) power supply in collaboration with corresponding rectifier, filter, and voltage regulator circuits. In this example, the DC power supply is specifically configured to be the battery pack. The battery pack 300 is used hereinafter instead of the DC power supply, which is not intended to limit the present application.

In this example, a battery pack 300a is used as an example, and the battery pack 300a includes a battery pack housing 31 and a cell module 32. The battery pack housing 31 is configured to be coupled to the power tool 10, and the cell module 32 is disposed inside the battery pack housing 31. The battery pack 300 further includes a terminal assembly 33 electrically connected to the cell module 32. The cell module 32 includes cells 321.

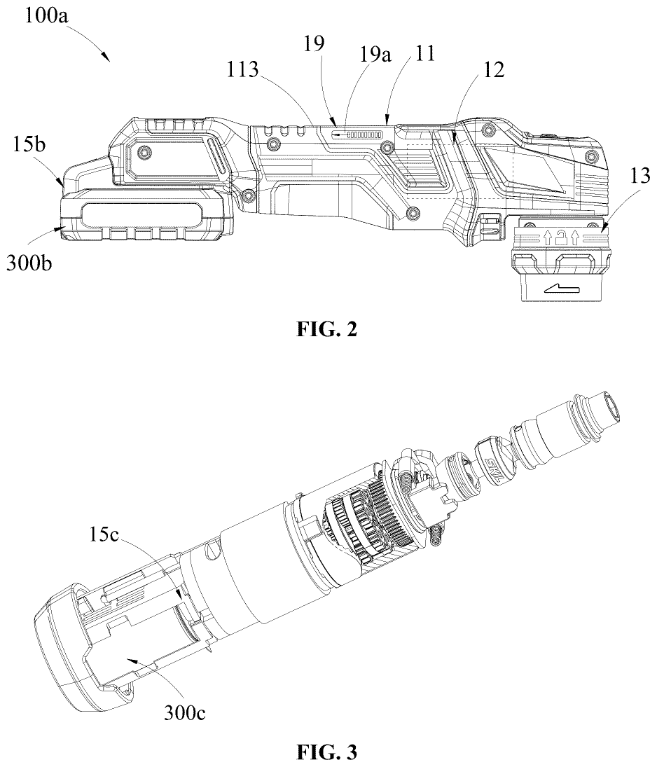

In this example, as shown in FIG. 2, the polisher 100a is provided with a power supply connecting portion 15b for detachably connecting a battery pack 300b. The power supply connecting portion 15b is provided with at least a power interface electrically connected to the terminal assembly 33 of the battery pack 300b, thereby supplying power to the power tool 10. In this example, the power supply connecting portion 15b is used for detachably connecting the battery pack 300b, that is, the battery pack 300b is pluggably connected to the power supply connecting portion 15b. The power supply connecting portion 15b is further provided with a locking structure and a pop-out structure. The locking structure is used for locking the battery pack 300b inside the power supply connecting portion 15b to prevent the battery pack 300b from shaking, thereby ensuring the electrical connection between the battery pack 300b and the power interface. The pop-out structure is used for popping out the battery pack 300b when the locking structure releases the lock on the battery pack 300b, thereby facilitating the removal of the battery pack 300b by the user. The working principle and structure for the locking and popping out of the battery pack 300b in a mechanical manner have been fully disclosed to those skilled in the art. Therefore, a detailed description is omitted here for brevity of description. The battery pack 300a and the battery pack 300b are battery packs 300 with different nominal voltages. Due to the difference in nominal voltages, the battery pack 300a and the battery pack 300b differ in size, but this does not affect the actual content of the connection.

In some alternative examples, the power tool is provided with a power supply connecting portion 15c, and the battery pack is a built-in battery 300c. That is, the power supply connecting portion 15c is non-detachably connected to the built-in battery 300c. The power supply connecting portion 15c is provided with an accommodation portion in which the built-in battery 300c is non-detachably accommodated. It is to be understood that the built-in battery 300c may be a battery that is generally not intended to be removed or a battery that is inconvenient for the user to quickly remove.

In some examples, for the outdoor traveling device 400, the power supply 300 is used for supplying power to at least the traveling assembly 42, and the power supply 300 is mounted to the vehicle frame 41. The traveling assembly 42 includes a traveling motor and wheels 421, and the traveling motor drives the wheels 421 to rotate so that the outdoor traveling device can move as instructed. In some examples, when the outdoor traveling device 400 incorporates other functions, such as mowing, snow removal, and harvesting, the outdoor traveling device 400 is further provided with a working motor, and the power supply 300 also supplies power to the working motor.

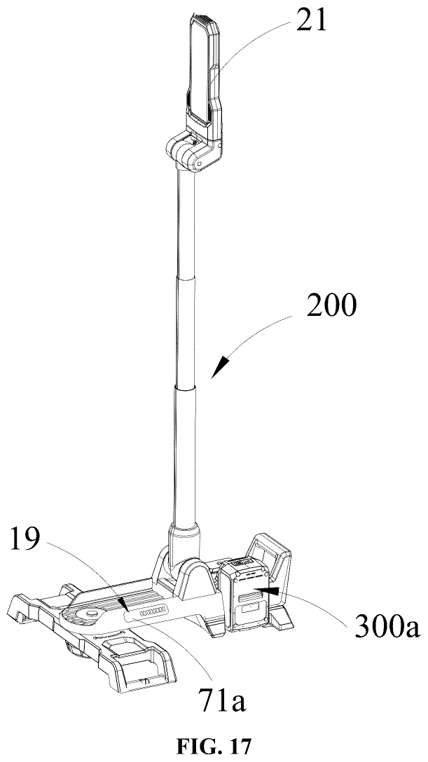

In some examples, the power tool 10 includes the working portion 21 that implements sound and/or light functions, and the power supply 300 supplies power to the working portion 21. As shown in FIGS. 1 and 17, the power tool 10 is an electrical device 200 that is not driven by the motor, such as a work light, a photoelectric detection device, a radio, or a speaker, and the battery pack 300a supplies power to the working portion 21. In some examples, as shown in FIG. 4, the power tool 10 includes a motor, and the working portion 21 serves as an auxiliary component of the power tool 10, such as a supplementary light, a laser scale, or an alarm mechanism of the power tool. The battery pack 300 simultaneously supplies power to both the motor and the working portion 21.

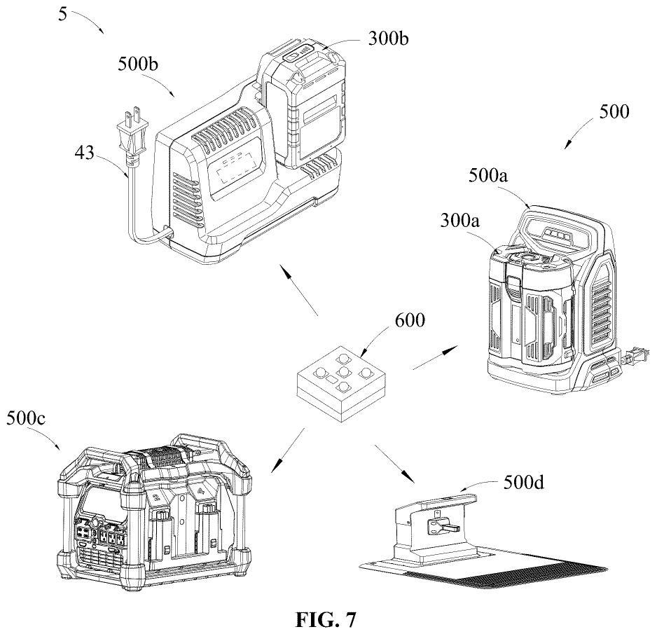

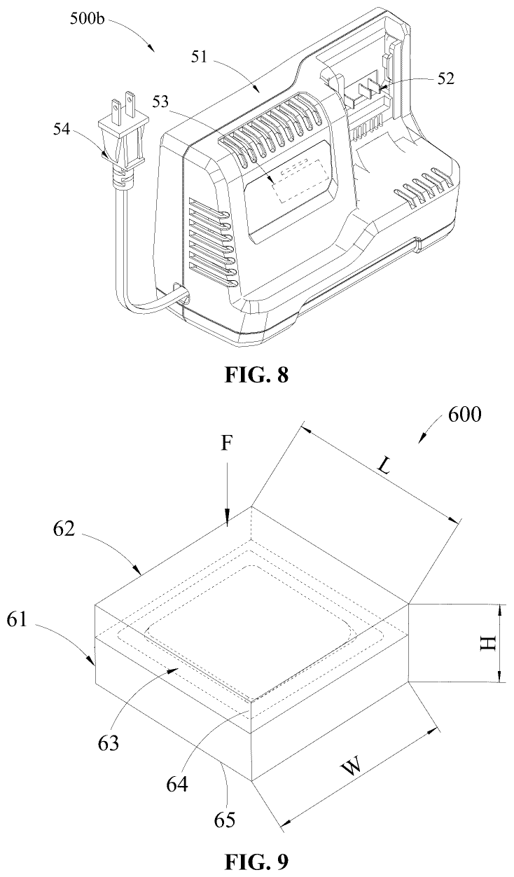

FIG. 7 shows a charging combination system 5 in an example of the present application. The charging combination system 5 includes battery packs 300a and 300b and charging devices 500a, 500b, 500c, and 500d. The battery pack 300a or 300b is coupled to the power tool 10 and supplies electric power to the power tool 10. The charging device 500a, 500b, 500c, or 500d is coupled to the battery pack 300a or 300b or the power tool 10, thereby charging the battery pack 300a or 300b. In some examples, as shown in FIG. 8, the charging device 500b is used as an example, and the charging device is a charger 500b. The charger 500b includes a charger housing 51, a battery pack interface 52, and a circuit board assembly 53. The battery pack interface 52 is disposed on the charger housing 51. The battery pack interface 52 is configured to be coupled to the battery pack 300. The circuit board assembly 53 is at least partially disposed in the charger housing 51. In this example, the charger 500b further includes a power input portion 54 for connecting an external power supply. In this example, an AC power supply may be selected as the power supply, and the power input portion 54 is connectable to AC mains power of 120 V or 220 V. The power input portion 54 is connected to a power conversion circuit so that the received AC power is converted into charging electrical energy suitable for charging the battery pack and auxiliary electrical energy for powering components in the charger 500b. It is to be understood that the power conversion circuit may include at least an AC/DC module. In an alternative example, the power input portion 54 may be connected to a photovoltaic panel, and the power conversion circuit may convert optical energy into charging electrical energy suitable for charging the battery pack and auxiliary electrical energy for powering the components in the charger 500b. It is to be understood that the power conversion circuit may include a maximum power point tracking (MPPT) module, that is, a module converting optical energy into electrical energy. In this example, the plug of a power cord is connected to the charger housing 51 and used as the power input portion 54. In an alternative example, the power input portion 54 may be another form of interface, which is not limited herein.

In some examples, the charger housing 51 is connected to a cable and/or a connector, and the connector is connected to the battery pack, thereby charging the battery pack. In some examples, the battery pack 300 is coupled to the power supply connecting portion of the power tool 10, and the charging device is coupled to the power tool 10, thereby charging the battery pack 300 through the power tool 10. For example, a charging station 500d for a smart mower or a smart robotic mower, a charging dock for a vacuum cleaner or a blower vacuum, and a conventional charger with a USB connector are included.

An example of the present application provides an electrical device. The electrical device includes a housing and a battery pack interface. The battery pack interface is disposed on the housing and configured to be coupled to the battery pack 300 so that the battery pack 300 can be charged or the battery pack 300 can supply power. The battery pack 300 is used for supplying power to the power tool 10. The electrical device includes the power tool 10, and the power tool 10 includes the outdoor traveling device 400, the power tool 10 driven by the motor to operate, or the electrical device 200 that is not driven by the motor. In some examples, the electrical device includes a charging device 500, the charging device 500 includes the power input portion 54 for connecting an external power supply, the charging device 500 further includes an output portion, that is, the battery pack interface 52, and the output portion is coupled to the battery pack 300 or the power tool 10, thereby charging the battery pack 300.

For the battery pack 300, the battery pack 300 has a nominal voltage greater than or equal to 3 V and less than or equal to 18 V. In some examples, the battery pack 300 has a nominal voltage greater than or equal to 18 V and less than or equal to 56 V. In some examples, the battery pack 300 has a nominal voltage greater than or equal to 56 V and less than or equal to 120 V. The nominal voltage generally refers to a voltage specified by the manufacturer or the vendor on the label, packaging, user manual, specification, advertisement, marketing document, or other support documents of the battery pack so that users know which power tools 10 can run with the battery pack. Alternatively, the nominal voltage of the battery pack 300 may be detected or calculated. The nominal voltage may be a voltage of the battery pack when the state of charge (SOC) of cells in the battery pack is 50%.

Optionally, each cell 321 has a nominal voltage greater than or equal to 3 V. In some examples, the cell 321 has a nominal voltage greater than or equal to 3.6 V. Each cell 321 has a nominal capacity greater than or equal to 1.5 ampere-hours (Ah). In some examples, each cell 321 has a nominal capacity greater than or equal to 3 Ah. In some examples, the battery pack 300 has a total capacity greater than or equal to 1.5 Ah and less than or equal to 5 Ah. The case where the battery pack 300 has a nominal voltage of 56 V is used as an example. The battery pack 300 is provided with two sets of lithium cells 321, the two sets are connected in parallel, each lithium cell 321 has a nominal voltage of 4 V and a capacity of nearly 2 Ah, the cell 321 has an average discharge current of 6 A, and each set consists of 14 cells 321 connected in series. In this manner, the battery pack 300 has a nominal voltage of 56 V and a capacity of nearly 4 Ah.

Optionally, the battery pack 300 may be a lithium battery pack, a solid-state battery pack, or a pouch battery pack.

In this example, the power tool system 1 further includes at least one miniature force sensor 600. The miniature force sensor 600 is an MEMS force sensor. The sensor is used for measuring the force applied to at least a portion of the sensor. The miniature force sensor 600 is mounted in the power tool 10 or the battery pack 300. It is to be understood that in some examples, the miniature force sensor 600 is mounted in the power tool 10. In some examples, the miniature force sensor 600 is mounted in the battery pack 300. In some examples, the miniature force sensor 600 is mounted in the battery pack 300 and the power tool 10. Depending on different requirements for measurement accuracy and measurement area, the number and positions of miniature force sensors 600 vary, and the details are described below.

A force-bearing component is disposed on at least one of the power tool 10 and the battery pack 300, and the miniature force sensor 600 is used for measuring the deformation or force value of the force-bearing component. It is to be understood that the matter is deformed when subjected to a force, so the miniature force sensor 600 can directly measure the force value or convert the deformation of the force-bearing component caused by the applied force into the force value. The miniature force sensor 600 measures the deformation or force value of the force-bearing component and converts it into a relevant electrical signal for output. In this example, the miniature force sensor 600 has an operating current less than or equal to 10 mA. In some examples, the miniature force sensor 600 has an operating current less than or equal to 5 mA. In some examples, the miniature force sensor 600 has an operating current less than or equal to 1 mA. In some examples, the miniature force sensor 600 has an operating current less than or equal to 900 μA. In some examples, the miniature force sensor 600 has an operating current less than or equal to 500 μA. In some examples, the miniature force sensor 600 has an operating current less than or equal to 100 μA. In some examples, the miniature force sensor 600 has an operating current less than or equal to 50 μA. In some examples, the miniature force sensor 600 has an operating current less than or equal to 10 μA.

The miniature force sensor 600 has a dimension less than or equal to 3 mm. In this example, for the power tool system 1 powered by the battery pack 300, the miniature force sensor 600 is disposed in any one of the power tool 10 or the battery pack 300 and used for acquiring a pressure value to perform the corresponding operation. In some examples, in a scenario where a cable is used for connecting a power supply, such as mains power or AC power, the miniature force sensor 600 is disposed in the power tool 10. It is to be explained that the miniature force sensor 600 has three dimensions: the length L, the width W, and the thickness H, and the largest dimension is less than or equal to 3 mm. In some examples, the miniature force sensor 600 has a thin plate shape, the length L is greater than or equal to the width W, the thickness H is the smallest, and the length L of the miniature force sensor 600 is less than or equal to 3 mm. In some examples, the miniature force sensor 600 has a length L less than or equal to 2.0 mm. In some examples, the miniature force sensor 600 has a length L less than or equal to 1.5 mm. In this example, the miniature force sensor 600 has an area less than or equal to 4 mm2. In some examples, the miniature force sensor 600 has an area less than or equal to 3 mm2. In some examples, the miniature force sensor 600 has an area less than or equal to 2 mm2. The miniature force sensor 600 is a pressure sensor with small dimensions and low power consumption so that the electrical energy utilization efficiency of the power tool system 1 can be improved and the battery life can be extended. Therefore, miniaturization and compactness of the product can be achieved.

FIG. 9 shows the structure of the miniature force sensor 600. The miniature force sensor 600 includes a substrate portion 61 and a cover portion 62. The substrate portion 61 includes a boss and curved portions 64. A sealed chamber 63 is formed by the inner surfaces of the substrate portion 61 and the cover portion 62. When the cover portion 62 and the substrate portion 61 are joined together, the sealed chamber 63 can be sealed between the cover portion 62 and the substrate portion 61. Optionally, the sealed chamber 63 is formed by etching a channel in the substrate portion 61 and then sealing the volume between the substrate portion 61 and the cover portion 62. Optionally, when the substrate portion 61 and the cover portion 62 bond together, the volume between the substrate portion 61 and the cover portion 62 is sealed, forming the sealed chamber 63. The channel may be etched by removing the material from the substrate portion 61. In addition, the channel defines outer walls and at least one curved portion 64. The channel is continuous and has a basically square shape. Optionally, the channel may form multiple outer walls and/or multiple curved portions 64. In other words, the miniature force sensor 600 has the sealed chamber 63, and the sealed chamber 63 defines a volume that is completely sealed by the cover portion 62 and the substrate portion 61. The sealed chamber 63 is sealed from the external environment.

The miniature force sensor 600 includes at least one sensing element 65 disposed on the bottom surface of the base. The sensing element 65 can change the electrical characteristics (for example, the resistance, capacitance, and charge) in response to the deflection of at least one curved portion 64. The change in electrical characteristics may be measured as an analog electrical signal as described herein. In an example, the sensing element 65 may optionally be a piezoresistive transducer. When the piezoresistive transducer is compressed and stretched by an applied external force F, the resistivity changes in opposite manners. Therefore, the Wheatstone bridge circuit, which includes multiple (for example, four) piezoresistive transducers (for example, two in each orientation relative to strain), becomes unbalanced and generates a differential voltage (sometimes referred to herein as “the analog electrical signal”) at the positive and negative signal terminals. The differential voltage is proportional to the external force F applied to the miniature force sensor 600. Optionally, the external force F applied directly to the miniature force sensor 600 is less than or equal to 20 N. The miniature force sensor 600 has a sampling frequency greater than or equal to 500 Hz. In some examples, the sampling frequency of the miniature force sensor 600 is greater than or equal to 600 Hz, 700 Hz, 800 Hz, 900 Hz, or 1000 Hz.

In some examples, the cover portion 62 may optionally be made of glass (for example, borosilicate glass) or silicon. The substrate portion 61 is optionally made of silicon. Optionally, the substrate portion 61 (and its components, such as the boss, the outer walls, and the curved portions 64) is a single continuous material, that is, the substrate portion 61 is integrally formed. The cover portion 62 and/or the substrate portion 61 may be bonded using techniques known in the art, including, but not limited to, silicon fusion bonding, anodic bonding, glass frit bonding, thermal compression bonding, and eutectic bonding.

The substrate portion 61 includes a silicon-based circuit board, such as a direct plating copper (DPC) ceramic substrate circuit board in this example. Aluminum nitride/alumina ceramic is used as the substrate for the circuit. A metal layer is composited on the substrate surface using a sputtering process, and the circuit is formed using electroplating and photolithography processes. Since the DPC ceramic substrate circuit board has a stable coefficient of thermal expansion and excellent mechanical and electrical properties, the sensor maintains stability and accuracy in high or low temperature environments. The DPC ceramic substrate circuit board can withstand high pressure and strong vibration, preventing the sensor from malfunctioning due to mechanical stress. The DPC ceramic substrate circuit board has a low dielectric constant and a low dielectric loss, thereby reducing signal noise and distortion and improving the accuracy and stability of the sensor. Moreover, the DPC process provides a strong bond between copper wires, thereby providing higher reliability. Since the DPC process can ensure a strong bond between the copper wires and the ceramic substrate, problems such as loosening and breakage can be avoided. In addition, the DPC process can improve the temperature resistance and vibration resistance of the product to ensure reliability in harsh working environments.

In some examples, the charging combination system 5 includes at least one miniature force sensor 600. The miniature force sensor 600 is a MEMS force sensor. The sensor is used for measuring the force applied to at least a portion of the sensor. The miniature force sensor 600 is mounted in the charging device 500. For example, the miniature force sensor 600 is mounted in the charger 500b or the charging station 500d. The charging device 500 includes a housing provided with an accommodation space, and the miniature force sensor 600 is mounted on the inner side of the housing. Depending on different requirements for measurement accuracy and measurement area, the number and positions of miniature force sensors 600 vary, and the details are described below.

The charging device 500 is provided with a force-bearing component. The miniature force sensor 600 is used for measuring the deformation or force value of the force-bearing component. The miniature force sensor 600 measures the deformation or force value of the force-bearing component and converts it into a relevant electrical signal for output. In this example, the miniature force sensor 600 has an operating current less than or equal to 10 mA. In some examples, the miniature force sensor 600 has an operating current less than or equal to 5 mA. In some examples, the miniature force sensor 600 has an operating current less than or equal to 1 mA. In some examples, the miniature force sensor 600 has an operating current less than or equal to 900 μA. In some examples, the miniature force sensor 600 has an operating current less than or equal to 500 μA. In some examples, the miniature force sensor 600 has an operating current less than or equal to 100 μA. In some examples, the miniature force sensor 600 has an operating current less than or equal to 50 μA. In some examples, the miniature force sensor 600 has an operating current less than or equal to 10 μA.

The miniature force sensor 600 has a dimension less than or equal to 3 mm. It is to be explained that the miniature force sensor 600 has three dimensions: the length, the width, and the thickness, and the largest dimension is less than or equal to 3 mm. In some examples, the miniature force sensor 600 has a thin plate shape, the length is greater than or equal to the width, the thickness is the smallest, and the length of the miniature force sensor 600 is less than or equal to 3 mm. In some examples, the miniature force sensor 600 has a dimension less than or equal to 2.0 mm. In some examples, the miniature force sensor 600 has a dimension less than or equal to 1.5 mm. In this example, the miniature force sensor 600 has an area less than or equal to 4 mm2. In some examples, the miniature force sensor 600 has an area less than or equal to 3 mm2. In some examples, the miniature force sensor 600 has an area less than or equal to 2 mm2. The miniature force sensor 600 is a pressure sensor with small dimensions and low power consumption so that the electrical energy utilization efficiency of the power tool system 1 can be improved and the battery life can be extended. Therefore, miniaturization and compactness of the product can be achieved.

The structure of the miniature force sensor 600 is basically the same as the structure of the miniature force sensor 600 disposed in the power tool system 1 described above. For the sake of brevity, the details are not repeated here.

As an example of the present application, a force-bearing component is formed on or connected to the housing of the power tool 10, the battery pack 300a, or the charging device. The force-bearing component includes a force-bearing surface 71 for receiving an external force and generating different deformation parameters when the external force changes.

As a specific implementation manner of this example, for ease of description, the battery pack 300a is used as an example, and a force-bearing component 70a is disposed on a human-machine interaction device 38 of the battery pack 300a. The human-machine interaction device 38 allows the user to operate the battery pack 300a, feed back the working state of the battery pack 300a, and display information about the battery pack 300a. It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations.

In the related art, the human-machine interaction device 38 is generally a push button switch for starting or stopping the discharge of the battery pack 300a or performing some adjustment operations on the battery pack 300a. The push button switch is a discrete push button switch such as a micro switch. The user presses the push button switch by a certain stroke to switch the switching states, thereby generating different signals. The discrete push button switch needs to be at least partially disposed on the visible surface of the battery pack housing 31 to receive user input to perform a corresponding action or send a corresponding signal. It is to be understood that, for example, the micro switch requires a certain trigger stroke, such as 1.5 mm or even larger. On the one hand, it is very difficult to directly cause a local deformation of more than 1.5 mm on the battery pack housing 31, so the trigger position of the switch needs to be set on the visible surface for direct user operation. On the other hand, due to the setting of such a trigger stroke, when the switch is triggered to the maximum stroke, a gap is generated between the switch position and the housing. Moreover, such a switch requires a mounting hole to be made on the battery pack housing 31 during installation and assembly, which inevitably leads to a gap or sealing defect between the switch and the battery pack housing 31 during installation.

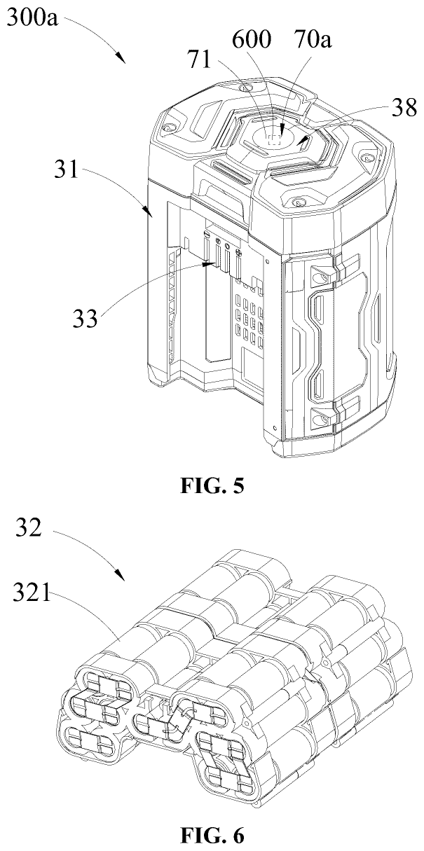

In this example, the miniature force sensor 600 is used to replace the micro switch in the related art. The human-machine interaction device 38 includes the force-bearing component and the miniature force sensor 600. The force-bearing component is used for receiving the user operation. Optionally, the human-machine interaction device 38 includes the force-bearing surface 71 and the miniature force sensor 600. The force-bearing surface 71 is a region with a certain area defined on the battery pack housing 31. The force-bearing surface 71 is used for receiving an external force, including the active touch force applied by the user, such as touching, tapping, or pressing. As shown in FIG. 5, the miniature force sensor 600 is disposed inside the battery pack housing 31. Optionally, the miniature force sensor 600 is disposed on the back side of the force-bearing surface 71. That is, the outer side surface of the battery pack housing 31 is configured to be the force-bearing surface 71, and the miniature force sensor 600 is disposed on the inner side surface corresponding to the force-bearing surface 71. In other alternative examples, the miniature force sensor 600 may be disposed on the back or side of the force-bearing surface 71 or on the outer periphery of the force-bearing surface. That is, the outer side surface of the battery pack housing 31 is configured to be the force-bearing surface 71, and the miniature force sensor 600 is disposed on the peripheral side surface of the battery pack housing 31 where the force-bearing surface 71 is located or on the sidewall of another housing that has a deformation transmission connection with the battery pack housing 31 where the force-bearing surface 71 is located. In other alternative examples, the miniature force sensor 600 may be disposed on the outer periphery of the force-bearing surface 71. That is, the outer side surface of the battery pack housing 31 is configured to be the force-bearing surface 71, and the miniature force sensor 600 may be disposed on the outer side surface of the battery pack housing 31 at the outer edge of the force-bearing surface 71 or on the surface of a housing that has a deformation transmission connection with the battery pack housing 31 where the outer edge of the force-bearing surface 71 is located. To stably fix the miniature force sensor 600, the battery pack housing 31 is provided with a flange or covering structure that at least partially covers the outer edge of the force-bearing surface 71. The miniature force sensor 600 is fixed between the force-bearing surface 71 and the flange or covering structure. Therefore, the miniature force sensor 600 is disposed on the inner side of the battery pack housing 31. It is to be noted that the miniature force sensor 600 is fixed through an additional housing due to the appearance design or other structural requirements of the battery pack 300a. In this case, the additional housing is also part of the battery pack housing 31. It is to be understood that any housing integrally formed with or directly or indirectly connected to the battery pack housing 31 falls within the scope of the battery pack housing 31. Therefore, only when the miniature force sensor 600 is completely exposed on the visible surface of the battery pack housing 31 does it fall outside the scope of “the inner side of the battery pack housing 31” disclosed in the present application.

The case where the miniature force sensor 600 is disposed on the back side of the force-bearing surface 71 is used as an example, and the miniature force sensor 600 is directly or indirectly connected to the back side of the force-bearing surface 71. In some examples, the miniature force sensor 600 is disposed on the back side of the force-bearing surface 71 but is not in contact with the back side of the force-bearing surface 71, that is, the miniature force sensor 600 is suspended relative to the back side of the force-bearing surface 71. For example, the miniature force sensor 600 is disposed on the back side of the force-bearing surface 71 and is connected and fixed to the front or side of the force-bearing surface 71 through connectors or fasteners. The force-bearing surface 71 is configured to be a region defined on the battery pack housing 31, thereby ensuring that the battery pack housing 31 is an integral structure.

In this example, the MEMS force sensor is used. Due to detection characteristics of the MEMS force sensor such as high sensitivity and immunity to radio frequency interference, the MEMS force sensor can directly sense the micro-deformation on the battery pack housing 31 and generate a corresponding signal. In this example, the MEMS force sensor provides a force detection range from 5 g to 10 kg. The MEMS force sensor can detect the touch force applied by the user to the battery pack housing 31 so that the battery pack housing 31 does not need to be provided with a hole and maintains an integrally formed housing structure. In this example, the battery pack 300a has a waterproof rating of at least IPX6 and features a fully adjustable and multi-level driven user interface as desired. In this example, the miniature force sensor 600 has a detection range greater than or equal to 10 micrometers and less than or equal to 20 micrometers for the deformation of the force-bearing surface 71. In some examples, the miniature force sensor 600 has a detection range greater than or equal to 10 micrometers and less than or equal to 50 micrometers for the deformation of the force-bearing surface 71. In this example, the miniature force sensor 600 has a detection range greater than or equal to 10 micrometers and less than or equal to 70 micrometers for the deformation of the force-bearing surface 71. In this example, the miniature force sensor 600 has a detection range greater than or equal to 10 micrometers and less than or equal to 90 micrometers for the deformation of the force-bearing surface 71. In this example, the miniature force sensor 600 can detect a pressure detection signal with a signal-to-noise ratio greater than or equal to 18 dB for the pressure sensing of the force-bearing surface 71.

In some examples, the force-bearing surface 71 accounts for greater than or equal to 1% and less than or equal to 50% of the side surface of the housing of the battery pack 300a on which the force-bearing surface 71 is located. In some examples, the proportion is greater than or equal to 1% and less than or equal to 40%. In some examples, the proportion is greater than or equal to 1% and less than or equal to 30%. In some examples, the proportion is greater than or equal to 1% and less than or equal to 20%. In some examples, the proportion is greater than or equal to 1% and less than or equal to 10%. The force-bearing surface 71 is made of the same material as the battery pack housing 31, such as plastic. The use of the miniature force sensor 600 does not impose special requirements on the material of the force-bearing surface 71.

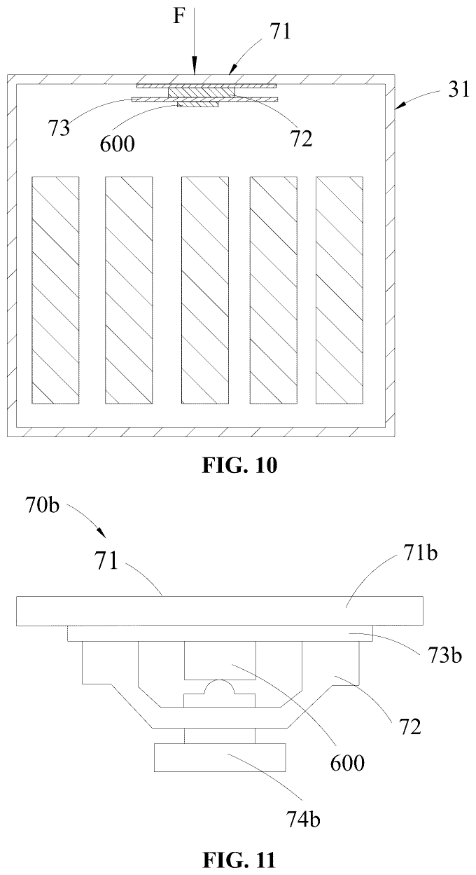

As shown in FIG. 10, when the miniature force sensor 600 is mounted, a buffer 72 is disposed between the force-bearing surface 71 and the miniature force sensor 600. The touch force applied to the force-bearing surface 71 is transmitted to the miniature force sensor 600 through the buffer 72. A circuit board 73 is disposed between the buffer 72 and the miniature force sensor 600, and the miniature force sensor 600 is bonded to the circuit board 73. Optionally, the buffer 72 includes rubber or silicone. Optionally, the buffer 72 may be made of various materials, such as rubber or polymers (for example, urethane, polyurethane, or silicone resin). The miniature force sensor 600 and the circuit board 73 are bonded using an adhesive, such as a pressure-sensitive adhesive (PSA), a double-sided adhesive (DSA), or other structural adhesives. Optionally, the miniature force sensor 600 and the circuit board 73 are bonded by welding. Optionally, the circuit board 73 includes a printed circuit board (PCB) 73 and a flexible printed circuit (FPC) board 73. The circuit board 73 has a thickness less than or equal to 1 mm. In some examples, the circuit board 73 has a thickness less than or equal to 0.8 mm, 0.7 mm, 0.6 mm, or 0.5 mm.

In this example, a controller is disposed on the circuit board 73 and electrically connected to the miniature force sensor 600, and the controller reads the pressure value or deformation detected by the miniature force sensor 600. Optionally, the controller uses a dedicated control chip, for example, a single-chip microcomputer or a microcontroller unit (MCU). Optionally, the controller is configured to, when the difference between the force value and the reference value is greater than or equal to a first threshold, determine that the force-bearing surface 71 receives a user operation instruction, that is, an external force applied by the user, and implement the relevant function. In some examples, a second threshold is further provided, and the controller is configured to, when the rate of change of the force value is greater than or equal to the second threshold, determine that the force-bearing surface 71 receives a user operation instruction, that is, an external force applied by the user, and implement the relevant function. The relevant function includes starting or stopping the discharge of the battery pack 300a. Optionally, the relevant functions include some adjustment operations for the battery pack 300a.

During the determination process by the controller, the miniature force sensor 600 generates force sensor data at a specified sampling frequency, and an interruption is triggered when the threshold is exceeded. In this example, the sampling frequency is greater than or equal to 500 Hz. The reference value is relative to a baseline. The miniature force sensor 600 implements a sensor baseline tracking algorithm that updates the baseline at a predetermined frequency, that is, updates the “zero” baseline value of each sensor, and updates the interruption threshold and the automatic calibration threshold accordingly. When the pressure value signal is less than the automatic calibration threshold, the baseline is updated at a prespecified rate. The controller updates the baseline by comparing the force value with the automatic calibration threshold. When the force value reading exceeds the automatic calibration threshold, the baseline stops being updated and a calibration reset timer is activated. When the calibration reset timeout occurs, the baseline is updated according to the baseline weight. For the automatic calibration level and the interruption level, reference is made to the baseline value. Therefore, the updating of the baseline automatically changes the preceding thresholds. An interruption is triggered when the number of times that the interruption threshold is reached exceeds the number of times set in the register. Automatic calibration is not performed when the force sensor measurement value is greater than the interruption threshold. Once the force measurement value is less than the automatic calibration threshold, the automatic calibration procedure is reactivated. This doesn't occur immediately, but occurs after an additional waiting time set by the register, which is a transient delay before the automatic calibration procedure starts.

In some examples, as shown in FIG. 5, to provide a better interactive experience between the human-machine interaction device 38 and the user, the human-machine interaction device 38 includes a display portion for being operated or providing feedback information. In some examples, the display portion includes a display, such as a display screen or an indicator light. In some examples, the display portion includes a touchscreen. Optionally, the controller determines that the force-bearing surface 71 receives a user operation instruction, that is, an external force applied by the user, and implements the relevant function, including lighting up the display portion. In some examples, the force-bearing surface 71 is disposed on a touchscreen 70b or the display screen. The miniature force sensor 600 recognizes the operation directly performed by the user on the display portion, thereby waking up or lighting up the display portion. In some examples, the force-bearing surface 71 is disposed on the battery pack housing 31, and the miniature force sensor 600 recognizes the operation at a designated position on the battery pack housing 31, thereby waking up or lighting up the display portion. Optionally, the touchscreen may be, for example, a liquid-crystal display (LCD), a light-emitting diode (LED) display, a display including organic light-emitting diodes (OLEDs), or an organic electroluminescent (EL) display. In some examples, the human-machine interaction device 38 includes a touchpad, and the touchpad includes a conventional touchpad and a digitizer.

As shown in FIG. 11, the force-bearing surface 71 is disposed on the touchscreen, and the miniature force sensor 600 is disposed on the back side of the force-bearing surface 71. The touchscreen includes a frame 74b, a touch surface 71b, and a main control board 73b. A buffer 72 is disposed between the touch surface 71b and the miniature force sensor 600. The touch force applied to the touch surface 71b is transmitted to the miniature force sensor 600 through the buffer 72. The main control board 73b is disposed between the buffer 72 and the miniature force sensor 600. The miniature force sensor 600 is bonded to the main control board 73b. Optionally, the buffer 72 includes rubber or silicone. Optionally, the buffer 72 may be made of various materials, such as rubber or polymers (for example, urethane, polyurethane, or silicone resin). The miniature force sensor 600 and the main control board 73b are bonded using an adhesive, such as a PSA, a DSA, or other structural adhesives. Optionally, the miniature force sensor 600 and the main control board 73b are bonded by welding. In this example, the controller is configured to determine that the force-bearing surface 71 is pressed by the user and activate or light up the electronic touchscreen 70b or the touchpad.

In some examples, the force-bearing component is disposed on the human-machine interaction device of the power tool 10. The human-machine interaction device allows the user to operate the power tool 10, feed back the working state of the power tool 10, and display information about the power tool 10. The force-bearing component is formed on or connected to the housing. The force-bearing component includes a force-bearing surface for receiving an external force and generating different deformation parameters when the external force changes. The force-bearing component includes a force-bearing surface for receiving an external force, and the miniature force sensor 600 is disposed on the inner side of the housing. The miniature force sensor 600 is disposed on the back or side of the force-bearing surface 71 or on the outer periphery of the force-bearing surface. The human-machine interaction device further includes a start control device for the power tool 10. In the related art, the start control device for the power tool 10 adopts a trigger switch, and the user starts or stops the power tool 10 by triggering the trigger switch. The miniature force sensor 600 is disposed inside the housing. The preceding content in which the battery pack 300 is used as an example is applicable to the power tool 10, so the details are not repeated.

In some examples, the force-bearing component is disposed on the human-machine interaction device of the charging device 500. The human-machine interaction device allows the user to operate the charging device 500, feed back the working state of the charging device, and display information about the charging device. The charging device 500 includes a housing, and the force-bearing component is disposed on the housing. The miniature force sensor 600 is mounted on the inner side of the charger housing. The force-bearing component is formed on or connected to the housing. The force-bearing component includes a force-bearing surface. The miniature force sensor 600 is connected to the back or side of the force-bearing surface or disposed on the outer periphery of the force-bearing surface. In this example, the charging device 500 has a waterproof rating of at least IPX6 so that the charging station 500d and the portable power station 500c for the smart robotic mower can operate in more diverse working conditions and adapt to more usage environments. The preceding content in which the battery pack 300 is used as an example is applicable to the charging device 500, so the details are not repeated.

As another example of the present application, a combination of multiple miniature force sensors 600 is used to achieve the detection of touch forces over a planar region of a certain size. In this example, the case where the multiple miniature force sensors 600 are disposed in a control panel is used as an example, and the control panel is used for controlling the electrical device or the battery pack 300. A control panel 70c is used for controlling the power tool 10, the battery pack 300, and the charging device 500.

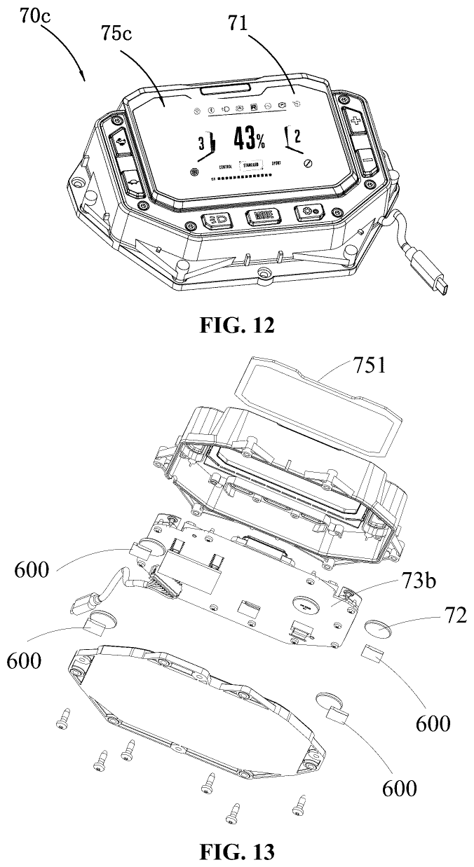

As shown in FIG. 4, the case where the power tool 10 is the outdoor traveling device 400 is used as an example, and the control panel 70c provides a user interface for controlling the outdoor traveling device 400. As shown in FIGS. 12 and 13, the control panel 70c provides a user interface for user operation and for providing feedback on the working state of the outdoor traveling device 400.

In this example, the control panel 70c includes a display 75c for being operated and/or for displaying. In some examples, the display 75c is used for displaying, that is, the display 75c is used for providing feedback to the user, that is, prompting information. The display 75c may be, for example, an LCD, an LED display, a display including the OLEDs, or an organic EL display. In some examples, an input portion for user settings is further included. The input portion may be buttons, a mini keyboard, knobs/toggle buttons, or the like.

In some examples, the display 75c is configured to be a touchscreen so that the display and the input portion are integrated. In some examples, the input portion includes a touchpad. Input is performed using the touchpad, and display is performed by the display 75c. In this example, the control panel 70c includes a flat force-bearing surface 71c and at least three miniature force sensors 600 disposed on the back side of the force-bearing surface 71c.

The force-bearing surface 71c is an exposed surface of the control panel 70c, that is, a surface that is convenient for the user to touch. The force-bearing surface 71c is configured to be a surface of an outer screen member 751 of the display 75c. It is to be understood that “the back side of the force-bearing surface 71c” is a surface of the outer screen member 751 facing the inside of the control panel 70c. Optionally, the outer screen member 751 is a lens. In some examples, the lens is made of a polymer material. In some examples, the lens is made of polycarbonate. In some examples, the lens is made of glass, such as organic glass. In some examples, the lens is made of plastic. In some examples, the force-bearing surface 71c is configured to be the surface of a protective cover covering the outer screen member 751 of the display 75c. Since the working conditions of the outdoor traveling device 400 are relatively harsh, directly exposing the outer screen member 751 of the display 75c poses a relatively high risk of wear. Therefore, for some outdoor traveling devices 400, a tempered glass film covers the outer side of the outer screen member 751 of the display 75c. In such an example, “the back side of the force-bearing surface 71c” is still the surface of the outer screen member 751 facing the inside of the control panel 70c. The protective cover and the outer screen member 751 of the display 75c form the exposed surface of the control panel 70c.

In this example, the diagonal dimension of the control panel 70c is greater than or equal to 2.4 inches and less than or equal to 13 inches. The force-bearing surface 71c is rectangular or basically rectangular.

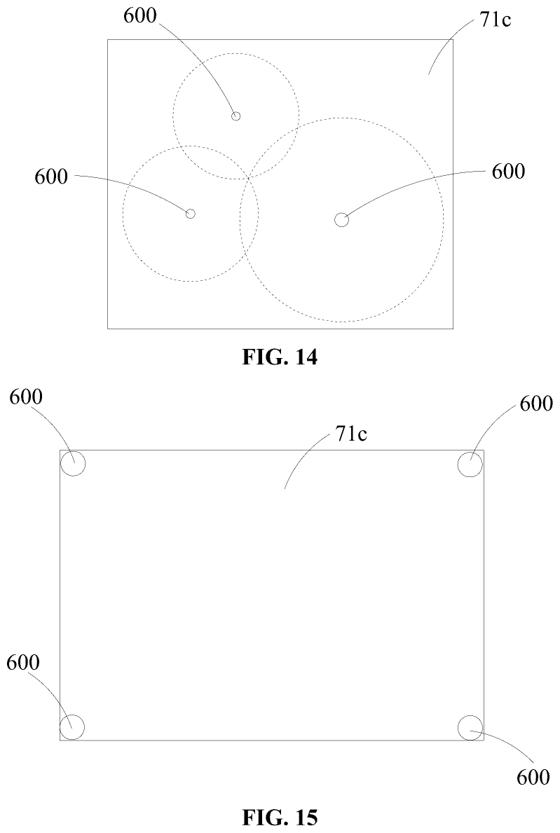

As shown in FIG. 14, when three miniature force sensors 600 are provided, the three miniature force sensors 600 are arranged in a triangle, and the distances among the three miniature force sensors 600 are determined by their optimal detection ranges. Optionally, to ensure no blind spots in detection, the detection ranges of the three miniature force sensors 600 overlap with one another.

As shown in FIG. 15, the miniature force sensors 600 are disposed at the corners of a rectangle, that is, the corners of the force-bearing surface 71c. To achieve a detection range that can basically cover the entire force-bearing surface 71c, the number of miniature force sensors 600 is greater than or equal to four, with at least one miniature force sensor 600 disposed at each corner of the force-bearing surface 71c. The case where four miniature force sensors 600 are arranged is used as an example. During installation, two miniature force sensors 600 are arranged along a first direction, two miniature force sensors 600 are arranged along a second direction, and for at least two miniature force sensors 600, the distance between each miniature force sensor 600 and the corresponding peripheral edge of the force-bearing surface 71c is substantially consistent. In some examples, the distance between two force sensors is greater than or equal to 2 mm.

In some examples, the number of miniature force sensors 600 is greater than four, and during installation, additional miniature force sensors 600 may be provided between two corners.

With continued reference to FIGS. 11 and 13, the control panel 70c further includes the main control board 73b for implementing the relevant function according to the output signal of the miniature force sensor 600. The main control board 73b also includes the circuit board 73 and the controller. In this example, the buffer 72 is disposed between the force-bearing surface 71 and the miniature force sensor 600. The touch force applied to the force-bearing surface 71 is transmitted to the miniature force sensor 600 through the buffer 72. The circuit board 73 is disposed between the buffer 72 and the miniature force sensor 600. The miniature force sensor 600 is bonded to the circuit board 73. Optionally, the buffer 72 includes rubber or silicone. Optionally, the buffer 72 may be made of various materials, such as rubber or polymers (for example, urethane, polyurethane, or silicone resin). The miniature force sensor 600 and the circuit board 73 are bonded using an adhesive, such as a PSA, a DSA, or other structural adhesives. Optionally, the miniature force sensor 600 and the circuit board 73 are bonded by welding.

In this example, the controller is electrically connected to the miniature force sensor 600, and the controller reads the pressure value detected by the miniature force sensor 600. Optionally, the controller uses a dedicated control chip, for example, a single-chip microcomputer or an MCU. The controller is configured to, when the difference between the pressure value and the reference value is greater than or equal to the first threshold, determine that the force-bearing surface 71 is pressed by the user and implement the relevant function. In some examples, a second threshold is further provided, and the controller is configured to, when the rate of change of the pressure value is greater than or equal to the second threshold, determine that the force-bearing surface 71 is pressed by the user and implement the relevant function. The relevant function includes, but is not limited to, lighting up or activating the display 75c, locking or unlocking the display 75c, or switching between different modes or menus by tapping or different touches.

During the determination process by the controller, the miniature force sensor 600 generates force sensor data at a specified sampling frequency, and an interruption is triggered when the threshold is exceeded. In this example, the sampling frequency is greater than or equal to 500 Hz. The reference value is relative to a baseline. The miniature force sensor 600 implements a sensor baseline tracking algorithm that updates the baseline at a predetermined frequency, that is, updates the “zero” baseline value of each sensor, and updates the interruption threshold and the automatic calibration threshold accordingly. When the pressure value signal is less than the automatic calibration threshold, the baseline is updated at a prespecified rate. The controller updates the baseline by comparing the force value with the automatic calibration threshold. When the force value reading exceeds the automatic calibration threshold, the baseline stops being updated and a calibration reset timer is activated. When the calibration reset timeout occurs, the baseline is updated according to the baseline weight. For the automatic calibration level and the interruption level, reference is made to the baseline value. Therefore, the updating of the baseline automatically changes the preceding thresholds. An interruption is triggered when the number of times that the interruption threshold is reached exceeds the number of times set in the register. Automatic calibration is not performed when the force sensor measurement value is greater than the interruption threshold. Once the force measurement value is less than the automatic calibration threshold, the automatic calibration procedure is reactivated. This doesn't occur immediately, but occurs after an additional waiting time set by the register, which is a transient delay before the automatic calibration procedure starts.

Unlike a capacitive touch sensor, the miniature force sensor 600 does not require a direct contact with the user. The miniature force sensor 600 may be entirely disposed inside the control panel 70c so that the control panel 70c may maintain an integrally formed housing structure. In this example, the control panel 70c has a waterproof rating of at least IPX6. Compared with the mobile electronic device, the control panel 70c of the electrical device is mainly operated by point touching, with fewer multi-finger operations and dragging/sliding operations. Therefore, the miniature force sensor 600 is more suitable for use in the field of electrical devices. When used in the field of mobile electronic devices, the miniature force sensor 600 needs to be used in conjunction with the capacitive touch sensor. In this case, usage costs are increased.

In some examples, the control panel 70c may be used in other power tools 10, such as a handheld power tool 10 with the display 75c or a garden tool with the display 75c.

As another example of the present application, a combination of multiple miniature force sensors 600 is used to achieve the output of corresponding linear signals through different continuous or intermittent operations. In this example, the rotational speed regulation of a motor 12 of the power tool 10 is used as an example.

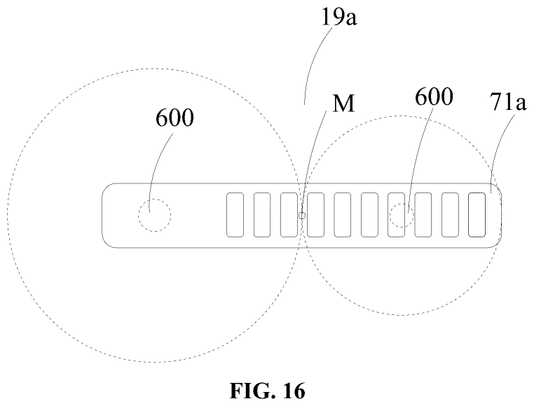

As shown in FIGS. 2, 16, and 17, the power tool 10 includes a housing 11, a motor 12, and an output portion 13. The housing 11 is provided with an accommodation space, and the motor 12 is at least partially disposed within the accommodation space. The motor 12 is used for providing power and can rotatably drive the output portion 13. The output portion 13 is used for outputting power. In this example, the output portion 13 includes an output shaft coupled to the motor 12, and the output shaft rotates about an output axis. To regulate and set the target rotational speed of the motor 12, the power tool 10 further includes an adjustment mechanism 19 and a controller. In this example, the adjustment mechanism 19 includes a speed regulation mechanism 19a for acquiring a user input. The controller is communicatively connected to the speed regulation mechanism 19a and determines the target rotational speed of the motor 12 according to the output of the speed regulation mechanism 19a. The speed regulation mechanism 19a includes the miniature force sensor 600. By applying different forces to the miniature force sensor 600, the user causes the miniature force sensor 600 to output different signals to the controller, and the controller determines the corresponding target rotational speeds of the motor 12 according to the different signals.

As another example of the present application, as shown in FIG. 2, a combination of multiple miniature force sensors 600 is used to achieve the output of corresponding linear signals through different continuous or intermittent operations. In this example, the rotational speed regulation of a motor 12 of the power tool 10 is used as an example. Compared with speed regulation using mechanical structures in the related art, the use of the miniature force sensor 600 can maintain the integrity of the housing 11. The installation of the speed regulation mechanism 19a does not require holes or other hollow structures, or space reservation due to the stroke is not required, thereby avoiding adverse effects on the sealing performance of the housing 11 of the power tool 10. For the power tool 10, such as the polisher 100a or other grinding products, a large amount of dust and debris is generated during operation. Maintaining the sealing performance of the housing 11 can prevent dust and debris from entering the machine.

As shown in FIG. 17, the speed regulation mechanism 19a includes an elongated force-bearing surface 71a, and the miniature force sensor 600 is disposed on the back side of the force-bearing surface 71a. The force-bearing surface 71a is configured to be a region defined by the housing 11. In some examples, the miniature force sensor 600 is directly or indirectly connected to the back side of the force-bearing surface 71a. In some examples, the miniature force sensor 600 is disposed on the back side of the force-bearing surface 71a but is not in contact with the back side of the force-bearing surface 71a, that is, the miniature force sensor 600 is suspended relative to the back side of the force-bearing surface 71a. For example, the miniature force sensor 600 is disposed on the back side of the force-bearing surface 71a and is connected and fixed to the front or side of the force-bearing surface 71a through connectors or fasteners.

The force-bearing surface 71a is configured to be a region defined by the housing 11, ensuring that the housing 11 has an integral structure. Optionally, the force-bearing surface 71a and the housing 11 are made of the same material and have the same appearance effect. The force-bearing surface 71a is indicated by an elongated mark on the housing 11. For example, the force-bearing surface 71a may be indicated by an elongated screen-printed mark on the housing 11, an adhesive label, etching, texturing, or patterning. In some examples, the force-bearing surface 71 and the housing 11 are made of different materials or have different appearance indications. For example, the force-bearing surface 71a is made of a light-transmissive material that is locally transparent or semi-transparent so that different operating pressures applied by the user can be fed back through lighting. In some examples, the force-bearing surface 71a has a different thickness or is made of a different material to satisfy the detection requirement of the miniature force sensor 600. Optionally, the force-bearing surface 71a is disposed near the grip of the housing 11. Optionally, the force-bearing surface 71a is disposed on the power supply connecting portion of the housing 11. Optionally, the force-bearing surface 71a is disposed at any position on the housing 11 that is convenient for operation.

During installation, two miniature force sensors 600 are disposed on two sides of the midpoint M of the elongated strip, respectively. That is, along the length direction of the elongated strip, two miniature force sensors 600 are disposed on two sides of the midpoint M, respectively. In this example, when the pressure applied by the user on the force-bearing surface 71a is transmitted to the miniature force sensor 600, the sensed value varies with the distance between the position to which the force is applied and the miniature force sensor 600. Moreover, since the miniature force sensors 600 are disposed on two sides of the midpoint M of the elongated strip, the output signals of the miniature force sensors 600 may be linearly matched with the user touches at different positions or different touch forces through the program conversion of the system. In some examples, the controller is configured to determine the target rotational speed of the motor 12 according to the ratio of the outputs of the two miniature force sensors 600. In some examples, the controller is further configured to linearly adjust the actual rotational speed of the motor 12 according to the ratio of the outputs of the two miniature force sensors 600. In some examples, through the user's finger sliding on the force-bearing surface 71, stepless adjustment, for example, stepless adjustment of the target rotational speed of the motor 12 and the actual rotational speed of the motor 12, is achieved. Optionally, the controller is configured to perform bidirectional control according to the ratio of the outputs of the two miniature force sensors 600, that is, increasing and decreasing are achieved in different sliding manners.

In some alternative examples, the miniature force sensor 600 may also be used instead of a start switch so that by touching a specific region, the user can keep the electric motor operating. The controller is configured to start or stop the motor 12 according to the output of any miniature force sensor 600. For a long-term operation, user efforts can be reduced. On the other hand, eliminating the trigger or other mechanical switches can maintain the sealing performance of the housing of the whole machine and improve the waterproof and dustproof performance of the machine, especially for products with high waterproof and dustproof requirements, such as a cleaning machine, a mixer, and an underwater product.

In some alternative examples, when the miniature force sensor 600 is used instead of a start switch, the miniature force sensor 600 can be used with no special treatment on the housing since the miniature force sensor 600 is small in size and can detect smaller deformations. Therefore, by providing multiple miniature force sensors 600 at different positions, for the product with multiple gripping positions, the product (such as an angle drill, an angle grinder, or a drywall screwdriver) can be started and stopped at each position.

In some examples, the controller is configured to lock or unlock the trigger according to the output of any miniature force sensor 600. Alternatively, the controller is configured to turn on or off an illumination component in the power tool 10 according to the output of any miniature force sensor 600. Alternatively, the controller is configured to activate or deactivate the adjustment mechanism according to the output of any miniature force sensor 600.

In some examples, the miniature force sensor 600 may replace a mode switch. For example, multiple miniature force sensors 600 are disposed at two or more positions on the machine, respectively. By applying forces to different miniature force sensors 600, the miniature force sensors 600 send corresponding signals to the controller so that the controller controls the electric motor or the corresponding response components to perform the corresponding actions. For example, multiple miniature force sensors 600 are linearly arranged so that the multiple miniature force sensors output a force detection signal that changes linearly during the sliding operation of the user. Through the user's sliding operation over the miniature force sensors to different positions, different corresponding signals are outputted to the controller so that the controller controls the electric motor or the corresponding response components to perform the corresponding actions. For example, the user may switch between the forward rotation mode and the reverse rotation mode of the electric motor through different operations on the miniature force sensors 600, for example, touching the left side for forward rotation or reverse rotation, and touching the right side for reverse rotation or forward rotation. For example, the user may switch the speed mode of the electric motor, that is, switch the electric motor to the maximum rotational speed, through different operations on the miniature force sensors 600.

In some alternative examples, as shown in FIG. 17, the power tool is the electrical device 200 that is not driven by the motor, which is generally not provided with the motor 12 and directly uses electrical energy to drive the working portion 21. For example, the electrical device 200 that is not driven by the motor is an illumination device and includes an illumination mechanism. The illumination mechanism includes a lamp head for emitting light, the lamp head includes a lamp head housing and a lamp board, and the lamp board is accommodated in the lamp head housing. The lamp board includes LED lamp beads or may include chip on board (COB) lamp beads. The adjustment mechanism 19 includes an elongated force-bearing surface 71a, and the miniature force sensor 600 is disposed on the back side of the force-bearing surface 71a. The force-bearing surface 71a is a region defined on the housing 11. The adjustment mechanism 19 is used for acquiring a user input. The controller is communicatively connected to the adjustment mechanism 19 and determines the target working state of an illumination mechanism 21 according to the output of the adjustment mechanism 19. The working state includes turning on the illumination mechanism 21, turning off the illumination mechanism 21, and changing the output form of the light state, for example, changing the illumination state of the illumination mechanism 21. The adjustment mechanism 19 includes the miniature force sensor 600. By applying different forces to the miniature force sensor 600, the user causes the miniature force sensor 600 to output different signals to the controller, and the controller determines the corresponding illumination states according to the different signals. The illumination states include the brightness, color temperature, color, and illumination effect of the light. For example, the illumination effect includes steady on, flashing, double flashing, breathing light, or scrolling light.

In some alternative examples, the working portion 21 is part of the power tool 10, the power tool 10 includes the motor 12, and the working portion 21 serves as an auxiliary component of the power tool 10, such as a supplementary light, a laser scale, or an alarm mechanism of the power tool 10. The supplementary light of the power tool 10 is used as an example. The adjustment mechanism 19 includes an elongated force-bearing surface 71a, and the miniature force sensor 600 is disposed on the back side of the force-bearing surface 71a. The force-bearing surface 71a is a region defined on the housing 11. The adjustment mechanism 19 is used for acquiring a user input. The controller is communicatively connected to the adjustment mechanism 19 and determines the target working state of the working portion 21 according to the output of the adjustment mechanism 19. The working state includes enabling sound or light emission of the working portion 21, turning off the working portion 21, and changing the output form of the sound/light state. For example, the working state includes the illumination state of the light. The illumination state of the light is determined according to the output of the adjustment mechanism 19. By applying different forces to the miniature force sensor 600, the user causes the miniature force sensor 600 to output different signals to the controller, and the controller determines the corresponding illumination states according to the different signals. The illumination states include the brightness, color temperature, color, and illumination effect of the light. For example, the illumination effect includes steady on, flashing, double flashing, breathing light, or scrolling light.

As another specific implementation manner, the power tool 10, the battery pack 300, or the charging device 500 includes a force-bearing component. The force-bearing component is formed on or connected to the housing of the power tool 10, the battery pack 300, or the charging device 500. The force-bearing component includes a force-bearing surface for receiving an external force and generating different deformation parameters when the external force changes. The deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations.

In some examples, the force-bearing surface 71 is disposed on a grip 113. The power tool 10 is used as an example. The grip 113 where the user holds the power tool 10 during use or transport is defined on the housing 11. The miniature force sensor 600 is used for detecting changes in the gripping force applied by the user to the power tool 10. The usage state of the power tool 10 is determined according to changes in gripping force, and then the protection program is initiated.

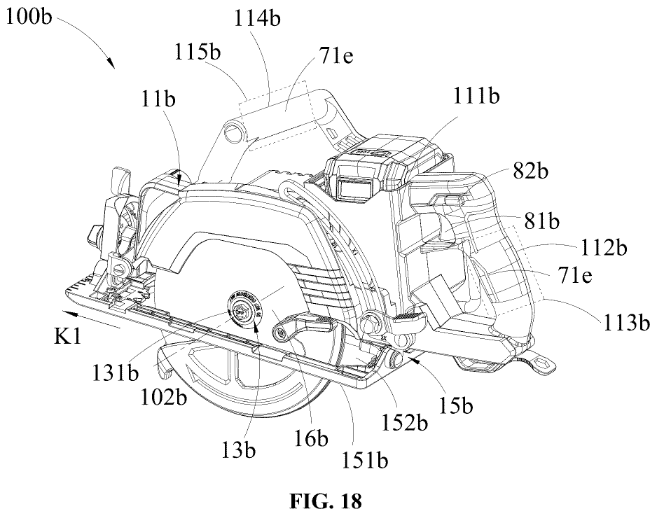

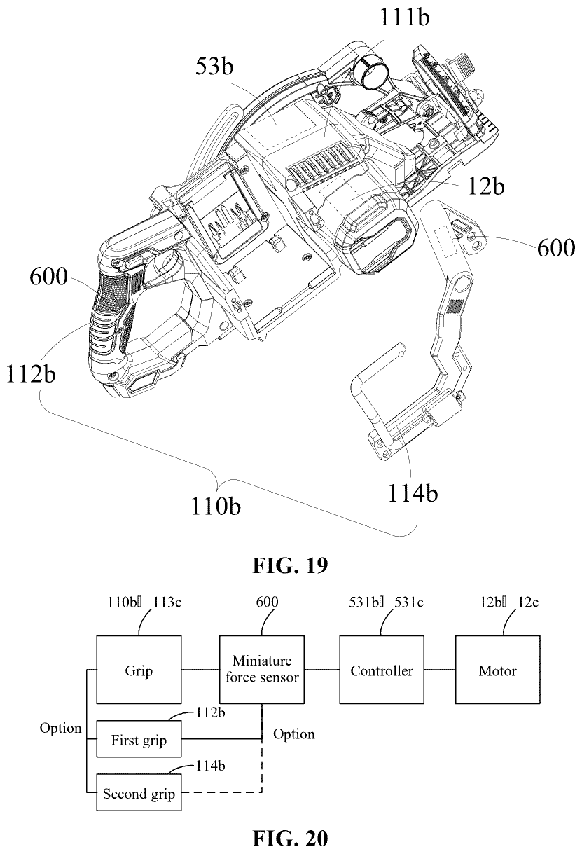

As shown in FIGS. 18 and 19, the power tool 10 is a handheld power tool. For example, the handheld power tool includes a handheld cutting tool, such as a circular saw, a chainsaw, a jigsaw, or a hedge trimmer. The handheld power tool further includes a rotary torque output tool. It is to be understood that the rotary torque output tool outputs rotary torque to the workpiece through an output portion driven to rotate. For example, the rotary torque output tool includes a screwdriver, an electric drill, an impact tool, an angle grinder, or an earth auger.

As shown in FIGS. 18 and 19, an electric circular saw 100b is used as an example, and the electric circular saw 100b includes a housing 11b, an output portion 13b, a motor 12b, and a base plate 15b. The output portion 13b includes an output shaft 131b and a cutting part 16b, and the output shaft 131b is used for mounting the cutting part 16b. The cutting part 16b rotates about the axis of the output shaft 131b. In this example, the cutting part 16b is a circular saw blade. The motor 12b is disposed inside the housing 11b and used for driving the output shaft 131b to rotate. The output shaft 131b is rotatably coupled to the motor 12b relative to the housing 11b. A power transmission mechanism is used for transmitting the output power of the motor 12b to the output shaft 131b. The housing 11b is used for accommodating the motor 12b, and the output shaft 131b and the cutting part 16b are disposed outside the housing 11b. The base plate 15b is movably connected to the housing 11b, and the base plate 15b is formed with a base plate bottom surface 151b in contact with the workpiece. The base plate 15b is formed with a saw blade through hole 152b extending along a first direction Fb, and the saw blade can pass through the saw blade through hole 152b and protrude downward from the base plate bottom surface 151b. In this example, the motor 12b is specifically an electric motor, which may optionally be a brushless electric motor. The electric motor is used below instead of the motor 12b, but this does not affect the substantive content of the present application.

The housing 11b includes a first housing 111b, and the first housing 111b is formed with or connected to a grip 110b for holding. In this example, the grip 110b includes a first grip 112b. The first grip 112b is located at the rear end of the circular saw and can be held by the user, thereby operating the circular saw to perform a cutting operation. A control switch 81b and a safety switch 82b are further provided on the grip 110b, and the control switch 81b can be triggered only when the safety switch 82b is pressed. That is to say, two actions are required before the electric motor 12b or the assembly of the electric motor 12b can be activated. Therefore, the danger caused by a single operation is avoided. When the user holds the grip 110b, the hand of the user holding the grip 110b can trigger the safety switch 82b and the control switch 81b to start or shut down the electric circular saw 100b.

The grip 110b further includes a second grip 114b. The second grip 114b is formed on or connected to the first housing 111b. The second grip 114b is located at the front end of the circular saw and is used as an auxiliary handle. In an example, the second grip 114b may be an external handle mounted on the housing 11b, that is to say, the second grip 114b may be an auxiliary operating component mounted separately on the housing 11b.

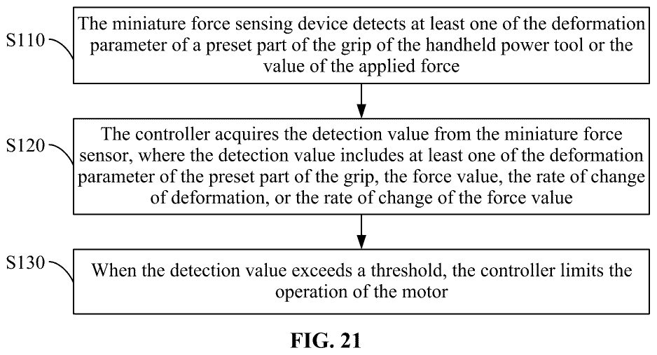

As shown in FIGS. 20 and 21, the electric circular saw 100b further includes a controller 531b disposed inside the housing 11b. The controller 531b is used for controlling the rotation of the motor 12b. The controller 531b is disposed on a control circuit board 53b, where the control circuit board 53b includes a PCB and an FPC board. The controller 531b uses a dedicated control chip, for example, a single-chip microcomputer or an MCU. It is to be noted that the control chip may be integrated into the controller 531b or may be disposed independently of the controller 531b. A structural relationship between a driver chip and the controller 531b is not limited in this example.

In this example, the electric circular saw 100b includes the miniature force sensor 600 for detecting at least one of the deformation parameter of a preset part of the grip 110b or the value of the applied force. It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations. The force value includes the value of the force applied to the force-bearing surface or the parameter derived from the force value through calculations, such as torque. A parameter generated based on the force, such as a change in speed, is further included.

The controller 531b is connected to the miniature force sensor 600. Optionally, the controller 531b is connected to the miniature force sensor 600 via digital signals. Optionally, the controller 531b is connected to the miniature force sensor 600 via analog signals. Optionally, the controller 531b is connected to the miniature force sensor 600 via wireless signals. The controller 531b is the main controller of the power tool. Optionally, the controller 531b is a separate controller controlled by the miniature force sensor 600. One control circuit board 53b may be provided. Optionally, two or more control circuit boards 53b are provided.

The controller 531b is configured to acquire the detection value of the miniature force sensor 600 and control the motor 12b according to the detection value. In this example, the detection value includes at least one of the deformation parameter of a preset part of the grip, the force value, the rate of change of deformation, or the rate of change of the force value. When the detection value exceeds a threshold, the power supply to the motor 12b is stopped. In this example, the usage state of the electric circular saw 100b is determined according to the gripping force of the user or the change in the gripping force of the user. Optionally, according to the change in gripping force, the controller 531b determines whether the power tool 10 experiences kickback. When the controller 531b determines that kickback occurs, the kickback protection program is initiated. For example, when at least one of the deformation parameter of a preset part of the grip, the force value, the rate of change of deformation, or the rate of change of the force value measured by the miniature force sensor 600 exceeds the threshold, the controller 531b determines that the electric circular saw 100b experiences kickback, and the controller 531b controls the motor 12b to cut off power, shuts down the motor 12b, or limits the output of the motor 12b to protect the user from being injured by the kickback of the electric circular saw 100b.

As shown in FIG. 19, the miniature force sensor 600 is disposed on a gripping portion of the second grip 114b. In some examples, the second grip 114b is provided with a gripping portion 115b for accommodating fingers or supporting the palm according to the user's usage habits. The gripping portion 115b has structural features that are easy for the user to identify, such as protrusions, a wavy structure, or an arc-shaped structure. The gripping portion 115b has surface treatment features that are easy for the user to identify, such as texturing, patterning, a soft rubber sleeve, different embedded materials, or different textures. In some examples, the gripping portion 115b does not have any features that distinguish it from other positions of the second grip 114b. In this case, the gripping portion 115b is at the position where the electric circular saw 100b is kept balanced after the user lifts the electric circular saw 100b up using the second grip 114b. In this example, the preset part of the grip 110b is disposed on the gripping portion 115b for accommodating fingers. Optionally, the gripping portion 115b for accommodating fingers is configured to be a finger receiving portion. The finger receiving portion includes a force-bearing surface 71e for receiving an external force and generating different deformation parameters when the external force changes. The miniature force sensor 600 outputs a corresponding signal to the controller 531b according to the deformation parameter of the force-bearing surface 71e, or the miniature force sensor 600 generates a corresponding force value parameter signal according to the deformation parameter of the force-bearing surface 71e and sends the force value parameter signal to the controller 531b.

In some examples, the miniature force sensor 600 detects and outputs the pressure value of the force-bearing surface 71e to the controller 531b during operation. When the controller 531b determines that the pressure value exceeds a pressure threshold, the controller 531b determines that the electric circular saw 100b experiences kickback, and the controller 531b initiates the anti-kickback program so that the controller 531b controls the motor 12b to shut down, stops the power supply to the motor 12b, or limits the output of the motor 12b. In some examples, the miniature force sensor 600 detects and outputs at least one of the following parameters to the controller 531b during operation: the deformation parameter of the force-bearing surface 71e, the force value, the rate of change of deformation, or the rate of change of the force value. When the controller 531b determines that at least one of the deformation parameter, the force value, the rate of change of deformation, or the rate of change of the force value exceeds the threshold, the controller 531b determines that the electric circular saw 100b experiences kickback, and the controller 531b initiates the anti-kickback program so that the controller 531b controls the motor 12b to shut down, stops the power supply to the motor 12b, or limits the output of the motor 12b.

In some examples, the miniature force sensor 600 is disposed on a gripping portion 113b of the first grip 112b. In this example, the gripping portion 113b of the first grip 112b is located behind the control switch 81b. For example, the gripping portion 113b of the first grip 112b is disposed within a range of a palm width (50 mm to 100 mm) behind the control switch 81b. In this example, the first grip 112b includes a force-bearing surface 71e for receiving an external force and generating different deformation parameters when the external force changes. The miniature force sensor 600 outputs a corresponding signal to the controller 531b according to the deformation parameter of the force-bearing surface 71e, or the miniature force sensor 600 generates a corresponding force value parameter signal according to the deformation parameter of the force-bearing surface 71e and sends the force value parameter signal to the controller 531b.

In some examples, the miniature force sensor 600 of the second grip 114b and the miniature force sensor 600 of the first grip 112b cooperate to detect and output the pressure values of the force-bearing surfaces 71e to the controller 531b during operation. For example, the detection value from the miniature force sensor 600 of the second grip 114b is configured to be the second pressure value, and the detection value from the miniature force sensor 600 of the first grip 112b is configured to be the first pressure value. When the controller 531b determines that the second pressure value exceeds a second pressure threshold or the first pressure value exceeds a first pressure threshold, the controller 531b determines that the electric circular saw 100b experiences kickback, and the controller 531b initiates the anti-kickback program so that the controller 531b controls the motor 12b to shut down, stops the power supply to the motor 12b, or limits the output of the motor 12b. The second pressure threshold is less than or equal to the first pressure threshold. In some examples, the miniature force sensor 600 of the second grip 114b and the miniature force sensor 600 of the first grip 112b cooperate to detect and output the pressure values of the force-bearing surfaces 71e to the controller 531b during operation. When the controller 531b determines that the rate of change of the second pressure value exceeds a second rate of change threshold or when the controller 531b determines that the rate of change of the first pressure value exceeds a first rate of change threshold, the controller 531b determines that the electric circular saw 100b experiences kickback, and the controller 531b initiates the anti-kickback program so that the controller 531b controls the motor 12b to shut down, stops the power supply to the motor 12b, or limits the output of the motor 12b.

In some examples, the force-bearing surface 71e is disposed on the grip 110b of the power tool or the handheld power tool. The force-bearing surface 71e is used for receiving an external force and generating different deformation parameters when the external force changes. The miniature force sensor 600 outputs a corresponding signal to the controller 531b according to the deformation parameter of the force-bearing surface 71e, or the miniature force sensor 600 generates a corresponding force value parameter signal according to the deformation parameter of the force-bearing surface 71e and sends the force value parameter signal to the controller 531b. According to the change in the gripping force applied by the user to the grip 110b, the controller 531b determines whether the cutting direction of the power tool 10 or the handheld power tool is consistent with the preset direction. When the controller 531b determines that the cutting direction is inconsistent with the preset direction or the deviation exceeds a standard value, the controller 531b activates a state indication portion to issue a prompt to the user or the controller 531b limits the output of the motor 12b to avoid the user's cutting deviation. For example, the power tool is a power tool product with a relatively stable feed direction during the cutting process, such as an electric circular saw, a jigsaw, or a track saw.

In some examples, the force-bearing surface 71e is disposed on the grip 110b of the power tool or the handheld power tool. The miniature force sensor 600 outputs a corresponding signal to the controller 531b according to the deformation parameter of the force-bearing surface 71e, or the miniature force sensor 600 generates a corresponding force value parameter signal according to the deformation parameter of the force-bearing surface 71e and sends the force value parameter signal to the controller 531b. According to the change in the gripping force applied by the user to the grip 110b, the controller 531b determines the magnitude of the thrust applied to the power tool 10 or the handheld power tool, and a signal is sent to the controller 531b. According to the thrust value, the controller 531b determines whether the output torque can satisfy the cutting requirements, and then the controller 531b controls the operation state of the motor 12b. Optionally, when the miniature force sensor detects an increase in gripping force, or an increase in gripping force in one direction, or an increase in the rate of change of the gripping force, it is determined that the torque outputted by the current electric motor 12b is less than the torque required for cutting the workpiece, and cutting becomes difficult. In this case, the controller 531b outputs a signal to the electric motor 12b to adjust the output torque, for example, to increase the output torque. Optionally, when the miniature force sensor 600 detects an increase in gripping force, or an increase in gripping force in one direction, or an increase in the change of the gripping force, it is determined that cutting work starts, and the controller 531b outputs a signal to start the electric motor 12b.

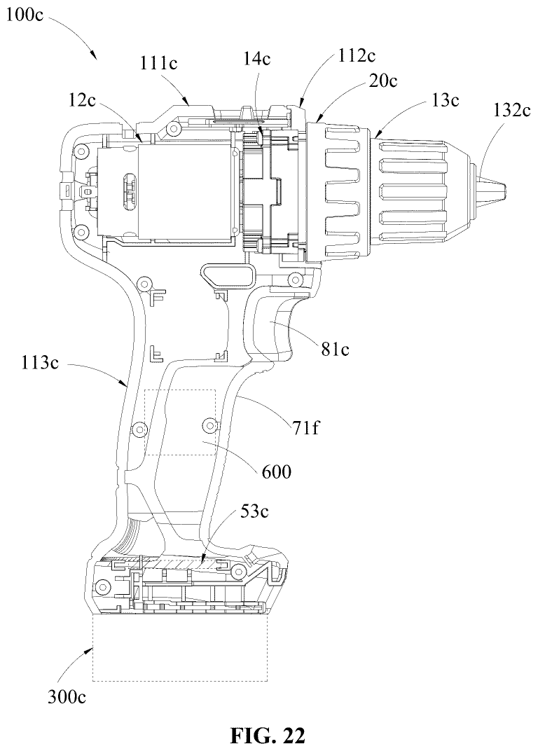

As shown in FIG. 22, in another example, an electric drill 100c is used as an example. The electric drill 100c includes a housing 11c, a motor 12c, and an output portion 20c. The output portion 20c includes an output shaft 131c for connecting a working attachment and driving the working attachment to rotate. A clamping assembly 132c is disposed at the front end of the output shaft 131c and may clamp corresponding working attachments, such as a screwdriver, a drill bit, and a sleeve, when different functions are implemented. The housing 11c includes a motor housing 111c for accommodating the motor 12c and an output housing 112c for accommodating at least part of the output portion 20c. The output housing 112c is connected to the front end of the motor housing 111c. The housing 11c is further formed with or connected to a grip 113c to be operated by the user. The grip 113c and the motor housing 111c form a T-shaped or L-shaped structure, thereby facilitating the hold and operation of the user. A power supply device is connected to one end of the grip 113c.

In this example, the grip 113c is provided with a trigger 81c for the user to operate to control the motor 12c. The electric drill 100c further includes a controller 531c disposed inside the housing 11c. The controller 531c is used for controlling the rotation of the motor 12c. The controller 531c is disposed on a control circuit board 53c, where the control circuit board 53c includes a PCB and an FPC board. The controller 531c uses a dedicated control chip, for example, a single-chip microcomputer or an MCU. It is to be noted that the control chip may be integrated into the controller 531c or may be disposed independently of the controller 531c. A structural relationship between a driver chip and the controller 531c is not limited in this example.

In this example, the electric drill 100c includes the miniature force sensor 600 for detecting at least one of the deformation parameter of a preset part of the grip 113c or the value of the applied force. It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations. The force value includes the value of the force applied to the force-bearing surface or the parameter derived from the force value through calculations, such as torque. A parameter generated based on the force, such as a change in speed, is further included.

The controller 531c is connected to the miniature force sensor 600. Optionally, the controller 531c is connected to the miniature force sensor 600 via digital signals. Optionally, the controller 531c is connected to the miniature force sensor 600 via analog signals. Optionally, the controller 531c is connected to the miniature force sensor 600 via wireless signals. The controller 531c is the main controller of the power tool. Optionally, the controller 531c is a separate controller controlled by the miniature force sensor 600. One control circuit board 53c may be provided. Optionally, two or more control circuit boards 53c are provided.

The controller 531c is configured to control the operation state of the motor 12c according to the detection value from the miniature force sensor 600. In this example, the detection value includes at least one of the deformation parameter of a preset part of the grip, the force value, the rate of change of deformation, or the rate of change of the force value. In this example, when at least one of the deformation parameter, the force value, the rate of change of the deformation parameter, or the rate of change of the force value detected by the miniature force sensor 600 exceeds a threshold, the power supply to the motor 12c is stopped. In this example, the usage state of the electric drill 100c is determined according to the gripping force of the user or the change in the gripping force of the user. Optionally, according to the change in gripping force, it is determined whether the electric drill 100c experiences a torque reaction during the rotation and torque output process. When the controller 531c determines that a torque reaction occurs, the torque-reaction protection program is initiated. For example, when the detection value from the miniature force sensor 600 exceeds a threshold, it is determined that the electric drill 100c has a risk of twisting the user's hand. The controller 531c controls the motor 12c to cut off power, shuts down the motor 12c, or limits the output of the motor 12c to protect the user from being injured by the electric drill 100c twisting the user's hand. For example, when the detection value from the miniature force sensor 600 exceeds the threshold, it is determined that the electric drill 100c has a risk of twisting the user's hand. The controller 531c limits the output of the motor 12c and then changes the direction of rotation of the motor 12c.

The grip 113c includes a force-bearing surface 71f for receiving an external force and generating different deformation parameters when the external force changes. The miniature force sensor 600 outputs a corresponding signal to the controller 531c according to the deformation parameter of the force-bearing surface 71f, or the miniature force sensor 600 generates a corresponding force value parameter signal according to the deformation parameter of the force-bearing surface 71f and sends the force value parameter signal to the controller 531c.

In some examples, the miniature force sensor 600 detects and outputs the pressure value of the force-bearing surface 71f to the controller 531c during operation. When the controller 531c determines that the pressure value exceeds a pressure threshold, the controller 531c determines that the electric drill 100c experiences a torque reaction, and the controller 531c initiates the anti-torque-reaction program so that the controller 531c controls the motor 12c to shut down or stops the power supply to the motor 12c. In some examples, the miniature force sensor 600 detects and outputs the pressure value of the force-bearing surface 71f to the controller 531c during operation. When the controller 531c determines that the rate of change of the pressure value exceeds a rate of change threshold, the controller 531c determines that the electric drill 100c experiences a torque reaction, and the controller 531c initiates the anti-torque-reaction program so that the controller 531c controls the motor 12c to shut down, stops the power supply to the motor 12c, or limits the output of the motor 12c. According to the operating habit, the force-bearing surface 71f is set starting from below the trigger 81c. Depending on the width of the palm, the extension length of the force-bearing surface 71f is in a range of 70 mm to 100 mm.

In some examples, the electric drill 100c further includes a gyroscope sensor for detecting the change in the torsion angle or torsion acceleration of the electric drill 100c. The gyroscope sensor may be a single-axis, two-axis, or three-axis MEMS system sensor or a rotation-type sensor. Other types of sensors also belong to the content disclosed by the present application. When the detection data received by the controller 531c from the gyroscope sensor is greater than a threshold and the detection data from the miniature force sensor 600 exceeds a threshold, the controller 531c determines that the electric drill 100c experiences a torque reaction, the controller 531c initiates the anti-torque-reaction program, and the controller 531c controls the motor 12c to shut down or stops the power supply to the motor 12c.

In some examples, the handheld power tool may be a handheld cutting tool or a rotary torque output tool. Optionally, the force-bearing surface 71e or 71f is disposed on the grip 110b or 113c of the power tool or handheld power tool. The force-bearing surface 71e or 71f is used for receiving an external force and generating different deformation parameters when the external force changes. The miniature force sensor 600 outputs a corresponding signal to the controller according to the deformation parameter of the force-bearing surface 71e or 71f, or the miniature force sensor 600 generates a corresponding force value parameter signal according to the deformation parameter of the force-bearing surface 71e or 71f and sends the force value parameter signal to the controller. According to the change in gripping force, the controller determines whether the handheld power tool falls while the motor is operating. When the controller determines that the handheld power tool falls, the fall protection program is initiated. In this case, the controller controls the motor to shut down.

Optionally, for a push power tool, such as a push mower, according to the change in gripping force, including the magnitude and direction of the gripping force, the controller determines the user's pushing difficulty, the dragging direction, and whether the user is holding the tool stably. The controller controls the self-propelling program of the push power tool according to the preceding determination results.

As shown in FIG. 21, this example further discloses a control method for a handheld power tool. The method specifically includes the steps below.

In S110, the miniature force sensing device detects at least one of the deformation parameter of a preset part of the grip of the handheld power tool or the value of the applied force.

In S120, the controller acquires the detection value from the miniature force sensor, where the detection value includes at least one of the deformation parameter of the preset part of the grip, the force value, the rate of change of deformation, or the rate of change of the force value.

In S130, when the detection value exceeds a threshold, the controller limits the operation of the motor.

In some examples, the force-bearing surface 71e or 71f is used for receiving an external force and generating different deformation parameters when the external force changes. The miniature force sensor 600 outputs a corresponding signal to the controller according to the deformation parameter of the force-bearing surface 71e or 71f, or the miniature force sensor 600 generates a corresponding force value parameter signal according to the deformation parameter of the force-bearing surface 71e or 71f and sends the force value parameter signal to the controller. The power tool 10 includes a memory for collecting gripping force data detected by the miniature force sensor during the user's use of the power tool. The gripping force data includes, but is not limited to, a gripping direction, a common gripping position, and a common gripping force. In this manner, it is convenient for the designer to collect data on customer usage habits to improve the human-machine interaction of the product. In some examples, the power tool 10 includes a server, and the server includes a memory and a processor. The processor may process data at preset time intervals. Optionally, the server may be a local server. Optionally, the server may be a cloud server. In some examples, the miniature force sensor is activated under specific conditions, for example, in a manufacturing or testing environment in a factory, to detect whether an operator holds or operates the tool in a compliant manner. When the controller 531c determines, according to the detection data from the miniature force sensor, that the requirement is not satisfied, an alarm is triggered or a shutdown operation is performed.

As a specific implementation manner of this example, the miniature force sensor is applicable to the torque determination and torque setting of the power tool. As shown in FIG. 26, the power tool 10 includes the motor 12, and the motor 12 rotatably drives the output portion 13 coupled to the motor 12. The force-bearing component receives the force generated by the movement of the motor 12. The force-bearing component includes a moving portion 14 driven by the motor 12 to move or a support portion 15 supporting the moving portion 14. The moving portion 14 is formed on or connected to the output portion 13. Optionally, the moving portion 14 includes an output shaft driven by the motor 12 to output torque or at least one of a gear transmission structure disposed between the drive shaft and the output shaft of the motor 12 or a cylinder. Optionally, the moving portion 14 may also be a drive shaft through which the motor 12 outputs torque.

The miniature force sensor 600 and the moving portion 14 are connected in an installation manner similar to the installation manner in the example of the battery pack 300. The support portion 15 is directly or indirectly connected to the moving portion 14. When the moving portion 14 is driven by the motor 12 to move, the support portion 15 undergoes deformation or displacement in response to the movement. The support portion 15 includes bearings 151 that support a shaft (for example, a drive shaft, an output shaft, a spindle, or a gear shaft), a housing 152 of a transmission component, a part of the housing 11 that fixes the housing of the transmission component, or a component that vibrates due to the operation of the motor 12. The miniature force sensor 600 is connected to the support portion 15. The miniature force sensor 600 is used for detecting the torque generated by the output portion 13 of the power tool 10. It is to be understood that when the output portion 13 generates torque, the output portion 13, the moving portion 14, or the support part 15 undergoes deformation or displacement. The miniature force sensor 600 outputs the torque generated by the output portion 13 through the program of the controller by detecting at least one of the deformation parameter or the force value. In the product featuring set-torque control and accurate torque control, the output torque of the output portion 13 can be accurately obtained.

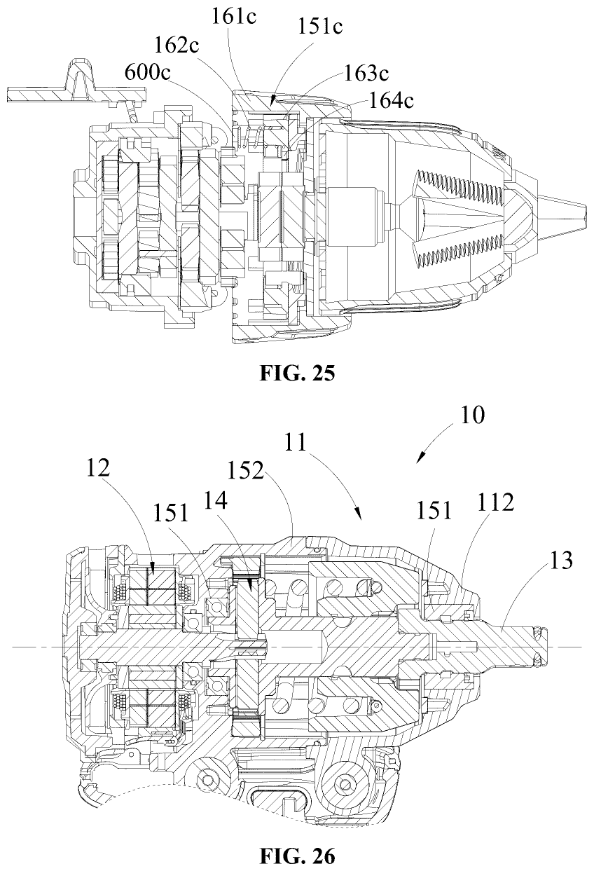

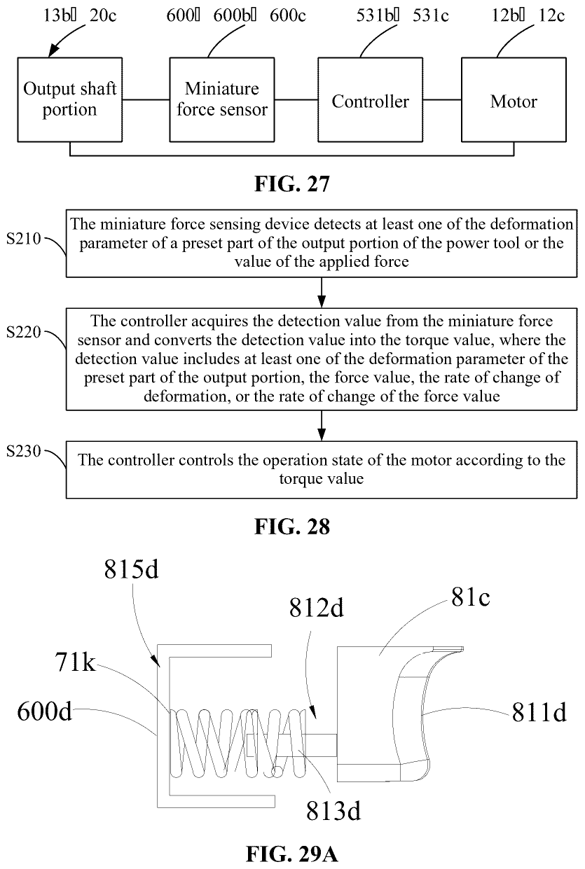

For example, with continued reference to FIGS. 22 to 25 and FIGS. 27 and 28, the power tool 10 is specifically the electric drill 100c. The electric drill 100c includes a housing 11c, a motor 12c, and an output portion 20c. The output portion 20c is rotatably coupled to the motor 12c. The motor 12c drives the output portion 20c to rotate. In this example, the output portion 20c includes a transmission mechanism 14c and an output mechanism 13c. The housing 11c includes an electric motor housing 11c for accommodating the motor 12c and an output housing 112c for accommodating at least part of the output mechanism 13c. The output housing 112c is connected to the front end of the electric motor housing 11c. The housing 11c is further formed with or connected to a grip 113c to be operated by the user. The grip 113c and the electric motor housing 11c form a T-shaped or L-shaped structure, thereby facilitating the hold and operation of the user. In some examples, the grip 113c and the electric motor housing 11c form a straight cylindrical structure. A battery pack 300c is connected to one end of the grip 113c. In this example, the battery pack 300c is detachably connected to the grip 113c. In some alternative examples, the battery pack 300c is disposed inside the housing 11c.

The output mechanism 13c is used for receiving torque supplied by the motor 12c and outputting torque. The output mechanism 13c includes an output shaft 131c for connecting a working attachment and driving the working attachment to rotate. The motor 12c drives the output shaft 131c to rotate about an output axis 102c. A clamping mechanism 132c or a receiving portion is disposed at the front end of the output shaft 131c and may clamp corresponding working attachments, such as a screwdriver, a drill bit, and a sleeve, when different functions are implemented. The output shaft 131c is used for outputting torque and rotates about the output axis 102c. The transmission mechanism 14c is disposed between the motor 12c and the output mechanism 13c and used for transmitting power between the motor 12c and the output mechanism 13c.

The output mechanism 13c further includes a torque adjustment mechanism 15c configured to set the output torque threshold of the power tool 100. That is, the user sets the maximum output torque of the electric drill 100c through the torque adjustment mechanism 15c.

The electric drill 100c further includes the controller 531c disposed inside the housing 11c and used for controlling the operation state of the motor 12c.

The miniature force sensor 600 is further included and used for detecting at least one of the deformation parameter of a preset part of the output shaft 131c or the value of the applied force. It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations. The force value includes the value of the force applied to the force-bearing surface or the parameter derived from the force value through calculations, such as torque. A parameter generated based on the force, such as a change in speed, is further included.

For ease of reference, the miniature force sensor for detecting the preset part of the output shaft 131c is configured to be the first miniature force sensor 600b. The controller 531c is connected to the first miniature force sensor 600b. Optionally, the controller 531b is connected to the first miniature force sensor 600b via digital signals. Optionally, the controller 531b is connected to the first miniature force sensor 600b via analog signals. Optionally, the controller 531b is connected to the first miniature force sensor 600b via wireless signals. The controller 531c acquires at least one of the deformation parameter or the force value detected by the first miniature force sensor 600b and controls the motor 12c according to at least one of the deformation parameter or the force value. In this example, the first miniature force sensor 600b outputs the detected torque signal of the output shaft 131c of the electric drill 100c or the parameter signal of the deformation of the output shaft 131c due to the output torque to the controller 531c. The controller 531c is configured to adjust the output of the motor 12c according to the signal from the first miniature force sensor 600b.

For example, when the controller 531c determines, according to the signal from the first miniature force sensor 600b, that the output torque of the motor 12c reaches the output torque threshold, the controller 531c controls the motor 12c to shut down, stops the power supply to the motor 12c, or controls the motor 12c to intermittently stop and start. In this example, the first miniature force sensor 600b is used for detecting the output torque, and when the output torque reaches a threshold, the controller 531c limits the torque output of the motor 12c, replacing the mechanical clutch mechanism in the related art and reducing the complexity of the mechanical structure of the product. The first miniature force sensor 600b outputs the torque generated by the output portion 20c through the program of the controller 531c by detecting at least one of the deformation parameter or the force value, thereby accurately obtaining the output torque of the output portion 20c, ensuring the usage safety and component safety of the product, and extending the service life of the product.

In some examples, the first miniature force sensor 600b is disposed on the output mechanism 13c or the output housing 112c and used for detecting the load torque on the output shaft 131c. It is to be understood that the load torque on the output shaft 131c is proportional to the torque outputted by the output shaft 131c. In some examples, the load torque on the output shaft 131c is basically the same as the torque outputted by the output shaft 131c.

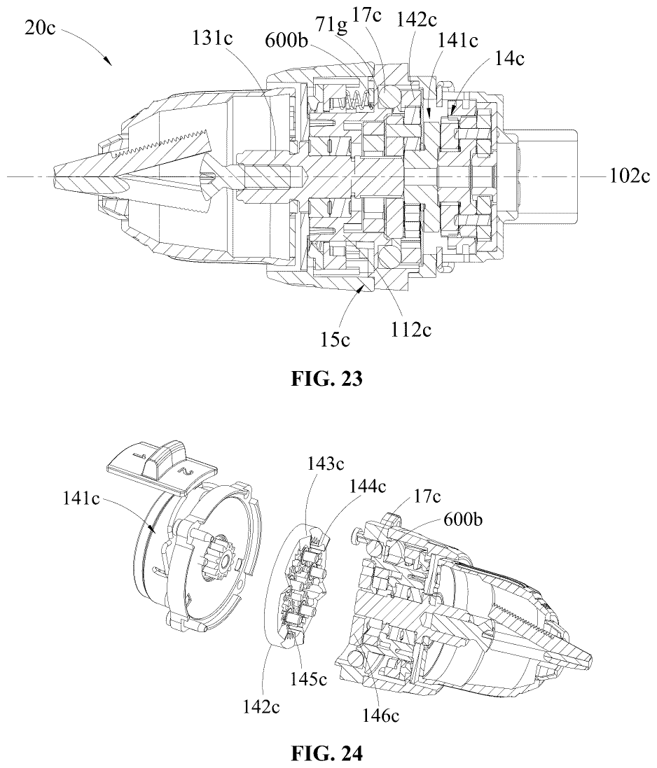

As shown in FIGS. 23 and 24, a target part 17c is disposed between the transmission mechanism 14c and the output housing 112c and used for receiving the load torque on the output shaft and causing deformation at a preset position or applying pressure to the preset position. Force transmission exists between the target part 17c and the output housing 112c. The force applied by the target part 17c to the output housing 112c is proportional to the load torque on the output shaft 131c. Optionally, the force applied by the target part 17c to the output housing 112c is basically the same as the load torque on the output shaft 131c. Optionally, the force applied by the target part 17c to the output housing 112c is proportional to the torque outputted by the output shaft 131c. Optionally, the force applied by the target part 17c to the output housing 112c is basically the same as the torque outputted by the output shaft 131c.

The first miniature force sensor 600b is disposed on the output housing 112c. A force-bearing surface 71g is disposed on the output housing 112c. The force-bearing surface 71g is used for receiving the force applied by the target part 17c and generating different deformation parameters when the force applied by the target part 17c changes. The first miniature force sensor 600b outputs a corresponding signal to the controller 531c according to the deformation parameter of the force-bearing surface 71g, or the first miniature force sensor 600b generates a corresponding force value parameter signal according to the deformation parameter of the force-bearing surface 71g and sends the force value parameter signal to the controller 531c.

For example, the first miniature force sensor 600b and the target part 17c are disposed on two side surfaces of the same position on the output housing 112c, respectively, that is, the first miniature force sensor 600b and the target part 17c are basically aligned with each other.

In this example, the target part 17c includes steel balls. The force-bearing surface 71g is the surface where the steel balls abut against the output housing 112c. The transmission mechanism 14c is formed with or connected to limiting portions 143c, thereby preventing the circumferential movement of the steel balls relative to the transmission mechanism 14c from exceeding a preset range. The transmission mechanism 14c includes a reduction gear system. Optionally, the transmission mechanism 14c includes a planetary gear train 141c for speed reduction, and a planetary gear train 141c or multiple planetary gear trains 141c may be provided. The planetary gear train 141c converts the output rotational speed of the motor 12c according to a certain gear ratio to achieve appropriate torque. In this example, the planetary gear train 141c includes planet gears 145c, a planet carrier 146c for mounting the planet gears 145c, and an inner ring gear 142c that meshes with the planet gears 145c. A sun gear (not shown) is formed on or connected to the drive shaft, and the planet gears 145c mesh with the sun gear. The inner ring gear 142c of the planetary gear train 141c closest to the output shaft 131c is connected to the housing 11c and does not rotate relative to the housing 11c. Optionally, the inner ring gear 142c is connected to the output housing 112c and does not rotate relative to the output housing 112c. The limiting portions 143c are formed on a side of the inner ring gear 142c facing the output shaft 131c. Optionally, the limiting portion 143c is a protrusion extending toward the output shaft 131c along the axial direction. The protrusion is provided with inclined surfaces 144c on two sides along the circumferential direction of the inner ring gear 142c. The steel ball abuts against the inner ring gear 142c and the output housing 112c on two sides along the axial direction. The steel ball abuts against the inclined surface 144c of the protrusion along the circumferential direction.

When the electric drill 100c rotates to output torque, the inner ring gear 142c is subjected to the torsional torque applied from the output shaft 131c. The inner ring gear 142c transmits the torsional torque to the steel balls through the protrusions. Due to the inclined surface 144c of the protrusion, the torque applied to the steel ball along the circumferential direction generates a torque component along the axial direction so that the steel ball applies the thrust to the output housing 112c along the axial direction. Therefore, the force-bearing surface 71g deforms. The first miniature force sensor 600b outputs a corresponding signal to the controller 531c according to the deformation parameter of the force-bearing surface 71g, or the first miniature force sensor 600b generates a corresponding force value parameter signal according to the deformation parameter of the force-bearing surface 71g and sends the force value parameter signal to the controller 531c. When the controller 531c determines that the output torque of the output shaft 131c exceeds a set threshold, the controller 531c limits the output of the motor 12c.

Optionally, when the controller 531c determines that the output torque of the output shaft 131c satisfies a preset condition, the controller 531c adjusts the output of the motor 12c. For example, according to the relationship between the value of the torque applied to the output shaft 131c and a preset value, the controller 531c adjusts the output of the motor 12c, including adjusting the output rotational speed or output torque, for example, increasing the output rotational speed or output torque or maintaining the output rotational speed or output torque. The first miniature force sensor 600b accurately sends the signal to the controller 531c based on its measurement accuracy. The controller 531c can accurately determine the actual torque and adjust the operation of the motor 12c according to the relationship between the actual torque and the preset torque to achieve accurate torque control. It is to be understood that the above is not limited to the electric drill 100c and is also applicable to other impact tools or torque output tools.

In some alternative examples, the first miniature force sensor 600b is connected to the inner ring gear 142c, and the force-bearing surface 71g is disposed on the inner ring gear 142c. When the target part 17c is subjected to a force, the force-bearing surface 71g of the inner ring gear 142c deforms due to torque. The first miniature force sensor 600b outputs a corresponding signal to the controller 531c according to the deformation parameter of the force-bearing surface 71g, or the first miniature force sensor 600b generates a corresponding force value parameter signal according to the deformation parameter of the force-bearing surface 71g and sends the force value parameter signal to the controller 531c. When the controller 531c determines that the output torque of the output shaft 131c exceeds a set threshold, the controller 531c limits the output of the motor 12c. Optionally, when the controller 531c determines that the output torque of the output shaft 131c satisfies a preset condition, the controller 531c adjusts the output of the motor 12c. For example, according to the relationship between the value of the torque applied to the output shaft 131c and a preset value, the controller 531c adjusts the output of the motor 12c, including adjusting the output rotational speed, the output torque, or the relevant electrical parameter, for example, increasing the output rotational speed, the output torque, or the current or changing the commutation parameter; or maintaining the output rotational speed, the output torque, the current, or the commutation parameter.

In some examples, the first miniature force sensor 600b is connected to the output shaft 131c. The force-bearing surface 71g is disposed on the output shaft 131c. When the force-bearing surface 71g of the output shaft 131c deforms due to torque, the first miniature force sensor 600b outputs a corresponding signal to the controller 531c according to the deformation parameter of the force-bearing surface 71g, or the first miniature force sensor 600b generates a corresponding force value parameter signal according to the deformation parameter of the force-bearing surface 71g and sends the force value parameter signal to the controller 531c. When the controller 531c determines that the output torque of the output shaft 131c exceeds a set threshold, the controller 531c limits the output of the motor 12c. Optionally, when the controller 531c determines that the output torque of the output shaft 131c satisfies a preset condition, the controller 531c adjusts the output of the motor 12c. For example, according to the relationship between the value of the torque applied to the output shaft 131c and a preset value, the controller 531c adjusts the output of the motor 12c, including adjusting the output rotational speed, the output torque, or the relevant electrical parameter, for example, increasing the output rotational speed, the output torque, or the current or changing the commutation parameter; or maintaining the output rotational speed, the output torque, the current, or the commutation parameter. In this example, the first miniature force sensor 600b directly detects the deformation parameter of the output shaft 131c caused by the load torque applied to the output shaft 131c.

Optionally, the first miniature force sensor 600b is used for detecting at least one of the deformation parameter or the value of the applied force caused by the load force applied to another component of the power tool. When the controller 531c determines that the load force exceeds a threshold, the controller 531c limits the output of the motor 12c or performs an alarm operation. The alarm operation includes changing the operation state of the motor 12c. The alarm operation further includes issuing a prompt using a photoelectric alarm.

As shown in FIG. 28, this example further discloses a control method for a power tool. The method specifically includes the steps below.

In S210, the miniature force sensing device detects at least one of the deformation parameter of a preset part of the output portion of the power tool or the value of the applied force.

In S220, the controller acquires the detection value from the miniature force sensor and converts the detection value into the torque value, where the detection value includes at least one of the deformation parameter of the preset part of the output portion, the force value, the rate of change of deformation, or the rate of change of the force value.

In S230, the controller controls the operation of the motor of the power tool according to the torque value.

In some examples, as shown in FIGS. 23 to 25, the torque adjustment mechanism 15c further includes a torque setting portion 151c operated to set the output torque threshold. For example, the torque setting portion 151c includes an electronic interactive assembly, such as a control panel. The control panel includes a component with input and display functions, such as buttons and a display screen, a touchscreen, and a linear touchpad and a display screen. The user inputs the operation instruction through the control panel. The received operation instruction is sent to the controller 531c in the form of the digital signal. The controller 531c controls the setting of the output torque threshold.

For example, the torque setting portion 151c includes a communication portion and an external device, and the communication portion is used for receiving an operation signal from an external device. In some examples, the communication portion includes a wireless communication device such as a long-range wireless network. The wireless communication device performs communication using other protocols (such as Wireless Fidelity (Wi-Fi), cellular protocols, and proprietary protocols) on different types of wireless networks. For example, the wireless communication device may be configured to perform communication via Wi-Fi over the Internet, a local area network (LAN), a wide area network (WAN), or a combination thereof or to perform communication via a piconet (such as infrared communication or near-field communication (NFC) communication). In other examples, the wireless communication device may use a short-range communication protocol (such as Bluetooth). Moreover, in other examples, the wireless communication device may be a wired network using, for example, a serial protocol (such as USB, USB-C, or FireWire). The external device includes a mobile device such as a smartphone, a tablet computer, a cellular phone, a laptop computer, or a smart wearable device. The user establishes a communication connection with the communication portion through the external device. The communication portion sends the received operation instruction to the controller 531c in the form of the digital signal. The controller 531c controls the setting of the output torque threshold.

In some examples, the torque setting portion 151c includes a torque cup. The torque cup includes an actuator sleeve 161c that is operably rotatable about the output shaft 131c to allow the user to set the output torque threshold. When the actuator sleeve 161c rotates, the actuator sleeve 161c undergoes axial displacement parallel to the extension direction of the output shaft 131c, that is, the output axis 102c. In this example, the torque cup also includes the miniature force sensor 600. For ease of reference, the miniature force sensor 600 disposed in the torque cup is configured to be the second miniature force sensor 600c. The second miniature force sensor 600c is disposed near the actuator sleeve 161c. The second miniature force sensor 600c is configured to detect at least one of the deformation parameter of a preset part near the actuator sleeve 161c or the value of the applied force when the actuator sleeve rotates. In some examples, the force-bearing surface of the second miniature force sensor 600c intersects with the output shaft 131c. It is to be understood that the extension direction of the force receiving surface of the miniature force sensor 600 intersects with the extension direction of the output shaft 131c. The “intersection” includes the spatial intersection and the planar intersection. Optionally, the extension direction of the force receiving surface of the miniature force sensor 600 is perpendicular to the extension direction of the output shaft 131c. Optionally, the extension direction of the force receiving surface of the miniature force sensor 600 is not parallel to the extension direction of the output shaft 131c.

In this example, the controller 531c is connected to the second miniature force sensor 600c. Optionally, the controller 531c is connected to the second miniature force sensor 600c via digital signals. Optionally, the controller 531c is connected to the second miniature force sensor 600c via analog signals. Optionally, the controller 531c is connected to the miniature force sensor 600 via wireless signals.

The controller 531c is configured to acquire the deformation parameter or force value detected by the second miniature force sensor 600c and determine the output torque threshold according to the deformation parameter or force value. When the actual output torque satisfies a preset requirement relative to the output torque threshold, the operation of the motor 12c is adjusted.

In some examples, the second miniature force sensor 600c and the first miniature force sensor 600b are two separate components. In some examples, the second miniature force sensor 600c and the first miniature force sensor 600b are the same component, that is, only one miniature force sensor is used.

In this example, when the controller 531c determines that the output torque of the output shaft 131c exceeds the output torque threshold, the controller 531c limits the output of the motor 12c. As the detection component, the second miniature force sensor 600c has high detection sensitivity. Compared with the mechanical torque cup in the related art, the second miniature force sensor 600c does not change the operating habit, the component complexity is low, the number of product parts is reduced, and the assembly difficulty is low.

As shown in FIGS. 24 and 25, the torque cup further includes an elastic member 162c, a driving portion 163c, and a guide portion 164c. The elastic member 162c is used for applying a corresponding force to the second miniature force sensor 600c when the actuator sleeve 161c rotates and undergoes axial displacement parallel to the extension direction of the output shaft 131c. Optionally, the elastic member 162c is a coil spring. The driving portion 163c is formed on or connected to the actuator sleeve 161c. The driving portion 163c is connected to or abuts against the elastic member 162c and is used for compressing the elastic member 162c and causing the elastic member 162c to generate a force applied to the second miniature force sensor 600c. The driving portion 163c rotates with the actuator sleeve 161c under a preset condition. Optionally, the driving portion 163c rotates coaxially and synchronously with the actuator sleeve 161c. Optionally, after the actuator sleeve 161c rotates by N degrees or N revolutions, the driving portion 163c rotates by M degrees or M revolutions. The rotational relationship between the driving portion 163c and the actuator sleeve 161c is set according to actual requirements. This does not affect the substantive content of the present application. The guide portion 164c is used for converting the rotational movement applied by the user into the movement of the driving portion 163c along the axial direction of the output shaft 131c. Optionally, the guide portion 164c includes a helix, and the driving portion 163c can move along the axial direction of the output shaft 131c while rotating about the output shaft 131c along the helix.

Optionally, the guide portion 164c is formed on or connected to the output housing 112c. Optionally, the guide portion 164c is a helix formed on the outside of the output housing 112c. The driving portion 163c engages with the helix. In this example, the output housing 112c at least partially extends into the actuator sleeve 161c. Along the axial direction of the output shaft 131c, the actuator sleeve 161c and the output housing 112c partially overlap. Along the axial direction of the output shaft 131c, the actuator sleeve 161c and the elastic member 162c partially overlap.

In this example, the force-bearing surface 71g is disposed on the elastic member 162c or the driving portion 163c. The force-bearing surface 71g is used for receiving the force when the elastic member 162c is compressed by the driving portion 163c and undergoing different deformations when the force changes. The miniature force sensor 600 outputs a corresponding signal to the controller 531c according to the deformation parameter of the force-bearing surface 71g, or the miniature force sensor 600 generates a corresponding force value parameter signal according to the deformation parameter of the force-bearing surface 71g and sends the force value parameter signal to the controller 531c.

In this example, the controller 531c determines the output torque threshold according to the measurement data acquired from the second miniature force sensor 600c. The controller 531c may set multiple output torque thresholds according to preset conditions. For example, the gears include the high gear, the medium gear, and the low gear. Moreover, since the use of the miniature force sensor 600 makes torque detection more accurate, the current output torque threshold may be directly represented by the torque value, such as 20 N or 50 N.

For example, the power tool 10 may be a cutting tool. With continued reference to FIGS. 18 and 19, the power tool 10 is the electric circular saw 100b. The output portion 13b includes an output shaft 131b and a cutting part 16b, and the output shaft 131b is used for mounting the cutting part 16b. The miniature force sensor 600 is used for detecting the load torque applied to the output portion 13b of the power tool. When the output portion 13b is subjected to the load torque, the output portion 13b undergoes deformation or displacement. The miniature force sensor 600 detects the load torque causing the deformation or displacement of the output portion 13b. The torque generated by the output portion 13b is outputted through the program of the controller. The load torque on the output shaft 131b is proportional to the torque outputted by the output shaft 131b. In some examples, the load torque on the output shaft 131b is basically the same as the torque outputted by the output shaft 131b.

In this example, the torque outputted by the output shaft 131b of the electric circular saw is detected by the miniature force sensor 600, and the output of the motor is adjusted according to the magnitude of the output torque. Optionally, when the miniature force sensor detects that the output shaft 131b of the electric circular saw is subjected to the load torque, it is determined that the cutting part 16b is in contact with the workpiece to be cut, and the controller 531b outputs a signal to control the motor 12b to start according to a preset program. Optionally, when the miniature force sensor 600 detects that the load torque applied to the output shaft 131b of the electric circular saw and the preset torque satisfy a corresponding relationship, the controller 531b outputs a signal to control the motor 12b to adjust the output according to a preset program. For example, if the load torque exceeds the preset torque, the controller 531b determines that the current output torque of the motor 12b is too low, so the controller 531b controls the motor 12b to output higher torque.

In some examples, with continued reference to FIG. 22, the power tool is the electric drill 100c. In the related art, the target speed of the motor 12c is adjusted according to the trigger stroke of the trigger. The trigger is coupled to a sliding rheostat, and the sliding rheostat outputs different analog signals according to different trigger strokes of the trigger. The trigger stroke of the trigger is positively correlated with the duty cycle of a pulse-width modulation (PWM) signal of the motor 12c, and the duty cycle of the PWM signal is positively correlated with the target rotational speed of the motor 12c. When the trigger stroke of the trigger switch is relatively short, the duty cycle of the PWM signal is also relatively small. In this case, the target rotational speed of the motor 12c is also relatively low. In the structure in which the trigger adjusts the target rotational speed of the motor 12c in the related art, the sliding rheostat is needed, resulting in a large size. Moreover, the sliding rheostat has a limited service life.

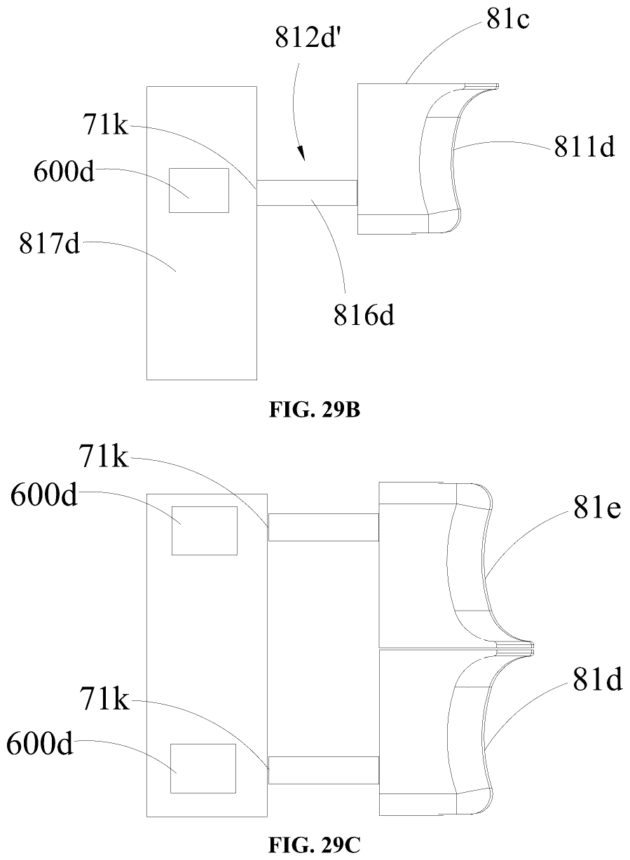

In this example, as shown in FIGS. 29A to 29C, the miniature force sensor 600 is disposed near the trigger 81c, and the miniature force sensor 600 is configured to detect at least one of the deformation parameter of a preset part or the value of the applied force when the trigger 81c is activated. The controller is configured to acquire at least one of the deformation parameter or the value of the applied force of the miniature force sensor 600 and determine the target parameter of the motor 12c according to the deformation parameter or the force value. The target parameter includes, but is not limited to, the target rotational speed of the motor, the target output torque, the target output current, the target duty cycle, the target conduction angle, the lead angle, or at least one of the relevant parameters affecting the preceding target parameters. For ease of reference, the miniature force sensor 600 disposed at the trigger 81c is configured to be the third miniature force sensor 600d. In this example, the miniature force sensor identifies at least one of the deformation parameter or force value caused by the trigger stroke of the trigger 81c and then sends a corresponding control signal. The product is compact, and the product structure and the component installation are simplified.

It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations. The force value includes the value of the force applied to the force-bearing surface or the parameter derived from the force value through calculations, such as torque. A parameter generated based on the force, such as a change in speed, is further included.

As shown in FIG. 29A, the trigger 81c is fixed inside the power tool 10 through a substrate 815d and partially extends out of the housing of the power tool 10. In this example, the substrate 815d is formed inside or connected to the grip 113d of the power tool, and the trigger 81c partially extends out of the grip 113d. The trigger 81c is operated and undergoes displacement relative to the grip 113d. The trigger 81c includes a contact portion 811d that is in contact with the user's finger and a linkage portion 812d that triggers the signal. A force-bearing surface 71k is disposed on the circuit board or the substrate 815d. The force-bearing surface 71k is used for receiving the force applied to the circuit board or the substrate 815d by the linkage portion 812d and generating different deformation parameters when the force changes. The third miniature force sensor 600d outputs a corresponding signal to the controller according to the deformation parameter of the force-bearing surface 71k, or the third miniature force sensor 600d generates a corresponding force value parameter signal according to the deformation parameter of the force-bearing surface 71k and sends the force value parameter signal to the controller 513d.

The linkage portion 812d includes a biasing member 813d, which may optionally be a coil spring. When the user presses the contact portion 811d with the finger or applies a force to the contact portion 811d, the contact portion 811d is connected to or abuts against the coil spring and is used for compressing the coil spring so that the coil spring generates a force applied to the force-bearing surface 71k or the third miniature force sensor 600d. The force applied by the coil spring to the force-bearing surface 71k or the third miniature force sensor 600d is proportional to the pressure applied by the user's finger to the contact portion 811d or the force applied to the contact portion 811d. In some examples, the force applied by the coil spring to the force-bearing surface 71k or the third miniature force sensor 600d may be linearly related to or non-linearly related to the pressure applied by the user's finger to the contact portion 811d or the force applied to the contact portion 811d. The third miniature force sensor 600d is disposed on the substrate 815d. The force-bearing surface 71k is disposed at a position where the coil spring abuts against the substrate 815d. For example, the third miniature force sensor 600d and the coil spring are disposed on two side surfaces of the same position on the substrate 815d, respectively, that is, the third miniature force sensor 600d and the coil spring are basically aligned with each other. When the user presses the contact portion 811d with the finger or applies a force to the contact portion 811d, the coil spring is compressed. The pressure of the coil spring is at least partially applied to the substrate 815d, causing deformation of the force-bearing surface 71k. The third miniature force sensor 600d detects the deformation parameter of the substrate 815d. The third miniature force sensor 600d outputs a deformation parameter signal to the controller 513d according to the deformation parameter, or the miniature force sensor 600 outputs a force value parameter signal to the controller 513d. The controller 513d determines the target parameter of the motor 12c according to the mapping relationship between the deformation parameter signal or force value parameter signal and the target parameter of the motor 12c.

As shown in FIG. 29B, a linkage portion 812d′ includes a rigid component. For example, the linkage portion 812d′ includes a pin 816d. The linkage portion 812d′ is formed on or connected to the contact portion 811d. When the user presses the contact portion 811d with the finger or applies a force to the contact portion 811d, the contact portion 811d drives the linkage portion 812d′ to move or makes the linkage portion 812d′ tend to move, thereby generating a force applied to the force-bearing surface 71k or the third miniature force sensor 600d. In this example, the control circuit board is disposed on the movement path of the linkage portion 812d′ after the contact portion 811d is pressed by the user's finger. The third miniature force sensor 600d is integrated on a control circuit board 817d. The force-bearing surface 71k is disposed at a position where the pin 816d abuts against the control circuit board 817d. When the user presses the contact portion 811d with the finger or applies a force to the contact portion 811d to move the linkage portion 812d′ or to make the linkage portion 812d′ tend to move, the linkage portion 812d′ abuts against the force-bearing surface 71k after a preset displacement, causing deformation of the force-bearing surface 71k. The third miniature force sensor 600d outputs a corresponding signal to the controller 513d according to the deformation parameter of the force-bearing surface 71k, or the third miniature force sensor 600d generates a corresponding force value parameter signal according to the deformation parameter of the force-bearing surface 71k and sends the force value parameter signal to the controller 513d. The controller 513d determines the target parameter of the motor 12c according to the mapping relationship between at least one of the deformation parameter signal or the force value parameter signal and the target parameter of the motor 12c.

The power tool includes multiple triggers 81c, and at least one third miniature force sensor 600d is provided for each trigger 81c. The linkage portion may be the biasing member 813d or a rigid component. As shown in FIG. 29C, for example, the power tool includes a first trigger 81d and a second trigger 81e, where when the first trigger 81d is activated, the controller 513d controls the motor 12c to rotate in a forward direction. When the second trigger 81e is activated, the controller 513d controls the motor 12c to rotate in a reverse direction. The first trigger 81d and the second trigger 81e each include a contact portion and a linkage portion. The user presses the contact portion of any trigger with the finger to cause the linkage portion to apply a force to the substrate or the control circuit board, thereby causing the corresponding force-bearing surface to generate a deformation parameter. The third miniature force sensor 600d detects the deformation parameter of the force-bearing surface 71k corresponding to the substrate or control circuit board. The third miniature force sensor 600d outputs a deformation parameter signal to the controller 513d according to the deformation parameter, or the third miniature force sensor 600d outputs a force value parameter signal to the controller 513d. The controller 513d determines the forward rotation target parameter or reverse rotation target parameter of the motor 12c according to the mapping relationship between at least one of the deformation parameter signal or the force value parameter signal and the target parameter of the motor 12c.

In the preceding examples, since the miniature force sensor 600 features more accurate detection and finer detection resolution, the stepless speed regulation for the target rotational speed of the motor 12c can be achieved.

As a specific implementation manner of this example, the miniature force sensor is applicable to the state determination for the attachment of the power tool or the workpiece being machined. The power tool 10 includes a housing, a motor, and an output portion. The motor is disposed inside the housing and is configured to rotatably drive the output portion coupled to the motor. The controller is disposed inside the housing and is used for controlling the rotation of the motor.

The output portion includes an attachment for machining the workpiece. The power tool 10 further includes at least one miniature force sensor 600 configured to detect at least one of the deformation parameter of at least one preset part of the attachment or the workpiece or the value of the applied force. The controller is connected to at least one miniature force sensor and is configured to acquire detection data from the at least one miniature force sensor and determine the state of the attachment or workpiece according to the detection data. Optionally, after determining the state of the attachment or workpiece, the controller may issue a state prompt via a state indication portion. Optionally, after determining the state of the attachment or workpiece, the controller adjusts the operation state of the motor according to the state of the attachment or workpiece.

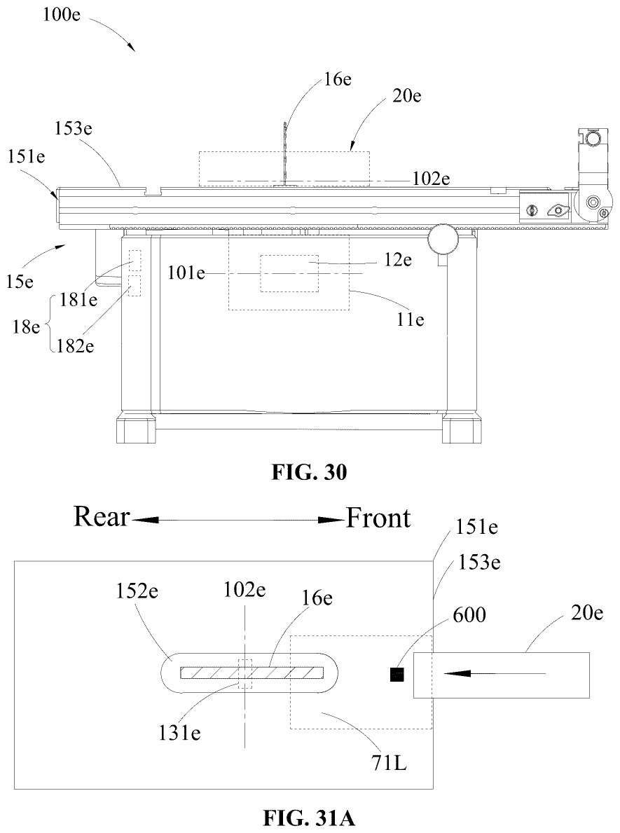

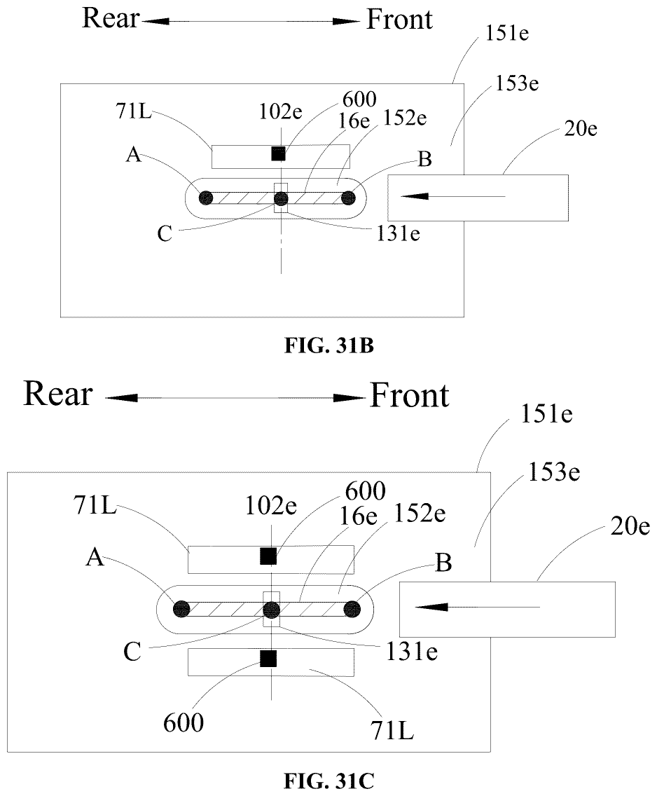

As shown in FIGS. 30, 31A, 31B, and 31C, the power tool is a table cut-off saw 100e, which may be any known type, such as a freestanding table cut-off saw or a portable table cut-off saw. The table cut-off saw 100e includes a worktable 15e, a motor 12e, and an output shaft 131e. The output shaft 131e is used for connecting a rotary working attachment. In this example, the motor 12e is an electric motor. The electric motor 12e is used below instead of the motor, without affecting the substantive content of the present application. The working attachment is a cutting element 16e, which, for example, is a saw blade. The electric motor 12e drives the output shaft 131e to rotate. In this example, the output shaft 131e rotates about a second axis 102e, and the motor shaft of the electric motor 12e rotates about a first axis 101e. The positional relationship between the first axis 101e and the second axis 102e and the transmission structure do not affect the substantive content of the present application. In this example, the first axis 101e does not coincide with the second axis 102e.

The electric motor 12e is disposed inside a housing 11e. In this example, the housing 11e is formed on or connected to the worktable 15e. The output shaft 131e and the cutting element 16e are disposed outside the housing 11e. The worktable 15e is provided with a worktable surface 151e that supports a workpiece 20e and allows the workpiece 20e to slide on the worktable surface 151e, and a top surface 153e of the worktable surface is in contact with the workpiece 20e. The worktable surface 151e is provided with a saw blade through hole 152e extending along the first direction. The saw blade passes through the saw blade through hole 152e and extends. Optionally, the saw blade can pass through the saw blade through hole 152e and protrude upward from the top surface. The saw blade is driven to rotate by the electric motor 12e below the worktable surface 151e to implement the cutting function. The saw blade is used for cutting the workpiece 20e that is pushed along the top surface and is in contact with the saw blade, such as wood.

As shown in FIG. 33, the table cut-off saw 100e further includes a drive module for driving the electric motor 12e and a controller 531e electrically connected to the drive module. The controller 531e outputs a control signal to a driver circuit to control the operation of the electric motor 12e. Optionally, the drive module distributes the voltage to the electric motor 12e in a certain logical relationship under the driving of the control signal outputted by the controller 531e so that the electric motor 12e starts and generates continuous torque. In some examples, the drive module includes multiple electronic switches. Specifically, the electronic switches include field-effect transistors, insulated-gate bipolar transistors, or the like. In some examples, the drive module is a three-phase bridge circuit. The electric motor 12e in this example is preferably configured to be a brushless electric motor 12e, and of course, the electric motor 12e may be another form of electric motor, which is not limited in the present application. In some examples, the controller 531e uses a dedicated control chip (such as an MCU).

In some examples, the table cut-off saw 100e further includes the miniature force sensor 600. The miniature force sensor 600 is connected to the controller 531e and is used for detecting at least one of the deformation parameter of at least one preset part of the workpiece 20e or the value of the applied force and outputting a first signal to the controller 531e.

A force-bearing surface 71L is at least partially located on the worktable surface 151e. The miniature force sensor 600 is used for detecting the parameter of the deformation of the force-bearing surface 71L caused by the force applied to the force-bearing surface 71L during the machining process of the workpiece 20e, thereby acquiring the unloading signal of the workpiece 20e. The arrow direction in FIGS. 31A to 31C is the movement direction of the workpiece 20e. The user moves the workpiece 20e along the arrow direction to perform the cutting operation. When the cutting operation is completed or the user moves the workpiece 20e out of the worktable surface 151e, the miniature force sensor 600 can sense the first signal of at least one of the deformation parameter of the force-bearing surface 71L or the change in deformation parameter. Then, the controller 531e determines that the workpiece 20e is removed and sends the unloading signal. In this example, the unloading signal is related to the first signal outputted by the miniature force sensor 600. In this example, the unloading signal may be understood as the end of the machining of the workpiece 20e and may also be understood as the removal of the workpiece 20e from the workplane. Of course, those skilled in the art may make other definitions for the unloading signal, such as stopping the workpiece 20e for a period of time.

In some examples, the force-bearing surface 71L is a region defined by the top surface 153e of the worktable surface. Optionally, the force-bearing surface 71L is not different from other positions on the top surface 153e of the worktable surface, or there are no identifiable distinguishing features. Optionally, the force-bearing surface 71L and other positions on the top surface 153e of the worktable surface may be made of different materials or have different appearance indications. For example, the force-bearing surface 71L is made of a light-transmissive material that is locally transparent or semi-transparent so that different operating pressures applied by the user can be fed back through lighting. In some examples, the force-bearing surface 71L has a different thickness or is made of a different material, or an additional surface treatment is performed on the force-bearing surface 71L. The force-bearing surface 71L and the top surface are on the same plane so that the movement of the workpiece 20e is not affected.

When the user operates the workpiece 20e and gradually moves the workpiece 20e toward the miniature force sensor 600 along the arrow direction in FIGS. 31A to 31C, the workpiece 20e causes different deformations of the force-bearing surface 71L. The miniature force sensor 600 outputs a corresponding signal to the controller 531e according to the deformation parameter of the force-bearing surface 71L, or the miniature force sensor 600 generates a corresponding force value parameter signal according to the deformation parameter of the force-bearing surface 71L and sends the force value parameter signal to the controller 531e. After the user completes the cutting operation, or after the user has finished cutting the workpiece 20e, or after the workpiece 20e is removed from the worktable surface 151e, the deformation parameter of the force-bearing surface 71L decreases to a preset threshold or the change in the deformation parameter of the force-bearing surface 71L reaches a preset threshold. In this case, the miniature force sensor 600 outputs the first signal. After receiving the first signal, the controller 531e determines the current operation state of the workpiece 20e. Optionally, after determining the operation state of the workpiece 20e, the controller 531e sends a signal to the state indication portion to prompt the user to perform the next operation. Optionally, after determining the operation state of the workpiece 20e, the controller 531e sends a signal to the electric motor 12e and automatically controls the rotational speed or torque output of the electric motor 12e according to the operation state of the workpiece. For example, when it is determined that the workpiece 20e is unloaded, the controller 531e limits the output of the electric motor 12e, reduces the rotational speed of the electric motor 12e, or shuts down the electric motor 12e.

Referring to FIG. 31A, the saw blade is provided with a cutting plane (not shown in the figure). In some examples, the force-bearing surface 71L or the miniature force sensor 600 is at least partially disposed at the front end of the saw blade. Optionally, the workpiece 20e enters the region of the force-bearing surface 71L or the miniature force sensor 600, continues advancing, is in contact with the saw blade, and starts being cut. Referring to FIGS. 31B and 31C, in some examples, the projection of the miniature force sensor 600 on the plane where the cutting plane is located is at least partially located within the projection of the saw blade on the plane where the cutting plane is located. Optionally, the projection of the miniature force sensor 600 on the worktable surface 151e is located between points A and B in the front and rear direction. The point A is a rear end point of the projection of the saw blade on the worktable surface 151e, and the point B is a front end point of the projection of the saw blade on the worktable surface 151e. Optionally, the point C is the midpoint of the projection of the saw blade on the worktable surface 151e, and the midpoint of the projection of the miniature force sensor 600 on the worktable surface 151e is within a range of 3 mm before and after the point C in the front and rear direction. Optionally, when multiple miniature force sensors 600 are provided, the projections of at least two miniature force sensors 600 on the worktable surface 151e are located on two sides of the plane where the cutting plane is located in the left and right direction. Optionally, the projections of at least two miniature force sensors 600 on the worktable surface 151e are symmetrical about the plane where the cutting plane is located.

In some examples, the table cut-off saw 100e further includes an operating switch 18e disposed on the worktable 15e and operable by the user. Optionally, the operating switch 18e includes a first switch 181e and a second switch 182e. The first switch 181e is the main control switch of the table cut-off saw 100e, and the second switch 182e is the switch of the electric motor 12e of the table cut-off saw 100e. The user can operate the table cut-off saw 100e in different working modes by operating the first switch 181e. Specifically, when the user operates the first switch 181e to be in the “1” gear, the table cut-off saw 100e is in a first working mode, that is, an intelligent mode. When the user operates the first switch 181e to be in the “2” gear, the table cut-off saw 100e is in the second working mode, that is, the normal mode. Of course, the preceding setting of the number of working modes and the specific correspondence are not intended to limit the present application.

The second switch 182e is the switch of the electric motor 12e of the table cut-off saw 100e. When the first switch 181e is in a selected gear and the second switch 182e is turned on, the table cut-off saw 100e operates in a fixed mode. When the second switch 182e is turned off, the electric motor 12e shuts down.

Control methods for the table cut-off saw 100e in different working modes are described in detail below.

After the user turns on the second switch 182e, the electric motor 12e does not work, and of course, the saw blade does not rotate. When the user sets the first switch 181e to be in the “1” gear, the table cut-off saw 100e is in the intelligent mode, and the electric motor 12e starts to drive the saw blade to rotate so that the user can perform the cutting operation. The controller 531e senses the workpiece 20e through the miniature force sensor 600. When the miniature force sensor 600 senses that the user completes the cutting work on the workpiece 20e, the miniature force sensor 600 sends the first signal to the controller 531e. The controller 531e sends an unloading control signal to the electric motor 12e, and the electric motor 12e shuts down to stop the saw blade from continuing rotating. When the table cut-off saw 100e is still in the intelligent mode and the user needs to start the electric motor 12e again to perform the cutting operation, the user needs to turn on the second switch 182e again to control the electric motor 12e to start. Of course, it is to be noted that when the table cut-off saw 100e is in the intelligent mode, the user may control the second switch 182e to be turned off to achieve shutdown.

When the user sets the first switch 181e to be in the “2” gear, the table cut-off saw 100e is in the normal mode. In this case, the electric motor 12e normally starts to drive the saw blade to rotate, and the user may directly perform the cutting operation. It is to be noted that when the first switch 181e is in the “2” gear, the user controls the electric motor 12e to shut down via the second switch 182e.

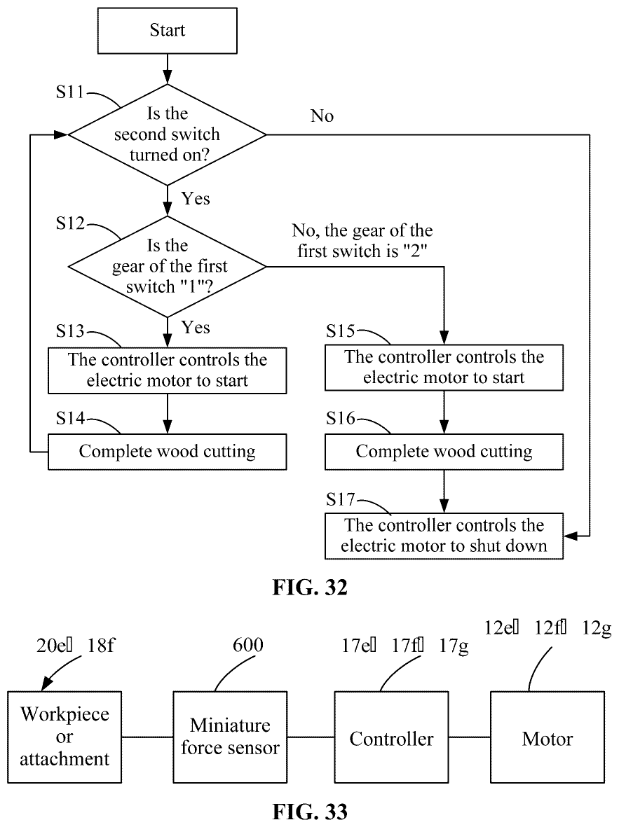

A flow of the control method for the table cut-off saw 100e in the intelligent mode is described below in conjunction with FIGS. 32 and 33. The method includes the steps below.

In S11, whether the second switch is turned on is determined. If so, step S12 is performed. If not, step S17 is performed.

In S12, the gear of the first switch 181e is determined. If the gear is “1”, step S13 is performed. If the gear is “2”, step S15 is performed.

In S13, the controller 531e controls the electric motor 12e to start.

The saw blade rotates so that the user can perform the cutting operation.

In S14, wood cutting is completed. Then, step S11 is performed.

In S15, the controller 531e controls the electric motor 12e to start.

The saw blade rotates so that the user can perform the cutting operation.

In S16, wood cutting is completed.

In S17, the controller 531e controls the electric motor 12e to shut down, and the saw blade stops rotating.

After the user sets the table tool to be in the intelligent mode through the first switch 181e, the user needs to continue to turn on the second switch 182e so that the electric motor 12e can start to drive the saw blade to rotate to satisfy cutting requirements of the user.

Optionally, after the user completes cutting, when the miniature force sensor 600 senses that the user completes the cutting work on the workpiece 20e, the miniature force sensor 600 sends the first signal to the controller 531e. The controller 531e sends an unloading control signal to the electric motor 12e, and the controller 531e controls the electric motor 12e to shut down after a preset time. Of course, the preset time may be set by those skilled in the art according to the actual situation. In this example, the preset time is configured to be less than or equal to 1 s. In some examples, the preset time is configured to be less than or equal to 500 ms. In some examples, the preset time is configured to be less than or equal to 300 ms. In some examples, the preset time is configured to be less than or equal to 200 ms. When the user needs to perform the cutting operation again, the second switch 182e needs to be turned on again.

The first switch 181e and the second switch 182e are disposed on the side surface of the worktable 15e. In this manner, not only can the user operate the switch 18e more conveniently, but also the following can be avoided: the workpiece 20e touches the switch by mistake, affecting the machining.

In this example, when the table cut-off saw 100e is configured to be in the intelligent mode, the table cut-off saw 100e has the function of automatic shutdown. Specifically, when the table tool is in the intelligent mode, the controller 531e sets the rotational speed of the electric motor 12e to be the first rotational speed in a preset time after acquiring the unloading signal of the workpiece 20e. In some examples, the unloading signal is related to the first signal outputted by the sensing device or the operating parameter of the electric motor 12e. Specifically, the operating parameter of the electric motor 12e includes, but is not limited to, the operating current or rotational speed of the electric motor 12e. In some examples, the first rotational speed is zero. In other examples, the first rotational speed is a lower rotational speed greater than zero.

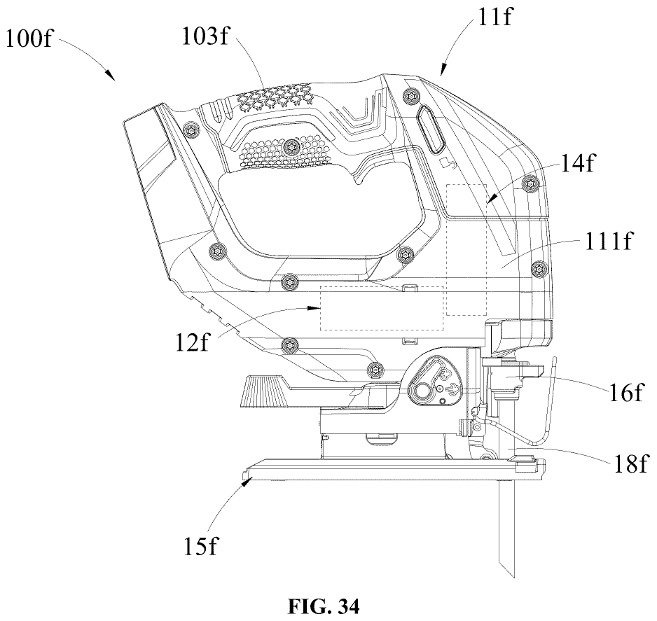

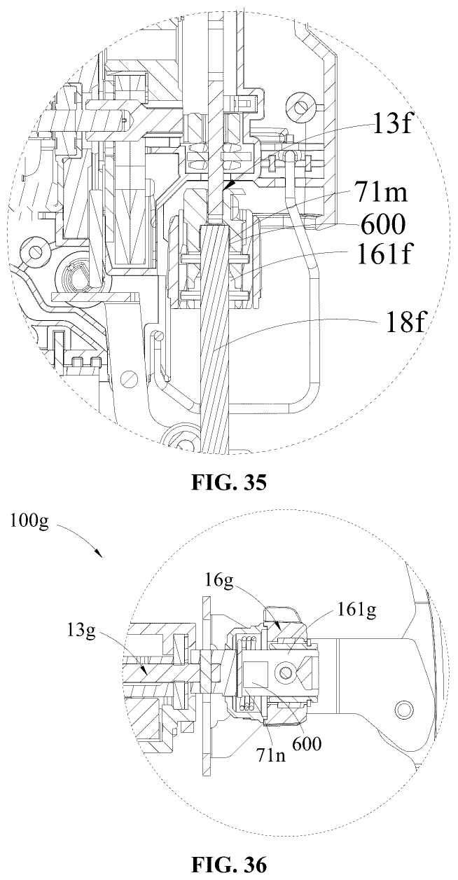

In some alternative examples, as shown in FIGS. 33 to 35, for example, the power tool is a jigsaw 100f, and the jigsaw 100f includes a housing 11f, a motor 12f, a transmission assembly 14f, an output member 13f, a saw blade 18f, and a base plate assembly 15f. The housing 11f includes a handle portion 113f and an accommodation portion 111f. The handle portion 113f can be held by the user to operate the jigsaw 100f, and an accommodation cavity for accommodating at least a portion of the motor 12f is formed inside the accommodation portion 111f. The motor 12f is disposed in the accommodation cavity formed by the accommodation portion 111f, and the motor 12f is used for driving the output member 13f to move. The transmission assembly 14f is used for transmitting the power outputted by the motor 12f to the output member 13f to drive the output member 13f to reciprocate. The transmission assembly 14f is at least partially disposed in the accommodation cavity formed by the accommodation portion 111f. The output member 13f is used for mounting the saw blade 18f, and the output member 13f at least partially extends out of the housing 11f. The saw blade 18f is disposed outside the housing 11f, and saw teeth are formed on one side of the saw blade 18f. The saw blade 18f reciprocates to cut the workpiece. The base plate assembly 15f is disposed outside the housing 11f, and the base plate assembly 15f and the housing 11f are rotatably connected about a first axis, thereby achieving bevel cutting. The output member 13f is provided with a clamping device 16f for clamping the saw blade 18f, and the saw blade 18f extends out of the housing 11f along a first direction.

A controller 17f is further included and configured to determine the working state of the saw blade 18f. The clamping device 16f includes a miniature force sensor 600 and a receiving portion 161f for accommodating the saw blade 18f. The miniature force sensor 600 detects at least one of the deformation parameter of a preset position of the saw blade 18f or the value of the applied force. The controller 17f determines that the saw blade 18f is mounted in place according to at least one of the deformation parameter signal or force value parameter signal outputted by the miniature force sensor 600. Optionally, the miniature force sensor 600 detects at least one of the deformation parameter of a preset position of the saw blade 18f or the value of the applied force. When the controller 17f determines that the operating direction of the saw blade 18f is not as expected according to at least one of the deformation parameter signal or force value parameter signal outputted by the miniature force sensor 600, the controller 17f issues an instruction that the clamping device 16f needs to be adjusted, or the controller 17f automatically adjusts the clamping state of the clamping device 16f.

Optionally, the miniature force sensor 600 is disposed within the receiving portion 161f, and force-bearing surfaces 71m are disposed on two sides of the saw blade 18f in the clamping direction, respectively. Optionally, the force-bearing surfaces 71m are disposed on the left and right sides of the saw blade 18f, respectively. The miniature force sensor 600 detects the deformation parameters of the force-bearing surfaces 71m caused by the saw blade 18f applying forces to the left and right sides. The miniature force sensor 600 outputs a corresponding signal to the controller 17f according to the deformation parameters of the force-bearing surfaces 71m, or the miniature force sensor 600 generates a corresponding force value parameter signal according to the deformation parameters of the force-bearing surfaces 71m and sends the force value parameter signal to the controller 17f. When at least one of the deformation parameter or force value of the force-bearing surface 71m on each side satisfies the preset condition, it is determined that the saw blade 18f is mounted in place. Optionally, when at least one of the deformation parameter or force value of the force-bearing surface 71m on one side is basically the same as that on the other side, it is determined that the saw blade 18f is mounted in place.

In some alternative examples, as shown in FIGS. 33 and 36, for example, the power tool is a reciprocating saw 100g. The reciprocating saw 100g includes an output member 13g, the output member 13g is provided with a clamping device 16g for clamping a saw blade (not shown), and the saw blade (not shown) extends out of the housing along a first direction. The clamping device 16g includes a miniature force sensor 600 and a receiving portion 161g for accommodating the saw blade (not shown). The miniature force sensor 600 detects at least one of the deformation parameter of a preset position of the saw blade (not shown) or the value of the applied force. When the controller 17g determines, according to at least one of the deformation parameter signal or force value parameter signal outputted by the miniature force sensor 600, that the reciprocating saw 100g completes the cutting task or cuts a workpiece that does not need to be cut, the controller 17g controls the output of the motor 12g. Optionally, the miniature force sensor 600 is disposed within the receiving portion 161g. The miniature force sensor 600 detects the deformation parameter of a force-bearing surface 71n caused by the saw blade (not shown) subjected to a force from the workpiece. The miniature force sensor 600 outputs a corresponding signal to the controller 17g according to the deformation parameter of the force-bearing surface 71n, or the miniature force sensor 600 generates a corresponding force value parameter signal according to the deformation parameter of the force-bearing surface 71n and sends the force value parameter signal to the controller 17g. When at least one of the deformation parameter or force value of the force-bearing surface 71n satisfies the preset condition, it is determined that the reciprocating saw 100g completes the cutting task. Optionally, when at least one of the deformation parameter or force value of the force-bearing surface 71n decreases to a preset value or suddenly decreases to a preset value, it is determined that the reciprocating saw 100g completes the cutting task, and the controller 17g limits the output of the motor 12g or controls the motor 12g to shut down. When at least one of the deformation parameter or force value of the force-bearing surface 71n increases to a preset value or suddenly increases to a preset value, it is determined that the reciprocating saw 100g cuts a workpiece that does not need to be cut, such as a metal plate, and the controller 17g limits the output of the motor 12g or controls the motor 12g to shut down, thereby protecting the saw blade (not shown) and the motor 12g.

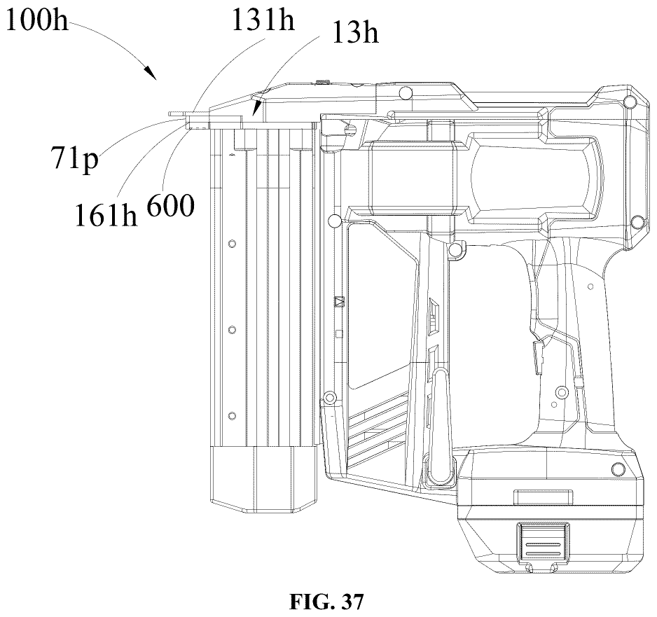

In some alternative examples, for example, as shown in FIG. 37, the power tool is a fastener driver 100h, such as a drywall screwdriver or a nail gun. An output mechanism 13h is used for driving the fastener into the workpiece. Optionally, the output mechanism of the drywall screwdriver includes an output shaft that drives the fastener into the workpiece via a clamping attachment or an impact attachment. Optionally, the nail gun includes a firing portion 131h that impacts the fastening nail to drive the fastening nail into the workpiece.

The fastener driver 100h includes a trigger mechanism. When a trigger portion 161h of the trigger mechanism comes into contact with the workpiece, the trigger portion 161h moves or tends to move, and then the trigger portion 161h deforms within a preset stroke. A trigger mechanism 16h further includes the miniature force sensor 600. The miniature force sensor 600 detects at least one of the deformation parameter of a preset position of the trigger portion 161h or the value of the applied force. When the controller determines, according to at least one of the deformation parameter signal or force value parameter signal outputted by the miniature force sensor 600, that the trigger portion 161h of the fastener driver 100h establishes a preset contact or relationship with the workpiece, the controller controls the output of the motor. Optionally, a force-bearing surface 71p is disposed on the surface of the trigger portion 161h or between the trigger portion 161h and the component that deforms the trigger portion 161h. The miniature force sensor 600 detects the deformation parameter of the force-bearing surface 71p caused by the force generated when the trigger portion 161h establishes a preset contact or relationship with the workpiece. The miniature force sensor 600 outputs a corresponding signal to the controller according to the deformation parameter of the force-bearing surface 71p, or the miniature force sensor 600 generates a corresponding force value parameter signal according to the deformation parameter of the force-bearing surface 71p and sends the force value parameter signal to the controller. When at least one of the deformation parameter or force value of the force-bearing surface 71p satisfies the preset condition, it is determined that the fastener driver 100h can start. In this manner, the product can start automatically when the trigger portion 161h abuts against the workpiece and applies a force to the workpiece, without the need for an additional trigger switch or manual control by the user. The trigger portion 161h may be a working attachment such as a screwdriver bit. The firing portion is also a type of working attachment.

In some alternative examples, the miniature force sensor detects at least one of the deformation parameter of a preset position of the attachment or the value of the applied force. The controller determines that the output torque of the working attachment satisfies a preset condition according to at least one of the deformation parameter signal or force value parameter signal outputted by the miniature force sensor and controls the output of the motor. Optionally, the force-bearing surface is disposed on the surface of the attachment or between the attachment and the clamping device. The miniature force sensor detects the deformation parameter of the force-bearing surface caused by the force generated by the torque transmission between the attachment and the workpiece. The miniature force sensor outputs a corresponding signal to the controller according to the deformation parameter of the force-bearing surface, or the miniature force sensor generates a corresponding force value parameter signal according to the deformation parameter of the force-bearing surface and sends the force value parameter signal to the controller. When at least one of the deformation parameter of the force-bearing surface or the force value satisfies a preset condition, it is determined that the output torque does not match the torque required by the workpiece, and then the motor output is adjusted. For example, when at least one of the deformation parameter of the force-bearing surface or the force value exceeds a threshold, it is determined that the output torque is too small, and then the motor is controlled to increase the torque output, for example, by increasing the output rotational speed or increasing the output torque. Optionally, when at least one of the deformation parameter of the force-bearing surface or the force value exceeds a threshold, it is determined that the working attachment is disengaged from the fastener, and then the motor is controlled to reduce torque output, for example, reducing the output rotational speed or reducing the output torque.

In some alternative examples, by using the detection value from the miniature force sensor, the controller controls the motor to automatically start or stop, thereby replacing the function of a mechanical clutch. In some examples, the detection value from the miniature force sensor can reflect the aging or wear of key machine components, such as gears, the electric motor, or an impact block. When the controller determines that aging or wear occurs, the controller sends a prompt signal through a state indication portion. In some alternative examples, the detection value from the miniature force sensor is used to detect the change in material state, such as monitoring the curing state of poured concrete.

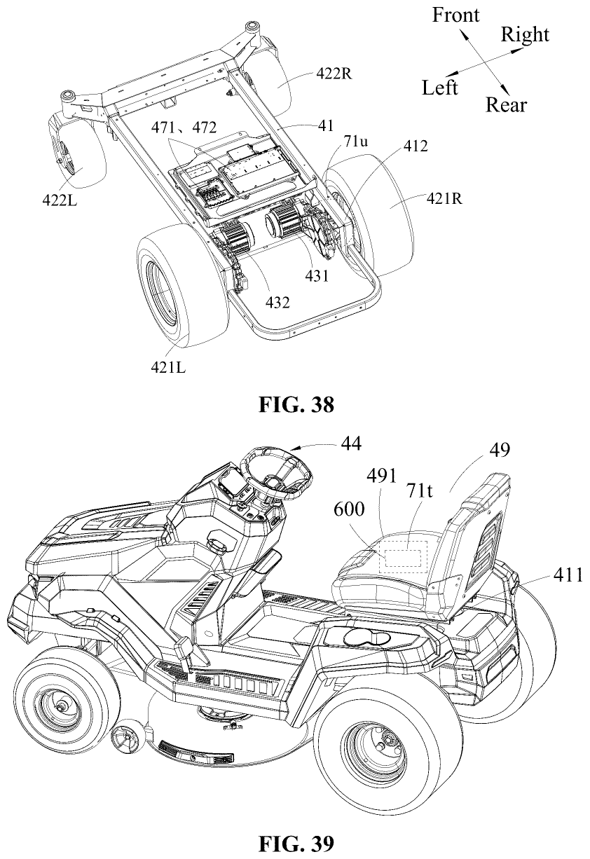

As a specific implementation manner of this example, as shown in FIG. 4 and FIGS. 38 to 42, the case where the power tool 10 is the outdoor traveling device 400 is used as an example. The traveling assembly 42 includes traveling wheels and a drive motor for driving the traveling wheels to rotate. In some examples, the traveling assembly 42 includes components such as a traveling track for driving the outdoor traveling device 400 to travel. In this example, the traveling wheels include rear traveling wheels 421 and front traveling wheels 422. As shown in FIG. 38, the rear traveling wheels 421 include a left rear traveling wheel 421L and a right rear traveling wheel 421R. The front traveling wheels 422 include a left front traveling wheel 422L and a right front traveling wheel 422R. The drive motor drives the rear traveling wheels 421 or the front traveling wheels 422 to rotate, thereby implementing the traveling function of the outdoor traveling device 400. Optionally, one, two, three, or four drive motors may be provided. For example, the traveling assembly 42 includes a first drive wheel and a second drive wheel for providing driving forces. In this example, the first drive wheel is the right rear traveling wheel 421R, and the second drive wheel is the left rear traveling wheel 421L. The drive motors include a first drive motor 431 for providing a driving force for the right rear traveling wheel 421R and a second drive motor 432 for providing a driving force for the left rear traveling wheel 421L. For convenience of reference, in the subsequent description, the first drive wheel 421R is referred to as the right rear traveling wheel, and the second drive wheel 421L is referred to as the left rear traveling wheel. The traveling assembly 42 provides driving forces to the first drive wheel 421R and the second drive wheel 421L in an independent driving manner.

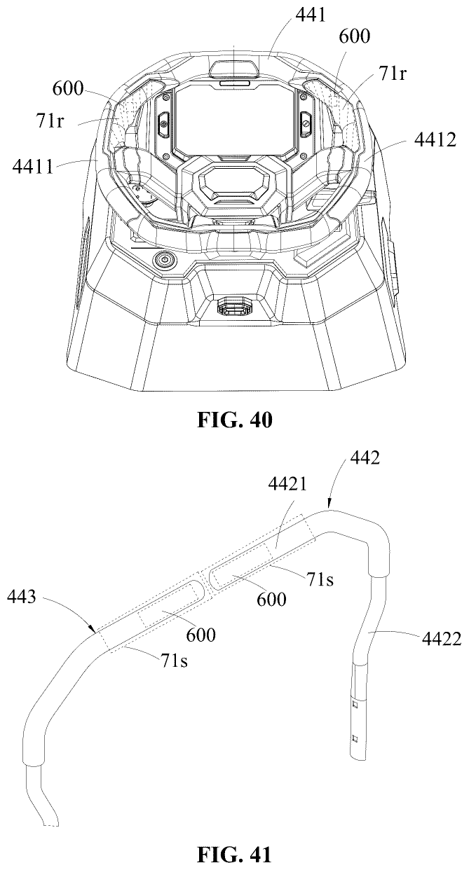

As shown in FIG. 4 and FIGS. 39 to 41, the outdoor traveling device 400 further includes an operation device 44 operated by the user to control at least the steering of the outdoor traveling device. As shown in FIGS. 39 and 40, the operation device 44 includes a steering wheel 441 for controlling the direction in which the traveling wheels travel. As shown in FIGS. 4 and 41, the operation device 44 includes a first operating lever 442 and a second operating lever 443. The first operating lever 442 and the second operating lever 443 are operated by the user and indicate the user's desired operation to control the outdoor traveling device 400 to move forward, move backward, or turn. For example, the first operating lever 442 can be held by the right hand of the user and may also be considered as a right operating lever, and the second operating lever 443 can be held by the left hand of the user and may also be considered as a left operating lever. The outdoor traveling device 400 of the present application is provided with two operating levers, which are the left operating lever and the right operating lever, and the steering speed and straight-line speed of the outdoor traveling device 400 are controlled according to the tilting angles of the left operating lever and the right operating lever. The first operating lever 442 and the second operating lever 443 are operably connected to the first drive wheel 421R and the second drive wheel 421L, respectively. For example, the first operating lever 442 is coupled to the first drive motor 431, and the second operating lever 443 is coupled to the second drive motor 432. The first operating lever 442 and the second operating lever 443 independently control the movement of the first drive wheel 421R and the second drive wheel 421L. Optionally, the first operating lever 442 and the second operating lever 443 independently input driving requirements to the first drive motor 431 and the second drive motor 432, respectively.

The outdoor traveling device 400 further includes a controller 472 for controlling the rotation of the drive motors. The controller 472 is disposed on a control circuit board 471 connected to the vehicle frame 41. The control circuit board 471 includes a PCB and an FPC board. The controller 472 uses a dedicated control chip, for example, a single-chip microcomputer or an MCU. It is to be noted that the control chip may be integrated into the controller 472 or may be disposed independently of the controller 472. A structural relationship between a driver chip and the controller 472 is not limited in this example.

The outdoor traveling device 400 includes the miniature force sensor 600 for detecting at least one of the deformation parameter of a preset part of the operation device 44 or the value of the force applied to the preset part of the operation device 44. It is to be explained that the deformation parameters include the values directly generated by the deformation of the force-bearing surface, such as changes in height, changes in curvature, and similar direct numerical changes. The deformation parameters further include numerical parameters obtained by performing relevant calculations on the values generated by direct deformation, such as changes in area or volume due to changes in height, or parameter values obtained after performing one or two calculations. The force value includes the value of the force applied to the force-bearing surface or the parameter derived from the force value through calculations, such as torque. A parameter generated based on the force, such as a change in speed, is further included.

The controller 472 is connected to the miniature force sensor 600. Optionally, the controller 472 is connected to the miniature force sensor 600 via digital signals. Optionally, the controller 472 is connected to the miniature force sensor 600 via analog signals. Optionally, the controller 472 is connected to the miniature force sensor 600 via wireless signals. The controller 472 is the main controller 472 of the power tool. Optionally, the controller 472 is a separate controller 472 controlled by the miniature force sensor 600. One control circuit board 471 may be provided. Optionally, two or more control circuit boards 471 are provided.

The controller 472 is configured to receive the detection value from the miniature force sensor 600 and determine the operation intention of the user for the operation device 44 based on the detection value from the miniature force sensor 600. In this example, the detection value includes at least one of the deformation parameter of a force-bearing surface of a preset part of the operation device 44, the force value, the rate of change of deformation, or the rate of change of the force value. The operation intention includes at least the following: increasing, maintaining, or decreasing the traveling speed, changing the traveling direction, stopping, or setting device parameters changing in a non-traveling state. The settings of device parameters changing in the non-traveling state include illumination settings, working component (for example, the mowing attachment, the snow removal attachment, or the cleaning attachment) state settings, and network state settings.

In some examples, the controller 472 controls the output state of the drive motors 431 and 432 based on the operation intention, for example, increasing or decreasing the output rotational speed of the drive motors 431 and 432, or limiting the output rotational speed or output torque of the drive motors 431 and 432. In some examples, the controller 472 generates an alarm signal based on the operation intention and provides the alarm to the user. For example, if the controller detects that the user's hands leave the operation device 44, the controller generates the alarm signal and provides the alarm to the user. In some examples, while generating the alarm signal, the controller limits the output rotational speed of the drive motors 431 and 432, including gradually decelerating or limiting the maximum rotational speed.

As shown in FIG. 40, in some examples, the operation device 44 is configured to be the steering wheel 441, the steering wheel 441 includes a left portion 4411 and a right portion 4412, the left portion 4411 is held by the left hand during traveling in a straight line, and the right portion 4412 is held by the right hand during traveling in a straight line. The miniature force sensor 600 is at least disposed on the left portion 4411 of the steering wheel 441. The housing of the left portion 4411 of the steering wheel 441 defines a force-bearing surface 71r. The force-bearing surface 71r is used for receiving an external force and undergoing different deformations when the external force changes. The miniature force sensor 600 is disposed in the left portion 4411 of the steering wheel 441. For example, the miniature force sensor 600 is disposed on the back or side of the force-bearing surface 71r or on the outer periphery of the force-bearing surface 71r. For example, as shown in FIG. 40, the force-bearing surface 71r is disposed on the housing at a preset gripping position of the driver. Optionally, the force-bearing surface 71r may also be disposed at another position on the left portion 4411 of the steering wheel 441. In some examples, the miniature force sensor 600 is at least disposed on the right portion 4412 of the steering wheel 441. The housing of the right portion 4412 of the steering wheel 441 defines a force-bearing surface 71r. The force-bearing surface 71r is used for receiving an external force and undergoing different deformations when the external force changes. The miniature force sensor 600 is disposed in the right portion 4412 of the steering wheel 441. For example, the miniature force sensor 600 is disposed on the back or side of the force-bearing surface 71r or on the outer periphery of the force-bearing surface 71r. For example, as shown in FIG. 40, the force-bearing surface 71r is disposed on the housing at a preset gripping position of the driver. Optionally, the force-bearing surface 71r may also be disposed at another position on the right portion 4412 of the steering wheel 441. In some examples, the miniature force sensors 600 are disposed on the left portion 4411 and the right portion 4412 of the steering wheel 441. The left portion 4411 and the right portion 4412 of the steering wheel 441 define force-bearing surfaces 71r, respectively. The force-bearing surface 71r is used for receiving an external force and undergoing different deformations when the external force changes. The miniature force sensors 600 are disposed in the left portion 4411 and the right portion 4412 of the steering wheel 441. Therefore, whether the user holds the left portion 4411 or the right portion 4412 of the steering wheel 441 can be detected so that whether the driver holds the steering wheel with both hands, holds the steering wheel with one hand, or does not hold the steering wheel can be determined, thereby making the detection data more accurate. The miniature force sensor consumes less power and is small in size, the detection data can be more accurate, controllability can be improved, and assisted driving precision can be improved.

In this example, the miniature force sensor 600 is disposed on the back side of the force-bearing surface 71r. The force-bearing surface 71r is configured to be the region defined by the housing of the left portion 4411 and/or right portion 4412 of the steering wheel 441. In some examples, the miniature force sensor 600 is directly or indirectly connected to the back side of the force-bearing surface 71r. In some examples, the miniature force sensor 600 is disposed on the back side of the force-bearing surface 71r but is not in contact with the back side of the force-bearing surface 71r, that is, the miniature force sensor 600 is suspended relative to the back side of the force-bearing surface 71r. For example, the miniature force sensor 600 is disposed on the back side of the force-bearing surface 71r and is connected and fixed to the front or side of the force-bearing surface 71r through connectors or fasteners.

The force-bearing surface 71r is configured to be the region defined by the housing of the left portion 4411 and/or right portion 4412 of the steering wheel 441, ensuring that the steering wheel 441 has an integral structure. Optionally, the force-bearing surface 71r and the housing of the steering wheel 441 are made of the same material and have the same appearance effect. The force-bearing surface 71r is indicated by a mark on the steering wheel 441. For example, the force-bearing surface 71r may be indicated by a screen-printed mark on the steering wheel 441, an adhesive label, etching, texturing, or patterning. In some examples, the force-bearing surface 71r and the housing of the steering wheel 441 are made of different materials or have different appearance indications. For example, the force-bearing surface 71r is made of a light-transmissive material that is locally transparent or semi-transparent so that different operating pressures applied by the user can be fed back through lighting. In some examples, the force-bearing surface 71r has a different thickness or is made of a different material to satisfy the detection requirement of the miniature force sensor 600.

In some examples, the miniature force sensor 600 may also replace any function switch on the steering wheel 441 so that the user can activate or deactivate the corresponding function simply by touching a specific region of the force-bearing surface 71r. For example, the motor can be powered on or off, or the outdoor traveling device can be set to the standby state or can shut down. The controller 472 is configured to start or stop the motor 12 according to the output of any miniature force sensor 600. Eliminating physical switches or other mechanical switches can maintain the sealing performance of the housing of the whole machine and improve the waterproof and dustproof performance of the machine. When the miniature force sensor 600 is used instead of a start switch, the miniature force sensor 600 can be used with no special treatment on the housing of the steering wheel 441 since the miniature force sensor 600 is small in size and can detect smaller deformations.

In some examples, the controller 472 is configured to turn on or off an illumination component in the power tool 10 according to the output of any miniature force sensor 600. In some examples, the miniature force sensor 600 may replace a mode switch to limit at least the maximum traveling speed of the outdoor traveling device by switching between different working modes. Multiple miniature force sensors 600 may be disposed at different positions to control the same or different functions at different positions of the steering wheel 441. For example, the miniature force sensors 600 are disposed on the left portion 4411 and the right portion 4412 of the steering wheel 441 to control the switching between the working modes, or the miniature force sensor 600 is disposed only on the left portion 4411 to control the illumination settings of the outdoor traveling device.

For example, multiple miniature force sensors 600 are disposed at two or more positions on the steering wheel 441, respectively. By applying forces to different miniature force sensors 600, the miniature force sensors 600 send corresponding signals to the controller 472 so that the controller 472 controls the motors (for example, the drive motors 431 and 432) or the corresponding response components to perform the corresponding actions. For example, multiple miniature force sensors 600 are linearly arranged so that the multiple miniature force sensors 600 output a force detection signal that changes linearly during the sliding operation of the user. Through the user's sliding operation over the miniature force sensors 600 to different positions, different corresponding signals are outputted to the controller 472 so that the controller 472 controls the motors (for example, the drive motors 431 and 432) or the corresponding response components to perform the corresponding actions.

As shown in FIG. 41, in some examples, the operation device 44 includes the first operating lever 442 and the second operating lever 443, and at least one of the first operating lever 442 and the second operating lever 443 includes a force-bearing surface 71s for receiving an external force and undergoing different deformations when the external force changes. The miniature force sensor 600 is disposed on the back or side of the force-bearing surface 71s or on the outer periphery of the force-bearing surface 71s.

In some examples, the first operating lever 442 is used as an example, and the first operating lever 442 includes a gripping portion 4421 configured to support the palm of the user. The first operating lever 442 further includes a steering lever 4422 configured to be movably connected to a vehicle frame 4111 or a traveling mechanism 40. In some examples, the steering lever 4422 may be a metal tube (or a tube made of other rigid materials) that includes at least a portion extending basically vertically (when mounted at the middle position) and the other portion extending basically horizontally. In some examples, the basically horizontally extending portion of the steering lever 4422 may be considered to be or actually include a structure used as the gripping portion 4421 or a structure for connecting the gripping portion 4421. In some examples, the gripping portion 4421 may be made of a different material (for example, a softer material) that is more comfortable for the operator to hold. In some cases, the gripping portion 4421 may include textures or other features to enhance or improve the operator's grip feel.

The first operating lever 442 and the second operating lever 443 each include the gripping portion 4421. The force-bearing surface 71s is at least partially disposed on the gripping portion 4421, and the housing of the gripping portion 4421 defines the force-bearing surface 71s. The miniature force sensor 600 is disposed inside at least one of the first operating lever 442 and the second operating lever 443 to detect the deformation or force value of the force-bearing surface. For example, the miniature force sensor 600 is disposed inside the gripping portion 4421. The force-bearing surface 71s of the gripping portion 4421 is used for receiving an external force and undergoing different deformations when the external force changes. Optionally, the miniature force sensor 600 is disposed on the back or side of the force-bearing surface 71s or on the outer periphery of the force-bearing surface 71s. In this example, the miniature force sensor 600 is disposed on the back side of the force-bearing surface 71s. The force-bearing surface 71s is configured to be the region defined by the housing of the gripping portion of the first operating lever 442 and/or the second operating lever 443. In some examples, the miniature force sensor 600 is directly or indirectly connected to the back side of the force-bearing surface 71s. In some examples, the miniature force sensor 600 is disposed on the back side of the force-bearing surface 71s but is not in contact with the back side of the force-bearing surface 71s, that is, the miniature force sensor 600 is suspended relative to the back side of the force-bearing surface 71s. For example, the miniature force sensor 600 is disposed on the back side of the force-bearing surface 71s and is connected and fixed to the front or side of the force-bearing surface 71s through connectors or fasteners.

The force-bearing surface 71s is configured to be the region defined by the housing of the gripping portion of the first operating lever 442 and/or the second operating lever 443, ensuring that the gripping portion 4421 has an integral structure. Optionally, the force-bearing surface 71s and the housing of the gripping portion 4421 are made of the same material and have the same appearance effect. The force-bearing surface 71s is indicated by a mark on the gripping portion 4421. For example, the force-bearing surface 71s may be indicated by a screen-printed mark on the gripping portion 4421, an adhesive label, etching, texturing, or patterning. In some examples, the force-bearing surface 71s and the housing of the gripping portion 4421 are made of different materials or have different appearance indications. For example, the force-bearing surface 71s is made of a light-transmissive material that is locally transparent or semi-transparent so that different operating pressures applied by the user can be fed back through lighting. In some examples, the force-bearing surface 71s has a different thickness or is made of a different material to satisfy the detection requirement of the miniature force sensor 600.

For example, the miniature force sensors 600 are configured to determine, according to the changes in the external forces received by the force-bearing surfaces 71s, how the user's two hands hold the tool. In some examples, the miniature force sensor 600 may replace any function switch on the first operating lever 442 and the second operating lever 443 so that the user can activate or deactivate the corresponding function by simply touching a specific region. Eliminating physical switches or other mechanical switches can maintain the sealing performance of the housing of the whole machine and improve the waterproof and dustproof performance of the machine. This is the same as the function in the steering wheel 441, and the details are not repeated.

As shown in FIGS. 4, 39, and 42, the outdoor traveling device 400 further includes a support mechanism 49 for supporting the user at least during the traveling process of the outdoor traveling device 400, and the support mechanism 49 is mounted on the vehicle frame 41. Optionally, the support mechanism 49 includes a seat 491. The seat 491 is mounted to the vehicle frame 41 and used for the user to sit on. In other alternative examples, the support mechanism 49 includes a platform for the user to stand on.

In this example, the miniature force sensor 600 is used for detecting at least one of the deformation parameter of a preset part of at least one of the traveling assembly 42, the support mechanism 49, and the vehicle frame 41 or the value of the applied force. The controller 472 is configured to receive the detection value from the miniature force sensor 600 and trigger the corresponding control signal of the controller 472 based on the detection value from the miniature force sensor 600.

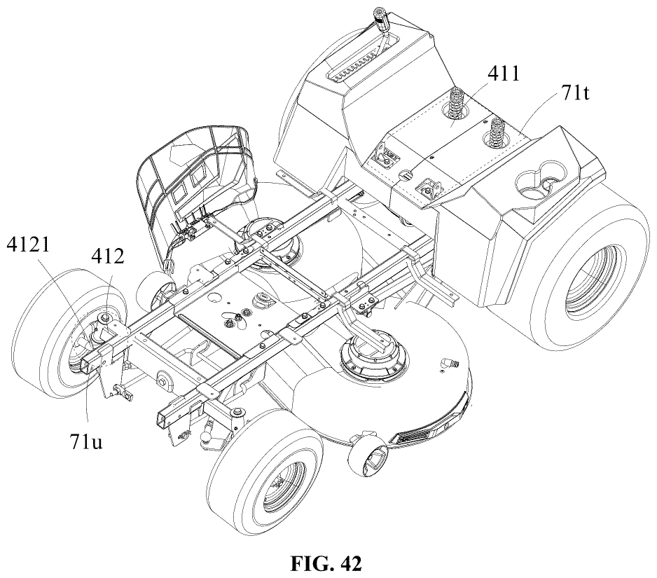

For example, the case where the support mechanism 49 includes the seat 491 is used as an example. Based on the detection value from the miniature force sensor 600, the controller 472 determines the user presence condition and triggers a control signal corresponding to the user presence condition. Based on the detection value from the miniature force sensor 600, the controller 472 determines the weight of the user supported by the support mechanism 49 or the position of the user relative to the support mechanism 49. As shown in FIG. 39, optionally, the miniature force sensor 600 is disposed inside the seat 491, and a force-bearing surface 71t in the preset part includes the region defined by the surface of the seat 491. As shown in FIG. 42, optionally, the seat 491 is connected to a seat mounting portion 411 of the vehicle frame 41, the miniature force sensor 600 is disposed in the vehicle frame 41, and the seat mounting portion 411 is on the force-bearing surface 71t in the preset part. The miniature force sensor 600 can accurately detect the weight information of the user in real time. Thresholds for the user weights are configured for the controller 472, thereby flexibly adapting to the weights of different drivers. The user presence condition can be accurately detected for both light and heavy users. For example, the user presence condition includes user absence and modes corresponding to users of different weights. Characteristics of vibration damping and traveling torque output corresponding to users of different weights are at least partially different.

In some examples, as shown in FIGS. 38 and 42, connecting plates 412 are disposed on the vehicle frame 41, the front traveling wheels 422 and the rear traveling wheels 421 are connected to the corresponding connecting plates 412, the miniature force sensors 600 are disposed on the connecting plates 412, and based on the detection values from the miniature force sensors 600, the controller 472 determines the attitude information of the outdoor traveling device and triggers a control signal corresponding to the attitude information. For example, the traveling assembly 42 includes at least four traveling wheels, the connecting plates 412 include four connection positions 4121 corresponding to the traveling wheels, and the preset positions are set on the connecting plates 412. Based on the detection values from the miniature force sensors 600, the pressure differences among the connection positions 4121 are determined, and the controller 472 determines the attitude information of the outdoor traveling device based on the pressure differences. The attitude information includes the tilt angle in the horizontal direction and the change in the tilt angle in the horizontal direction.

For example, a force-bearing surface 71u at the preset position is disposed on the connecting plate 412, and at least one miniature force sensor 600 is disposed at each of the connection positions 4121 corresponding to the multiple traveling wheels. When the attitude of the outdoor traveling device is basically parallel to the horizontal direction, the detection values from the miniature force sensors 600 at the connection positions 4121 are basically the same. When the outdoor traveling device is tilted relative to the horizontal direction, the detection values from the connection positions 4121 are different, thereby forming the pressure differences among the connection positions 4121. According to the pressure differences among the connection positions 4121, the controller 472 determines the attitude information of the outdoor traveling device in a preset calculation method or a table lookup method. The controller 472 controls the output states of the drive motors 431 and 432 based on the attitude information. For example, when the tilt angle is too large, single-side deceleration or stopping is performed. For example, when the tilt angle is too large, the vehicle stability system is automatically adjusted. In some examples, the controller 472 generates an alarm signal based on the attitude information and provides the alarm to the user. In some examples, based on the attitude information, the controller 472 controls the output states of the drive motors 431 and 432, generates an alarm signal, and provides the alarm to the user.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool system, comprising:
a power tool;
a battery pack coupled to the power tool to supply electric power to the power tool, wherein at least one of the power tool and the battery pack is provided with a force-bearing component; and
at least one miniature force sensor mounted in the power tool or the battery pack, wherein a miniature force sensor of the at least one miniature force sensor detects at least one of a deformation parameter of a preset part of the force-bearing component or a value of a force applied to the preset part of the force-bearing component, and an operating current of the miniature force sensor is less than or equal to 10 mA.

2. The power tool system of claim 1, wherein the power tool comprises a motor-driven power tool, an outdoor traveling device, or an electrical device not driven by a motor.

3. The power tool system of claim 1, wherein the power tool comprises a housing provided with an accommodation space, the battery pack comprises a battery pack housing provided with an accommodation space, and the miniature force sensor is mounted on an inner side of the housing of the power tool or on an inner side of the battery pack housing.

4. The power tool system of claim 3, wherein the force-bearing component is formed on or connected to the housing or the force-bearing component is formed on or connected to the battery pack housing, the force-bearing component comprises a force-bearing surface, and the miniature force sensor is disposed on a back or side of the force-bearing surface or on an outer periphery of the force-bearing surface.

5. The power tool system of claim 4, wherein the power tool comprises a controller disposed inside the housing, the controller is connected to the miniature force sensor, and the controller determines a detection value from the miniature force sensor and sends a corresponding signal according to the detection value to control a working state of the power tool.

6. The power tool system of claim 5, wherein the power tool further comprises a motor disposed inside the housing, the motor rotatably drives a coupled output portion, the miniature force sensor detects at least one of a deformation parameter of a preset part of the output portion or a value of a force applied to the preset part of the output portion, and the controller is configured to determine a detection value from the miniature force sensor and control an operation state of the motor according to the detection value.

7. The power tool system of claim 6, wherein the controller determines actual output torque of the power tool according to at least one of the deformation parameter or the value of the force detected by the miniature force sensor and determines the operation state of the motor according to a comparison result between the actual output torque and a preset torque.

8. The power tool system of claim 6, wherein the output portion comprises an output mechanism comprising an output shaft for connecting a working attachment and driving the working attachment to rotate.

9. The power tool system of claim 6, wherein the output portion comprises: an output mechanism comprising an output shaft for connecting a working attachment and driving the working attachment to rotate; and a transmission mechanism disposed between the motor and the output mechanism and used for transmitting power between the motor and the output mechanism.

10. The power tool system of claim 5, wherein the power tool further comprises a motor disposed inside the housing and configured to drive an output shaft to rotate; and an actuator sleeve that is operably rotatable about the output shaft to allow a user to set a torque threshold, wherein when the actuator sleeve rotates, the actuator sleeve undergoes axial displacement parallel to an extension direction of the output shaft; wherein the miniature force sensor is configured to detect at least one of a deformation parameter of a preset part of the actuator sleeve or a value of a force applied to the preset part of the actuator sleeve when the actuator sleeve rotates, wherein the force receiving surface of the miniature force sensor intersects with the output shaft.

11. The power tool system of claim 10, wherein the controller is configured to acquire at least one of the deformation parameter or the value of the force detected by the miniature force sensor and determine the torque threshold according to acquired data, and the controller controls an operation state of the motor according to the torque threshold.

12. The power tool system of claim 1, wherein the battery pack has a total capacity greater than or equal to 1.5 Ah and less than or equal to 5 Ah.

13. The power tool system of claim 1, wherein the miniature force sensor has a dimension less than or equal to 3 mm.

14. The power tool system of claim 1, wherein the miniature force sensor has a measurement frequency greater than or equal to 500 Hz.

15. The power tool system of claim 1, wherein the miniature force sensor comprises a substrate portion, and the substrate portion comprises a silicon-based circuit board.

16. A power tool, comprising:
a housing;
a motor disposed inside the housing and configured to rotatably drive an output portion coupled to the motor;
a controller disposed inside the housing, wherein the controller controls rotation of the motor; and
at least one miniature force sensor configured to detect at least one of a deformation parameter of a preset part of the output portion or a value of a force applied to the preset part of the output portion;
wherein the controller is connected to the at least one miniature force sensor and is configured to acquire a detection value from the at least one miniature force sensor and control an operation state of the motor according to the detection value.

17. The power tool of claim 16, wherein the controller determines actual output torque of the power tool according to the detection value from the at least one miniature force sensor and determines the operation state of the motor according to a comparison result between the actual output torque and a preset torque.

18. A power tool, comprising:
a housing;
a motor disposed inside the housing and configured to drive an output shaft to rotate;
a controller disposed inside the housing, wherein the controller controls rotation of the motor;
an actuator sleeve that is operably rotatable about the output shaft to allow a user to set a torque threshold, wherein when the actuator sleeve rotates, the actuator sleeve undergoes axial displacement parallel to an extension direction of the output shaft; and
a miniature force sensor configured to detect at least one of a deformation parameter of a preset part of the actuator sleeve or a value of a force applied to the preset part of the actuator sleeve when the actuator sleeve rotates, wherein a force receiving surface of the miniature force sensor intersects with the output shaft;
wherein the controller is connected to the miniature force sensor and is configured to acquire a detection value from the miniature force sensor and determine the torque threshold according to the acquired detection value, wherein the controller controls an operation state of the motor according to the torque threshold.

19. The power tool of claim 18, wherein when determining that output torque of the output shaft is greater than the torque threshold, the controller controls the motor to shut down or decelerate.

20. The power tool of claim 18, wherein the miniature force sensor is disposed on a back or side of the preset part or on an outer periphery of the preset part.
